(19) United States
(12) Patent Application Publication
(10) Pub. No.: US 2024/0381304 A1
(43) Pub. Date: Nov. 14, 2024

(54) SYSTEMS AND METHODS FOR DETERMINING TIME DOMAIN CHANNEL REPRESENTATION INFORMATION

(71) Applicant: COGNITIVE SYSTEMS CORP., Waterloo (CA)

(72) Inventors: Chris BEG, Waterloo (CA); Mohammad OMER, Waterloo (CA)

(21) Appl. No.: 18/688,036

(22) PCT Filed: Sep. 2, 2022
(86) PCT No.: PCT/IB2022/058269

§ 371 Date: Feb. 29, 2024

Related U.S. Application Data
(60) Provisional application No. 63/284,330, filed on Nov. 30, 2021.
(60) Provisional application No. 63/273,581, filed on Oct. 29, 2021.
(60) Provisional application No. 63/251,239, filed on Oct. 1, 2021.
(60) Provisional application No. 63/240,641, filed on Sep. 3, 2021.

(51) Int. Cl. H04W 64/00; H04L 5/00; H04W 84/12

(52) U.S. Cl. CPC H04W 64/006; H04L 5/0007; H04L 5/0053; H04W 84/12

(57) ABSTRACT

Systems and methods for Wi-Fi sensing are provided for determining time domain channel representation information. A method for Wi-Fi sensing carried out by a sensing receiver including a transmitting antenna, a receiving antenna, and a processor is described. Initially, a sensing transmission is received. A sensing measurement is generated based on the sensing transmission. In an example, a full time-domain channel representation (TD-CRI) of a propagation channel between the sensing receiver and a sensing transmitter is generated based on the sensing measurement. Thereafter, in an example, principal impulses of the full TD-CRI are identified. The principal impulses represent a subset of time domain pulses of the full TD-CRI. Then, a filtered TD-CRI is identified according to the principal impulses. The filtered TD-CRI is sent to a sensing algorithm manager.

### CROSS-REFERENCE TO RELATED APPLICATIONS

This application claims priority to U.S. Provisional Application No. 63/240,641, filed on Sep. 3, 2021, U.S. Provisional Application No. 63/251,239, filed on Oct. 1, 2021, U.S. Provisional Application No. 63/273,581, filed on Oct. 29, 2021, and U.S. Provisional Application No. 63/284,330, filed on Nov. 30, 2021, the entire contents of each of which are incorporated herein by reference.

### TECHNICAL FIELD

The present disclosure generally relates to systems and methods for Wi-Fi sensing. In particular, the present disclosure relates to systems and methods for determining principal impulses of time domain channel representation information for Wi-Fi sensing.

### BACKGROUND OF THE DISCLOSURE

Motion detection systems have been used to detect movement, for example, of objects in a room or an outdoor area. In some example motion detection systems, infrared or optical sensors are used to detect the movement of objects in the sensor's field of view. Motion detection systems have been used in security systems, automated control systems, and other types of systems. A Wi-Fi sensing system is one recent addition to motion detection systems. The Wi-Fi sensing system may be a network of Wi-Fi-enabled devices that may be a part of an IEEE 802.11 network. For example, the Wi-Fi sensing system may include a sensing receiver and a sensing transmitter. In an example, the Wi-Fi sensing system may be configured to detect features of interest in a sensing space. The sensing space may refer to any physical space in which the Wi-Fi sensing system may operate, such as a place of residence, a place of work, a shopping mall, a sports hall or sports stadium, a garden, or any other physical space. The features of interest may include motion of objects and motion tracking, presence detection, intrusion detection, gesture recognition, fall detection, breathing rate detection, and other applications. In the Wi-Fi sensing system, an orthogonal frequency division multiplexing (OFDM) channel may be represented by a channel representation information (CRI) in either frequency domain or time domain. In an example, frequency domain channel state information (CSI) is most common CRI which represents the OFDM channel by a phase and amplitude modifier for every subcarrier in an OFDM signal. However, it may be advantageous to represent the OFDM channel in the time domain where the CRI may represent a time delay and attenuation of a direct path and a number of multipath signals. In an example, an inverse fast Fourier transform (IFFT) algorithm may be used to transform the CSI from the frequency domain to the time domain. Although, the IFFT algorithm is highly optimized, the IFFT algorithm may be computationally expensive and may require significant memory for its execution. Further, the determination of a CRI is functionality which typically sits above the physical (PHY) layer of a receiving device (for example, a sensing receiver). Accordingly, processing is often carried out by general purpose microprocessors with limited memory and reduced computing power.

### BRIEF SUMMARY OF THE DISCLOSURE

The present disclosure generally relates to systems and methods for Wi-Fi sensing. In particular, the present disclosure relates to systems and methods for determining principal impulses of time domain channel representation information for Wi-Fi sensing.

In an example embodiment, a method for Wi-Fi sensing is described. The method is carried out by a Wi-Fi device including at least one processor configured to execute instructions to implement a sensing agent. The method includes receiving, by the at least one processor, a sensing measurement in a frequency domain generated based on a sensing transmission received from a sensing transmitter, generating, by the at least one processor, a time domain representation of the sensing measurement, selecting, by the at least one professor, one or more time domain pulses indicative of the time domain representation, and communicating, by the at least one processor, the one or more time domain pulses to a sensing algorithm manager for use in determining motion or movement.

In another example embodiment, a method for Wi-Fi sensing is described. The method is carried out by a Wi-Fi device including at least one processor configured to execute instructions. The method includes receiving one or more time domain pulses indicative of a time domain representation, generating a reconstructed time domain representation based on the one or more time domain pulses, generating reconstructed channel state information according to the reconstructed time domain representation, and executing a sensing algorithm according to the reconstructed channel state information to obtain a sensing result.

In another example embodiment, a system for Wi-Fi sensing is described. The system includes a Wi-Fi device including at least one processor configured to execute instructions for receiving a sensing measurement in a frequency domain generated based on a sensing transmission received from a sensing transmitter, generating a time domain representation of the sensing measurement, selecting, by the at least one processor, one or more time domain pulses indicative of the time domain representation, and communicating the one or more time domain pulses to a sensing algorithm manager for use in determining motion or movement.

In another example embodiment, a system for Wi-Fi sensing is described. The system includes a Wi-Fi device including at least one processor configured to execute instructions for receiving one or more time domain pulses indicative of a time domain representation, generating a reconstructed time domain representation based on the one or more time domain pulses, generating reconstructed channel state information according to the reconstructed time domain representation, and executing a sensing algorithm according to the reconstructed channel state information to obtain a sensing result.

Systems and methods are provided for Wi-Fi sensing. In an example embodiment, a method for Wi-Fi sensing is described. The method is carried out by a sensing receiver including a transmitting antenna, a receiving antenna, and a processor configured to execute instructions. The method includes receiving a sensing transmission, generating a sensing measurement based on the sensing transmission, generating a full time-domain channel representation (TD-CRI) of a propagation channel between the sensing receiver and a sensing transmitter based on the sensing measurement, identifying principal impulses of the full TD-CRI, the principal impulses representing a subset of time domain pulses of the full TD-CRI, identifying a filtered TD-CRI comprising the principal impulses, and sending the filtered TD-CRI to a sensing algorithm manager.

In some embodiments, the method includes sending, to the sensing algorithm manager, location information indicating locations in the full TD-CRI of the principal impulses.

In some embodiments, the location information includes a bit map.

In some embodiments, the location information is included in the filtered TD-CRI.

In some embodiments, the method includes obtaining, by the sensing algorithm manager, the filtered TD-CRI, generating, by the sensing algorithm manager, a reconstructed TD-CRI based on the location information and the principal impulses, generating, by the sensing algorithm manager, reconstructed channel state information according to the reconstructed TD-CRI, and executing, by the sensing algorithm manager, a sensing algorithm according to the reconstructed channel state information to obtain a sensing result.

In some embodiments, identifying the principal impulses includes optimizing for a weighted combination of accuracy and size of the filtered TD-CRI.

In some embodiments, identifying the principal impulses includes minimizing an objective function representing a weighted linear combination of an error factor and a size factor.

In some embodiments, the error factor represents an error between channel state information determined from the sensing measurement and reconstructed channel state information determined from the filtered TD-CRI.

In some embodiments, the size factor represents a number of principal impulses in the filtered TD-CRI.

In some embodiments, minimizing the objective function includes selecting a first set of principal impulse candidates according to a time domain mask including a time delay filter and an amplitude mask, varying the first set of principal impulse candidates to generate a second set of principal impulse candidates, and comparing the objective function value using the first set of principal impulse candidates and the second set of principal impulse candidates.

In another example embodiment, a method for Wi-Fi sensing is described. The method is carried out by a sensing algorithm manager including a receiving antenna and a processor configured to execute instructions. The method includes receiving a filtered TD-CRI and corresponding location information, generating a reconstructed TD-CRI based on the filtered TD-CRI and the location information, generating reconstructed channel state information according to the reconstructed TD-CRI, and executing a sensing algorithm on the reconstructed channel state information to obtain a sensing result.

In some embodiments, the method includes receiving a plurality of principal impulses, including location information, and using the location information to determine placement of the principal impulses in the reconstructed TD-CRI.

In another example embodiment, a method for Wi-Fi sensing is described. The method is carried out by a sensing receiver including a processor configured to execute instructions. The method includes receiving channel state information (CSI) in a frequency domain generated based on a sensing transmission received from a sensing transmitter, determining a signal time window, generating a partial time-domain channel representation (TD-CRI) of the CSI by transforming the CSI to identify a plurality of time domain pulses occurring in the signal time window of a time domain, identifying a filtered TD-CRI based on the partial TD-CRI, and sending the filtered TD-CRI to a sensing algorithm manager.

In some embodiments, transforming the CSI includes applying a transform to the CSI to obtain only the plurality of time domain pulses occurring in the signal time window and not obtain time domain pulses occurring outside of the signal time window.

In some embodiments, the plurality of time domain pulses represents the channel between the sensing transmitter and the sensing receiver.

In some embodiments, determining the signal time window includes determining a cut-off time in the sensing transmission as an end of the signal time window, transforming the CSI to identify post cut-off pulses occurring in a post-signal window occurring after the cut-off time, sampling a noise level in the post cut-off pulses, determining a threshold according to the noise level, identifying a first time domain pulse exceeding the threshold, and setting a beginning of the signal time window according to the first time domain pulse.

In some embodiments, determining the cut-off time includes selecting a time in the sensing transmission based on a system model of the sensing transmitter and the sensing receiver.

In some embodiments, the cut-off time represents the time after which no meaningful signal is expected.

In some embodiments, identifying the first time domain pulse includes transforming the CSI to identify pre-signal pulses occurring in a pre-signal window in the time domain, detecting a presence of a pre-signal pulse from the pre-signal pulses in the pre-signal window that exceeds the threshold, and responsive to detecting the presence of the pre-signal pulse, setting the pre-signal pulse as the first time domain pulse.

In some embodiments, the pre-signal window is a subsequent pre-signal window, and identifying the first time domain pulse further includes transforming the CSI to identify first pre-signal pulses occurring in a first pre-signal window occurring before the subsequent pre-signal window in the time domain and detecting the non-presence of any pre-signal pulses from the first pre-signal pulses in the first pre-signal window that exceed the threshold, where applying the transform to the CSI to identify the pre-signal pulses in the subsequent pre-signal window is performed responsive to detecting the non-presence of any first pre-signal pulses from the first pre-signal pulses in the first pre-signal window that exceed the threshold.

In some embodiments, identifying the filtered TD-CRI includes setting the filtered TD-CRI as the partial TD-CRI.

In some embodiments, identifying the filtered TD-CRI includes identifying principal impulses of the partial TD-CRI representing a subset of time domain pulses of the partial TD-CRI.

Other aspects and advantages of the disclosure will become apparent from the following detailed description, taken in conjunction with the accompanying drawings, which illustrate by way of example, the principles of the disclosure.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1 is a diagram showing an example wireless communication system;

FIG. 2A and FIG. 2B are diagrams showing example wireless signals communicated between wireless communication devices;

FIG. 3A and FIG. 3B are plots showing examples of channel responses computed from the wireless signals communicated between wireless communication devices in FIG. 2A and FIG. 2B;

FIG. 4A and FIG. 4B are diagrams showing example channel responses associated with motion of an object in distinct regions of a space;

FIG. 4C and FIG. 4D are plots showing the example channel responses of FIG. 4A and FIG. 4B overlaid on an example channel response associated with no motion occurring in the space;

FIG. 5A and FIG. 5B depict an implementation of some of an architecture of an implementation of a system for Wi-Fi sensing, according to some embodiments;

FIG. 6A and FIG. 6B depict a sequence diagram for communication between a sensing receiver, a sensing transmitter, and a sensing algorithm manager, where the sensing receiver is the sensing initiator, according to some embodiments;

FIG. 7A and FIG. 7B depict a sequence diagram for communication between a sensing receiver, a sensing transmitter, and a sensing algorithm manager, where the sensing transmitter is a sensing initiator, according to some embodiments;

FIG. 8 depicts a sequence diagram for communication between a sensing receiver and a sensing transmitter including a sensing algorithm manager, where the sensing transmitter is a sensing initiator, according to some embodiments;

FIG. 9 illustrates a management frame carrying a sensing transmission, according to some embodiments;

FIG. 10A illustrates an example of a format of a control frame and FIG. 10B illustrates a format of a sensing transmission announcement control field of the control frame, according to some embodiments;

FIG. 11A illustrates another example of a format of a control frame and FIG. 11B illustrates a format of a sensing measurement control field of the control frame, according to some embodiments;

FIG. 12 illustrates a management frame carrying a channel representation information (CRI) transmission message, according to some embodiments;

FIG. 13 illustrates a representation of a receiver chain of a sensing receiver, according to some embodiments;

FIG. 14 depicts an example representation of a channel, which includes a direct signal path and a single multipath, according to some embodiments;

FIG. 15 depicts creation of a constrained basis matrix, according to some embodiments;

FIG. 16 depicts an illustration of a time domain mask, according to some embodiments;

FIG. 17 illustrates a representation of communication of locations of principal impulses in a full time-domain channel representation (TD-CRI) from a sensing receiver to a sensing algorithm manager using an active tone bit map, according to some embodiments;

FIG. 18 illustrates a representation of communication of locations of principal impulses in a full TD-CRI from a sensing receiver to a sensing algorithm manager using a full bit map, according to some embodiments;

FIG. 19 illustrates a representation of communication of locations of principal impulses in a full TD-CRI from a sensing receiver to a sensing algorithm manager using positions of the principal impulses in the full TD-CRI, according to some embodiments;

FIG. 20A and FIG. 20B depict a flowchart for sending a filtered TD-CRI to a sensing algorithm manager, according to some embodiments;

FIG. 21 depicts a flowchart for executing a sensing algorithm according to reconstructed channel state information (R-CSI) to obtain a sensing result, according to some embodiments;

FIG. 22 depicts an example of a typical impulse response computed by a sensing receiver, according to some embodiments;

FIG. 23 depicts a signal flow graph of an 8-point inverse fast Fourier transform (IFFT), according to some embodiments;

FIG. 24 depicts another signal flow graph of an 8-point IFFT, according to some embodiments;

FIG. 25A to FIG. 25H depict a signal flow graph of a 32-point IFFT, according to some embodiments;

FIG. 26A to FIG. 26H depict another signal flow graph of a 32-point IFFT, according to some embodiments;

FIG. 27A to FIG. 27H depict yet another signal flow graph of a 32-point IFFT, according to some embodiments;

FIG. 28A and FIG. 28B depict a flowchart for sending filtered time domain channel representation information (TD-CRI) to a sensing algorithm manager, according to some embodiments; and

FIG. 29 depicts a flowchart for determining a signal time window, according to some embodiments.

### DETAILED DESCRIPTION

In some aspects of what is described herein, a wireless sensing system may be used for a variety of wireless sensing applications by processing wireless signals (e.g., radio frequency signals) transmitted through a space between wireless communication devices. Example wireless sensing applications include motion detection, which can include the following: detecting motion of objects in the space, motion tracking, breathing detection, breathing monitoring, presence detection, gesture detection, gesture recognition, human detection (moving and stationary human detection), human tracking, fall detection, speed estimation, intrusion detection, walking detection, step counting, respiration rate detection, apnea estimation, posture change detection, activity recognition, gait rate classification, gesture decoding, sign language recognition, hand tracking, heart rate estimation, breathing rate estimation, room occupancy detection, human dynamics monitoring, and other types of motion detection applications. Other examples of wireless sensing applications include object recognition, speaking recognition, keystroke detection and recognition, tamper detection, touch detection, attack detection, user authentication, driver fatigue detection, traffic monitoring, smoking detection, school violence detection, human counting, metal detection, human recognition, bike localization, human queue estimation, Wi-Fi imaging, and other types of wireless sensing applications. For instance, the wireless sensing system may operate as a motion detection system to detect the existence and location of motion based on Wi-Fi signals or other types of wireless signals. As described in more detail below, a wireless sensing system may be configured to control measurement rates, wireless connections, and device participation, for example, to improve system operation or to achieve other technical advantages. The system improvements and technical advantages achieved when the wireless sensing system is used for motion detection are also achieved in examples where the wireless sensing system is used for another type of wireless sensing application.

In some example wireless sensing systems, a wireless signal includes a component (e.g., a synchronization preamble in a Wi-Fi PHY frame, or another type of component) that wireless devices can use to estimate a channel response or other channel information, and the wireless sensing system can detect motion (or another characteristic depending on the wireless sensing application) by analyzing changes in the channel information collected over time. In some examples, a wireless sensing system can operate similar to a bistatic radar system, where a Wi-Fi access point (AP) assumes the receiver role, and each Wi-Fi device (stations or nodes or peers) connected to the AP assumes the transmitter role. The wireless sensing system may trigger a connected device to generate a transmission and produce a channel response measurement at a receiver device. This triggering process can be repeated periodically to obtain a sequence of time variant measurements. A wireless sensing algorithm may then receive the generated time-series of channel response measurements (e.g., computed by Wi-Fi receivers) as input, and through a correlation or filtering process, may then make a determination (e.g., determine if there is motion or no motion within the environment represented by the channel response, for example, based on changes or patterns in the channel estimations). In examples where the wireless sensing system detects motion, it may also be possible to identify a location of the motion within the environment based on motion detection results among a number of wireless devices.

Accordingly, wireless signals received at each of the wireless communication devices in a wireless communication network may be analyzed to determine channel information for the various communication links (between respective pairs of wireless communication devices) in the network. The channel information may be representative of a physical medium that applies a transfer function to wireless signals that traverse a space. In some instances, the channel information includes a channel response. Channel responses can characterize a physical communication path, representing the combined effect of, for example, scattering, fading, and power decay within the space between the transmitter and receiver. In some instances, the channel information includes beamforming state information (e.g., a feedback matrix, a steering matrix, channel state information (CSI), etc.) provided by a beamforming system. Beamforming is a signal processing technique often used in multi-antenna (multiple-input/multiple-output (MIMO)) radio systems for directional signal transmission or reception. Beamforming can be achieved by operating elements in an antenna array in such a way that signals at some angles experience constructive interference while others experience destructive interference.

The channel information for each of the communication links may be analyzed (e.g., by a hub device or other device in a wireless communication network, or a sensing transmitter communicably coupled to the network) to, for example, detect whether motion has occurred in the space, to determine a relative location of the detected motion, or both. In some aspects, the channel information for each of the communication links may be analyzed to detect whether an object is present or absent, e.g., when no motion is detected in the space.

In some cases, a wireless sensing system can control a node measurement rate. For instance, a Wi-Fi motion system may configure variable measurement rates (e.g., channel estimation/environment measurement/sampling rates) based on criteria given by a current wireless sensing application (e.g., motion detection). In some implementations, when no motion is present or detected for a period of time, for example, the wireless sensing system can reduce the rate that the environment is measured, such that the connected device will be triggered less frequently. In some implementations, when motion is present, for example, the wireless sensing system can increase the triggering rate to produce a time-series of measurements with finer time resolution. Controlling the variable measurement rate can allow energy conservation (through the device triggering), reduce processing (less data to correlate or filter), and improve resolution during specified times.

In some cases, a wireless sensing system can perform band steering or client steering of nodes throughout a wireless network, for example, in a Wi-Fi multi-AP or Extended Service Set (ESS) topology, multiple coordinating wireless APs each provide a Basic Service Set (BSS) which may occupy different frequency bands and allow devices to transparently move between from one participating AP to another (e.g., mesh). For instance, within a home mesh network, Wi-Fi devices can connect to any of the APs, but typically select one with a good signal strength. The coverage footprint of the mesh APs typically overlap, often putting each device within communication range or more than one AP. If the AP supports multi-bands (e.g., 2.4 GHz and 5 GHz), the wireless sensing system may keep a device connected to the same physical AP, but instruct it to use a different frequency band to obtain more diverse information to help improve the accuracy or results of the wireless sensing algorithm (e.g., motion detection algorithm). In some implementations, the wireless sensing system can change a device from being connected to one mesh AP to being connected to another mesh AP. Such device steering can be performed, for example, during wireless sensing (e.g., motion detection), based on criteria detected in a specific area, to improve detection coverage, or to better localize motion within an area.

In some cases, a wireless sensing system can allow devices to dynamically indicate and communicate their wireless sensing capability or wireless sensing willingness to the wireless sensing system. For example, there may be times when a device does not want to be periodically interrupted or triggered to transmit a wireless signal that would allow the AP to produce a channel measurement. For instance, if a device is sleeping, frequently waking the device up to transmit or receive wireless sensing signals could consume resources (e.g., causing a cell-phone battery to discharge faster). These and other events could make a device willing or not willing to participate in wireless sensing system operations. In some cases, a cell phone running on its battery may not want to participate, but when the cell phone is plugged into the charger, it may be willing to participate. Accordingly, if the cell phone is unplugged, it may indicate to the wireless sensing system to exclude the cell phone from participating; whereas if the cell phone is plugged in, it may indicate to the wireless sensing system to include the cell phone in wireless sensing system operations. In some cases, if a device is under load (e.g., a device streaming audio or video) or busy performing a primary function, the device may not want to participate; whereas when the same device's load is reduced and participating will not interfere with a primary function, the device may indicate to the wireless sensing system that it is willing to participate.

Example wireless sensing systems are described below in the context of motion detection (detecting motion of objects in the space, motion tracking, breathing detection, breathing monitoring, presence detection, gesture detection, gesture recognition, human detection (moving and stationary human detection), human tracking, fall detection, speed estimation, intrusion detection, walking detection, step counting, respiration rate detection, apnea estimation, posture change detection, activity recognition, gait rate classification, gesture decoding, sign language recognition, hand tracking, heart rate estimation, breathing rate estimation, room occupancy detection, human dynamics monitoring, and other types of motion detection applications. However, the operation, system improvements, and technical advantages achieved when the wireless sensing system is operating as a motion detection system are also applicable in examples where the wireless sensing system is used for another type of wireless sensing application.

In various embodiments of the disclosure, non-limiting definitions of one or more terms that will be used in the document are provided below.

A term “measurement campaign” may refer to a bi-directional series of one or more sensing transmissions between a sensing receiver and a sensing transmitter that allows a series of one or more sensing measurements to be computed.

A term “channel representation information (CRI)” may refer to a collection of sensing measurements which together represent the state of the channel between two devices. Examples of CRI are CSI and full TD-CRI.

A term “channel state information (CSI)” may refer to properties of a communications channel that are known or measured by a technique of channel estimation. CSI may represent how wireless signals propagate from a transmitter (for example, a sensing transmitter) to a receiver (for example, a sensing receiver) along multiple paths. CSI is typically a matrix of complex values representing the amplitude attenuation and phase shift of signals, which provides an estimation of a communications channel.

A term “discrete Fourier transform (DFT)” may refer to an algorithm that transforms a signal in time domain to a signal in frequency domain. In an example, the DFT may be used to transform a TD-CRI into a R-CSI. In an embodiment, a fast Fourier transform (FFT) may be used to implement the DFT.

A term “fast Fourier transform (FFT)” may refer to a fast algorithm to implement DFT.

A term “full time-domain channel representation information (full TD-CRI)” may refer to a series of complex pairs representing the amplitude and delay of time domain pulses which are created by performing an Inverse Fourier transform (IDFT or IFFT) on CSI values, for example CSI calculated by a baseband receiver. A full TD-CRI may also be referred to as the impulse response of the channel represented by CSI.

A term “filtered time-domain channel representation information (filtered TD-CRI)” may refer to a reduced series of complex pairs of time domain pulses created by applying an algorithm to a full TD-CRI. The algorithm may select some time domain pulses and reject others. The filtered TD-CRI includes information that relates a selected time domain pulse to the corresponding time domain pulse in the full TD-CRI.

A term “inverse discrete Fourier transform (IDFT)” may refer to an algorithm which transforms a signal in frequency domain to a signal in time domain. In an example, the IDFT may be used to transform a CSI into a TD-CRI. In an embodiment, an inverse fast Fourier transform (IFFT) may be used to implement the IDFT.

A term “inverse fast Fourier transform (IFFT)” may refer to a fast algorithm to implement IDFT.

A term “partial TD-CRI” may refer to a reduced series of complex pairs of time domain pulses created by applying an optimized IFFT on a full TD-CRI.

A term “principal impulses” may refer to a minimum subset of TD-CRI time domain pulses comprising the time domain pulses which are determined to be principal for creating reconstructed CSI (R-CSI) channel representation with sufficient accuracy. In an example, principal impulses are included in the filtered TD-CRI.

A term “reconstructed CSI (R-CSI)” may refer to a representation of original CSI values as measured by the baseband receiver, where R-CSI is calculated by taking original CSI values (frequency domain), performing an IDFT to translate those values into the time domain, selecting a number of time domain pulses, zeroing or nulling time domain tones that do not include a selected time domain pulse, and performing a DFT. The resulting frequency domain complex values are the R-CSI.

A term “sensing initiator” may refer to a device that initiates a Wi-Fi sensing session. The role of sensing initiator may be taken on by the sensing receiver, the sensing transmitter, or a separate device which includes a sensing algorithm (for example, a sensing algorithm manager).

A term “Null Data PPDU (NDP)” may refer to a PPDU that does not include data fields. In an example, Null Data PPDU may be used for sensing transmission where it is the MAC header that includes the information required.

A term “sensing transmission” may refer to any transmission made from the sensing transmitter to the sensing receiver which may be used to make a sensing measurement. In an example, sensing transmission may also be referred to as wireless sensing signal or wireless signal.

A term “sensing trigger message” may refer to a message sent from the sensing receiver to the sensing transmitter to trigger one or more sensing transmissions that may be used for performing sensing measurements. A sensing trigger message may also be referred to as a sensing initiation message.

A term “sensing response message” may refer to a message which is included within a sensing transmission from the sensing transmitter to the sensing receiver. In an example, the sensing transmission that includes the sensing response message may be used to perform a sensing measurement.

A term “sensing measurement” may refer to a measurement of a state of a channel i.e., CSI measurement between the sensing transmitter and the sensing receiver derived from a sensing transmission.

A term “PHY-layer Protocol Data Unit (PPDU)” may refer to a data unit that includes preamble and data fields. The preamble field may include the transmission vector format information and the data field may include payload and higher layer headers.

A term “sensing transmitter” may refer to a device that sends a transmission (for example, NDP and PPDUs) used for sensing measurements (for example, channel state information) in a sensing session. In an example, a station is an example of a sensing transmitter. In some examples, an access point (AP) may also be a sensing transmitter for Wi-Fi sensing purposes in the example where a station acts as a sensing receiver.

A term “sensing receiver” may refer to a device that receives a transmission (for example, NDP and PPDUs) sent by a sensing transmitter and performs one or more sensing measurements (for example, channel state information) in a sensing session. An access point (AP) is an example of a sensing receiver. In some examples, a station may also be a sensing receiver in a mesh network scenario.

A term “sensing transmission announcement message” may refer to a message which is sent from the sensing transmitter to the sensing receiver that announces that a sensing transmission NDP will follow within a short interframe space (SIFS). The sensing transmission NDP may be transmitted using transmission parameters defined with the sensing transmission announcement messages.

A term “short interframe space (SIFS)” may refer to a period within which a processing element (for example, a microprocessor, dedicated hardware, or any such element) within a device of a Wi-Fi sensing system is able to process data presented to it in a frame. In an example, the short interframe space may be 10 ms.

A term “sensing transmission NDP” may refer to an NDP transmission which is sent by the sensing transmitter and used for a sensing measurement at the sensing receiver. The transmission follows a sensing transmission announcement and may be transmitted using transmission parameters that are defined in the sensing response announcement.

A term “sensing measurement poll message” may refer to a message sent from the sensing transmitter to the sensing receiver to solicit the transmission of channel representation information determined by the sensing receiver.

A term “transmission parameters” may refer to a set of IEEE 802.11 PHY transmitter configuration parameters which are defined as part of transmission vector (TXVECTOR) corresponding to a specific PHY and which are configurable for each PHY-layer Protocol Data Unit (PPDU) transmission.

A term “channel response information (CRI) transmission message” may refer to a message sent by the sensing receiver that has performed a sensing measurement on a sensing transmission, in which the sensing receiver sends CRI to the sensing transmitter.

A term “sensing configuration message” may refer to a message which from a device including a sensing algorithm (for example, a sensing algorithm manager) to the sensing receiver. The sensing configuration message may include a channel representation information configuration. The channel representation information configuration may interchangeably be referred to as Time Domain Channel Representation Information (TD-CRI) configuration. In an example, the channel representation information configuration may include a time domain mask. The time domain mask may include a time delay filter and an amplitude mask.

A term “sensing configuration response message” may refer to a message sent from the sensing receiver to the device including the sensing algorithm (for example, the sensing algorithm manager) in response to a sensing configuration message. In an example, the sensing configuration response message may be an acknowledgement to the sensing configuration message.

A term “time domain pulse” may refer to a complex number that represents amplitude and phase of discretized energy in the time domain. When CSI values are obtained for each tone from the baseband receiver, time domain pulses are obtained by performing an IFFT on the CSI values.

A term “tone” may refer to an individual subcarrier in an OFDM signal. A tone may be represented in time domain or frequency domain. In the time domain, a tone may also be referred to as a symbol. In the frequency domain, a tone may also be referred to as a subcarrier.

A term “delivered transmission configuration” may refer to transmission parameters applied by the sensing transmitter to a sensing transmission.

A term “requested transmission configuration” may refer to requested transmission parameters of the sensing transmitter to be used when sending a sensing transmission.

A term “Wi-Fi sensing session” may refer to a period during which objects in a physical space may be probed, detected and/or characterized. In an example, during a Wi-Fi sensing session, several devices participate in, and thereby contribute to the generation of sensing measurements. A Wi-Fi sensing session may also be referred to as a wireless local area network (WLAN) sensing session or simply a sensing session.

For purposes of reading the description of the various embodiments below, the following descriptions of the sections of the specifications and their respective contents may be helpful:

Section A describes a wireless communications system, wireless transmissions and sensing measurements which may be useful for practicing embodiments described herein.

Section B describes systems and methods that are useful for a Wi-Fi sensing system configurated to send sensing transmissions and make sensing measurements.

Section C describes embodiments of Systems and methods for determining partial and filtered TD-CRIs of time domain channel representation information

### A. Wireless Communications System, Wireless Transmissions, and Sensing Measurements

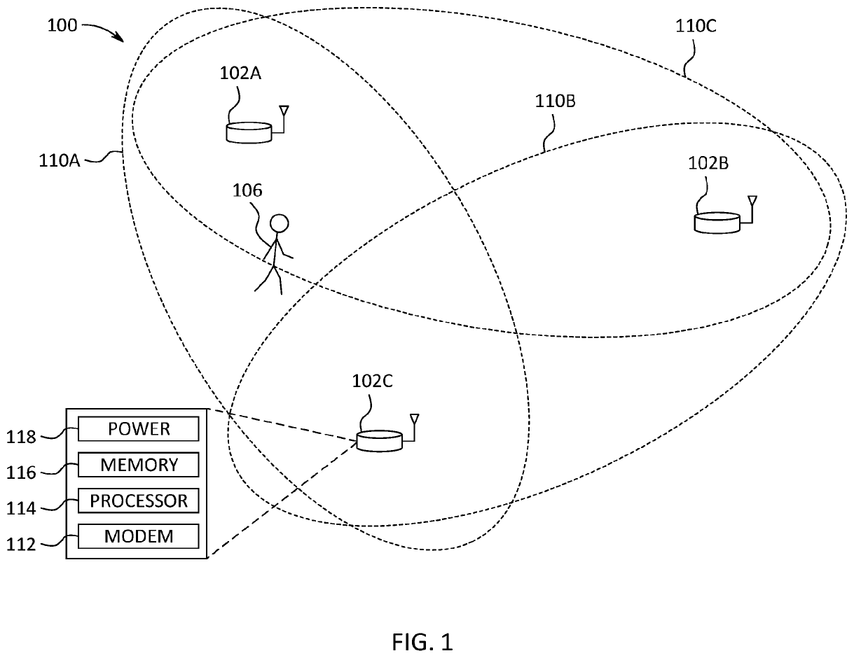

FIG. 1 illustrates wireless communication system 100. Wireless communication system 100 includes three wireless communication devices: first wireless communication device 102A, second wireless communication device 102B, and third wireless communication device 102C. Wireless communication system 100 may include additional wireless communication devices and other components (e.g., additional wireless communication devices, one or more network servers, network routers, network switches, cables, or other communication links, etc.).

Wireless communication devices 102A, 102B, 102C can operate in a wireless network, for example, according to a wireless network standard or another type of wireless communication protocol. For example, the wireless network may be configured to operate as a Wireless Local Area Network (WLAN), a Personal Area Network (PAN), a metropolitan area network (MAN), or another type of wireless network. Examples of WLANs include networks configured to operate according to one or more of the 802.11 family of standards developed by IEEE (e.g., Wi-Fi networks), and others. Examples of PANs include networks that operate according to short-range communication standards (e.g., BLUETOOTH®, Near Field Communication (NFC), ZigBee), millimeter wave communications, and others.

In some implementations, wireless communication devices 102A, 102B, 102C may be configured to communicate in a cellular network, for example, according to a cellular network standard. Examples of cellular networks include networks configured according to 2G standards such as Global System for Mobile (GSM) and Enhanced Data rates for GSM Evolution (EDGE) or EGPRS; 3G standards such as Code Division Multiple Access (CDMA), Wideband Code Division Multiple Access (WCDMA), Universal Mobile Telecommunications System (UMTS), and Time Division Synchronous Code Division Multiple Access (TD-SCDMA); 4G standards such as Long-Term Evolution (LTE) and LTE-Advanced (LTE-A); 5G standards, and others.

In the example shown in FIG. 1, wireless communication devices 102A, 102B, 102C can be, or they may include standard wireless network components. For example, wireless communication devices 102A, 102B, 102C may be commercially available Wi-Fi APs or another type of wireless access point (WAP) performing one or more operations as described herein that are embedded as instructions (e.g., software or firmware) on the modem of the WAP. In some cases, wireless communication devices 102A, 102B, 102C may be nodes of a wireless mesh network, such as, for example, a commercially available mesh network system (e.g., Plume Wi-Fi, Google Wi-Fi, Qualcomm Wi-Fi SoN, etc.). In some cases, another type of standard or conventional Wi-Fi transmitter device may be used. In some instances, one or more of wireless communication devices 102A, 102B, 102C may be implemented as WAPs in a mesh network, while other wireless communication device(s) 102A, 102B, 102C are implemented as leaf devices (e.g., mobile devices, smart devices, etc.) that access the mesh network through one of the WAPs. In some cases, one or more of wireless communication devices 102A, 102B, 102C is a mobile device (e.g., a smartphone, a smart watch, a tablet, a laptop computer, etc.), a wireless-enabled device (e.g., a smart thermostat, a Wi-Fi enabled camera, a smart TV), or another type of device that communicates in a wireless network.

Wireless communication devices 102A, 102B, 102C may be implemented without Wi-Fi components; for example, other types of standard or non-standard wireless communication may be used for motion detection. In some cases, wireless communication devices 102A, 102B, 102C can be, or they may be part of, a dedicated motion detection system. For example, the dedicated motion detection system can include a hub device and one or more beacon devices (as remote sensor devices), and wireless communication devices 102A, 102B, 102C can be either a hub device or a beacon device in the motion detection system.

As shown in FIG. 1, wireless communication device 102C includes modem 112, processor 114, memory 116, and power unit 118; any of wireless communication devices 102A, 102B, 102C in wireless communication system 100 may include the same, additional, or different components, and the components may be configured to operate as shown in FIG. 1 or in another manner. In some implementations, modem 112, processor 114, memory 116, and power unit 118 of a wireless communication device are housed together in a common housing or other assembly. In some implementations, one or more of the components of a wireless communication device can be housed separately, for example, in a separate housing or other assembly.

Modem 112 can communicate (receive, transmit, or both) wireless signals. For example, modem 112 may be configured to communicate radio frequency (RF) signals formatted according to a wireless communication standard (e.g., Wi-Fi or Bluetooth). Modem 112 may be implemented as the example wireless network modem 112 shown in FIG. 1, or may be implemented in another manner, for example, with other types of components or subsystems. In some implementations, modem 112 includes a radio subsystem and a baseband subsystem. In some cases, the baseband subsystem and radio subsystem can be implemented on a common chip or chipset, or they may be implemented in a card or another type of assembled device. The baseband subsystem can be coupled to the radio subsystem, for example, by leads, pins, wires, or other types of connections.

In some cases, a radio subsystem in modem 112 can include one or more antennas and radio frequency circuitry. The radio frequency circuitry can include, for example, circuitry that filters, amplifies, or otherwise conditions analog signals, circuitry that up-converts baseband signals to RF signals, circuitry that down-converts RF signals to baseband signals, etc. Such circuitry may include, for example, filters, amplifiers, mixers, a local oscillator, etc. The radio subsystem can be configured to communicate radio frequency wireless signals on the wireless communication channels. As an example, the radio subsystem may include a radio chip, an RF front end, and one or more antennas. A radio subsystem may include additional or different components. In some implementations, the radio subsystem can be or include the radio electronics (e.g., RF front end, radio chip, or analogous components) from a conventional modem, for example, from a Wi-Fi modem, pico base station modem, etc. In some implementations, the antenna includes multiple antennas.

In some cases, a baseband subsystem in modem 112 can include, for example, digital electronics configured to process digital baseband data. As an example, the baseband subsystem may include a baseband chip. A baseband subsystem may include additional or different components. In some cases, the baseband subsystem may include a digital signal processor (DSP) device or another type of processor device. In some cases, the baseband system includes digital processing logic to operate the radio subsystem, to communicate wireless network traffic through the radio subsystem, to detect motion based on motion detection signals received through the radio subsystem or to perform other types of processes. For instance, the baseband subsystem may include one or more chips, chipsets, or other types of devices that are configured to encode signals and deliver the encoded signals to the radio subsystem for transmission, or to identify and analyze data encoded in signals from the radio subsystem (e.g., by decoding the signals according to a wireless communication standard, by processing the signals according to a motion detection process, or otherwise).

In some instances, the radio subsystem in modem 112 receives baseband signals from the baseband subsystem, up-converts the baseband signals to radio frequency (RF) signals, and wirelessly transmits the radio frequency signals (e.g., through an antenna). In some instances, the radio subsystem in modem 112 wirelessly receives radio frequency signals (e.g., through an antenna), down-converts the radio frequency signals to baseband signals, and sends the baseband signals to the baseband subsystem. The signals exchanged between the radio subsystem, and the baseband subsystem may be digital or analog signals. In some examples, the baseband subsystem includes conversion circuitry (e.g., a digital-to-analog converter, an analog-to-digital converter) and exchanges analog signals with the radio subsystem. In some examples, the radio subsystem includes conversion circuitry (e.g., a digital-to-analog converter, an analog-to-digital converter) and exchanges digital signals with the baseband subsystem.

In some cases, the baseband subsystem of modem 112 can communicate wireless network traffic (e.g., data packets) in the wireless communication network through the radio subsystem on one or more network traffic channels. The baseband subsystem of modem 112 may also transmit or receive (or both) signals (e.g., motion probe signals or motion detection signals) through the radio subsystem on a dedicated wireless communication channel. In some instances, the baseband subsystem generates motion probe signals for transmission, for example, to probe a space for motion. In some instances, the baseband subsystem processes received motion detection signals (signals based on motion probe signals transmitted through the space), for example, to detect motion of an object in a space.

Processor 114 can execute instructions, for example, to generate output data based on data inputs. The instructions can include programs, codes, scripts, or other types of data stored in memory. Additionally, or alternatively, the instructions can be encoded as pre-programmed or re-programmable logic circuits, logic gates, or other types of hardware or firmware components. Processor 114 may be or include a general-purpose microprocessor, as a specialized co-processor or another type of data processing apparatus. In some cases, processor 114 performs high level operation of the wireless communication device 102C. For example, processor 114 may be configured to execute or interpret software, scripts, programs, functions, executables, or other instructions stored in memory 116. In some implementations, processor 114 may be included in modem 112.

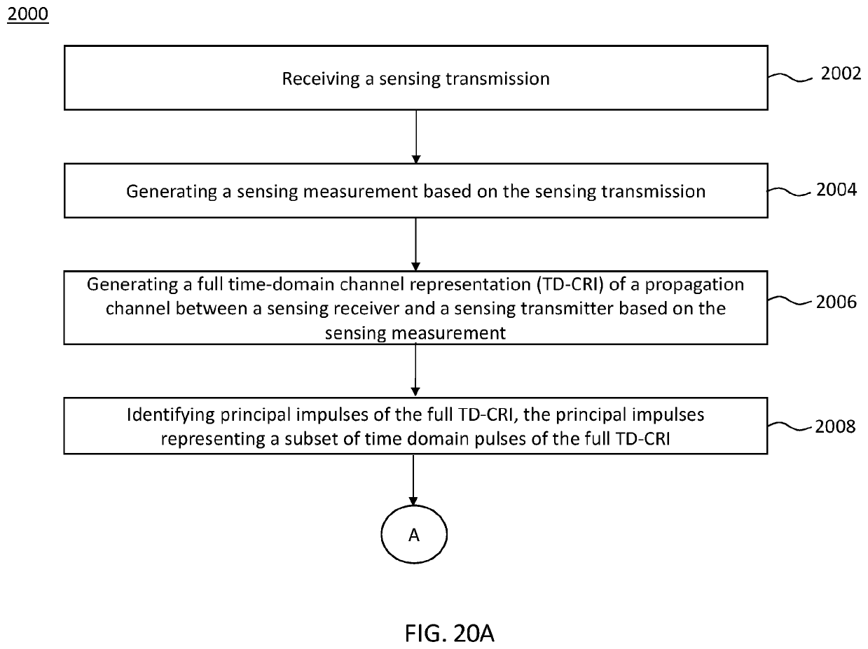

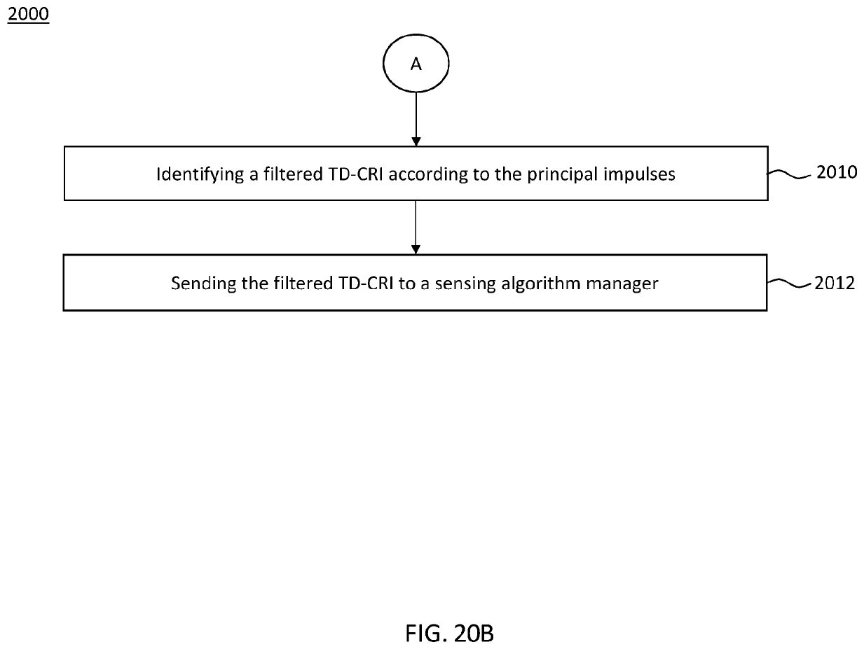

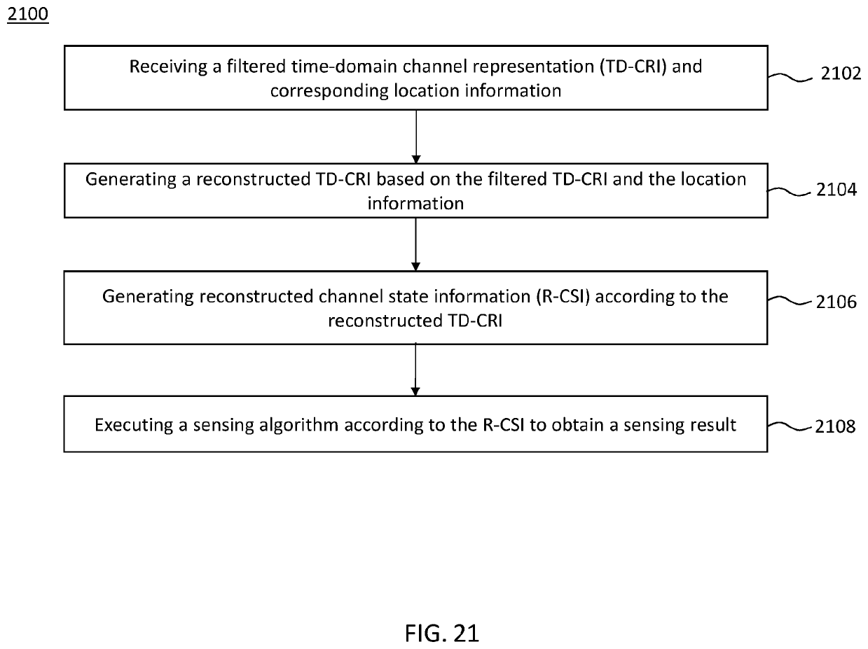

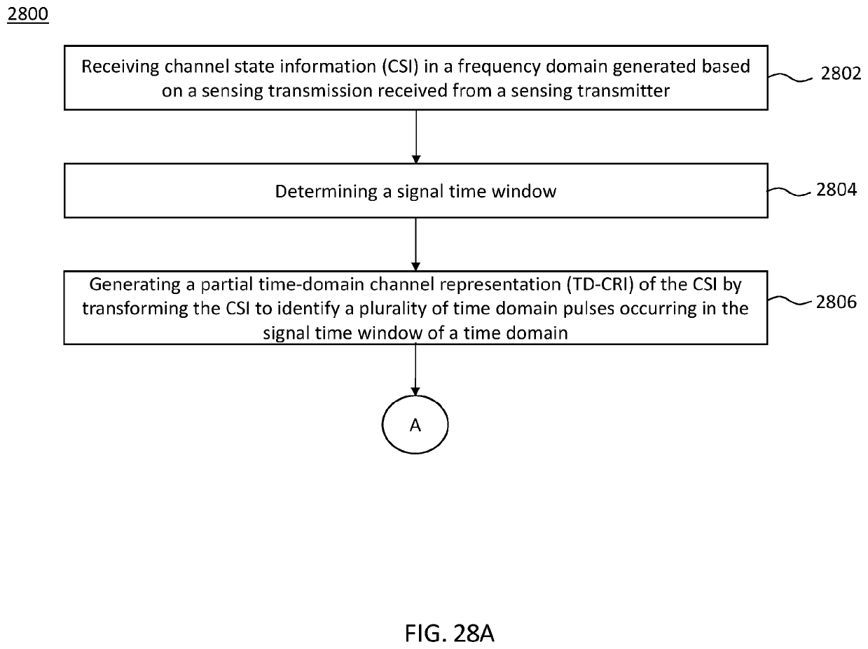

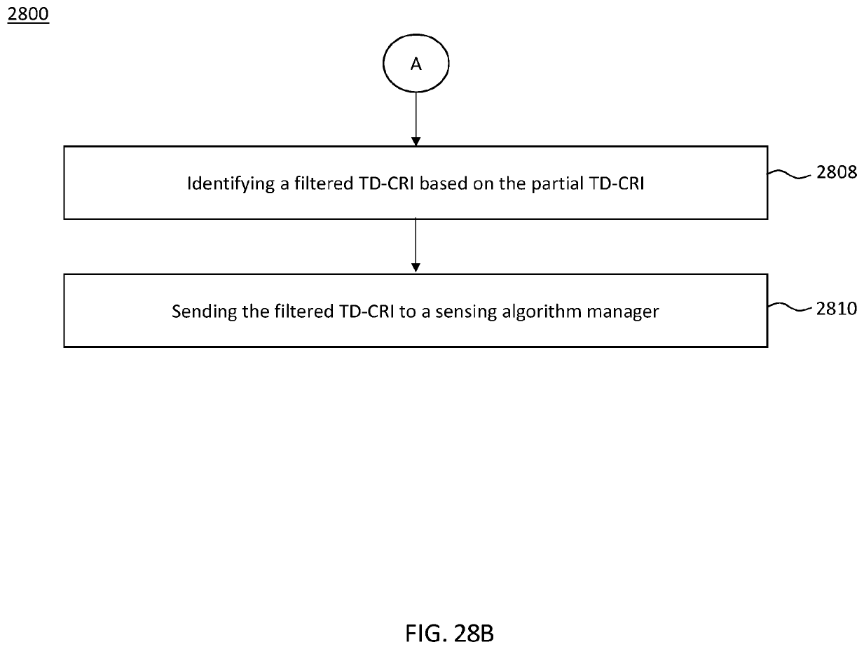

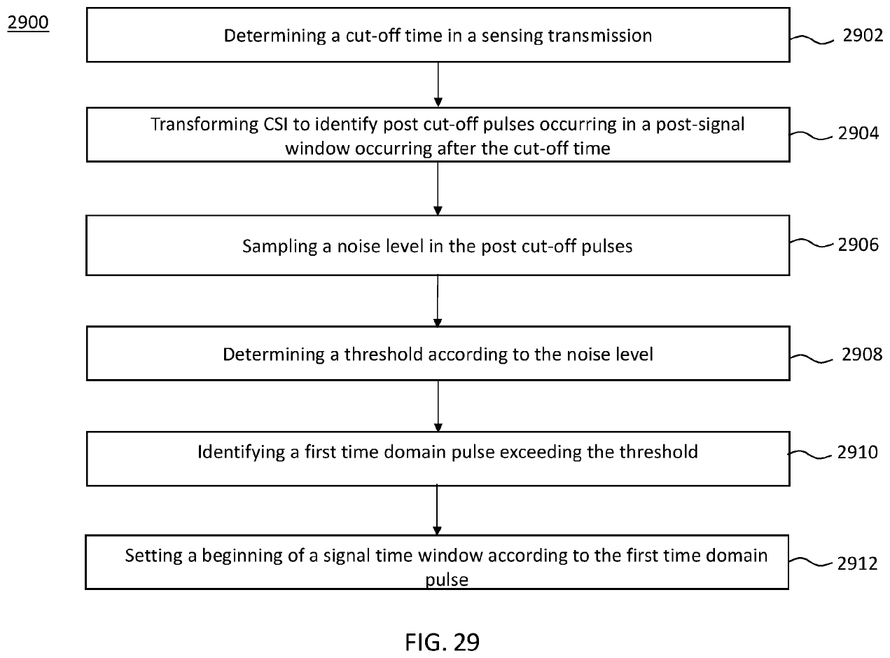

Memory 116 can include computer-readable storage media, for example, a volatile memory device, a non-volatile memory device, or both. Memory 116 can include one or more read-only memory devices, random-access memory devices, buffer memory devices, or a combination of these and other types of memory devices. In some instances, one or more components of the memory can be integrated or otherwise associated with another component of wireless communication device 102C. Memory 116 may store instructions that are executable by processor 114. For example, the instructions may include instructions for time-aligning signals using an interference buffer and a motion detection buffer, such as through one or more of the operations of the example processes as described in any of FIG. 20A-FIG. 20B, FIG. 21, FIG. 28A-FIG. 28B, and FIG. 29.

Power unit 118 provides power to the other components of wireless communication device 102C. For example, the other components may operate based on electrical power provided by power unit 118 through a voltage bus or other connection. In some implementations, power unit 118 includes a battery or a battery system, for example, a rechargeable battery. In some implementations, power unit 118 includes an adapter (e.g., an AC adapter) that receives an external power signal (from an external source) and coverts the external power signal to an internal power signal conditioned for a component of wireless communication device 102C. Power unit 118 may include other components or operate in another manner.

In the example shown in FIG. 1, wireless communication devices 102A, 102B transmit wireless signals (e.g., according to a wireless network standard, a motion detection protocol, or otherwise). For instance, wireless communication devices 102A, 102B may broadcast wireless motion probe signals (e.g., reference signals, beacon signals, status signals, etc.), or they may send wireless signals addressed to other devices (e.g., a user equipment, a client device, a server, etc.), and the other devices (not shown) as well as wireless communication device 102C may receive the wireless signals transmitted by wireless communication devices 102A, 102B. In some cases, the wireless signals transmitted by wireless communication devices 102A, 102B are repeated periodically, for example, according to a wireless communication standard or otherwise.

In the example shown, wireless communication device 102C processes the wireless signals from wireless communication devices 102A, 102B to detect motion of an object in a space accessed by the wireless signals, to determine a location of the detected motion, or both. For example, wireless communication device 102C may perform one or more operations of the example processes described below with respect to any of FIG. 20A-FIG. 20B, FIG. 21, FIG. 28A-FIG. 28B, and FIG. 29, or another type of process for detecting motion or determining a location of detected motion. The space accessed by the wireless signals can be an indoor or outdoor space, which may include, for example, one or more fully or partially enclosed areas, an open area without enclosure, etc. The space can be or can include an interior of a room, multiple rooms, a building, or the like. In some cases, the wireless communication system 100 can be modified, for instance, such that wireless communication device 102C can transmit wireless signals and wireless communication devices 102A, 102B can processes the wireless signals from wireless communication device 102C to detect motion or determine a location of detected motion.

The wireless signals used for motion detection can include, for example, a beacon signal (e.g., Bluetooth Beacons, Wi-Fi Beacons, other wireless beacon signals), another standard signal generated for other purposes according to a wireless network standard, or non-standard signals (e.g., random signals, reference signals, etc.) generated for motion detection or other purposes. In examples, motion detection may be carried out by analyzing one or more training fields carried by the wireless signals or by analyzing other data carried by the signal. In some examples data will be added for the express purpose of motion detection or the data used will nominally be for another purpose and reused or repurposed for motion detection. In some examples, the wireless signals propagate through an object (e.g., a wall) before or after interacting with a moving object, which may allow the moving object's movement to be detected without an optical line-of-sight between the moving object and the transmission or receiving hardware. Based on the received signals, wireless communication device 102C may generate motion detection data. In some instances, wireless communication device 102C may communicate the motion detection data to another device or system, such as a security system, which may include a control center for monitoring movement within a space, such as a room, building, outdoor area, etc.

In some implementations, wireless communication devices 102A, 102B can be modified to transmit motion probe signals (which may include, e.g., a reference signal, beacon signal, or another signal used to probe a space for motion) on a separate wireless communication channel (e.g., a frequency channel or coded channel) from wireless network traffic signals. For example, the modulation applied to the payload of a motion probe signal and the type of data or data structure in the payload may be known by wireless communication device 102C, which may reduce the amount of processing that wireless communication device 102C performs for motion sensing. The header may include additional information such as, for example, an indication of whether motion was detected by another device in wireless communication system 100, an indication of the modulation type, an identification of the device transmitting the signal, etc.

In the example shown in FIG. 1, wireless communication system 100 is a wireless mesh network, with wireless communication links between each of wireless communication devices 102. In the example shown, the wireless communication link between wireless communication device 102C and wireless communication device 102A can be used to probe motion detection field 110A, the wireless communication link between wireless communication device 102C and wireless communication device 102B can be used to probe motion detection field 110B, and the wireless communication link between wireless communication device 102A and wireless communication device 102B can be used to probe motion detection field 110C. In some instances, each wireless communication device 102 detects motion in motion detection fields 110 accessed by that device by processing received signals that are based on wireless signals transmitted by wireless communication devices 102 through motion detection fields 110. For example, when person 106 shown in FIG. 1 moves in motion detection field 110A and motion detection field 110C, wireless communication devices 102 may detect the motion based on signals they received that are based on wireless signals transmitted through respective motion detection fields 110. For instance, wireless communication device 102A can detect motion of person 106 in motion detection fields 110A, 110C, wireless communication device 102B can detect motion of person 106 in motion detection field 110C, and wireless communication device 102C can detect motion of person 106 in motion detection field 110A.

In some instances, motion detection fields 110 can include, for example, air, solid materials, liquids, or another medium through which wireless electromagnetic signals may propagate. In the example shown in FIG. 1, motion detection field 110A provides a wireless communication channel between wireless communication device 102A and wireless communication device 102C, motion detection field 110B provides a wireless communication channel between wireless communication device 102B and wireless communication device 102C, and motion detection field 110C provides a wireless communication channel between wireless communication device 102A and wireless communication device 102B. In some aspects of operation, wireless signals transmitted on a wireless communication channel (separate from or shared with the wireless communication channel for network traffic) are used to detect movement of an object in a space. The objects can be any type of static or moveable object and can be living or inanimate. For example, the object can be a human (e.g., person 106 shown in FIG. 1), an animal, an inorganic object, or another device, apparatus, or assembly, an object that defines all or part of the boundary of a space (e.g., a wall, door, window, etc.), or another type of object. In some implementations, motion information from the wireless communication devices may be analyzed to determine a location of the detected motion. For example, as described further below, one of wireless communication devices 102 (or another device communicably coupled to wireless communications devices 102) may determine that the detected motion is nearby a particular wireless communication device.

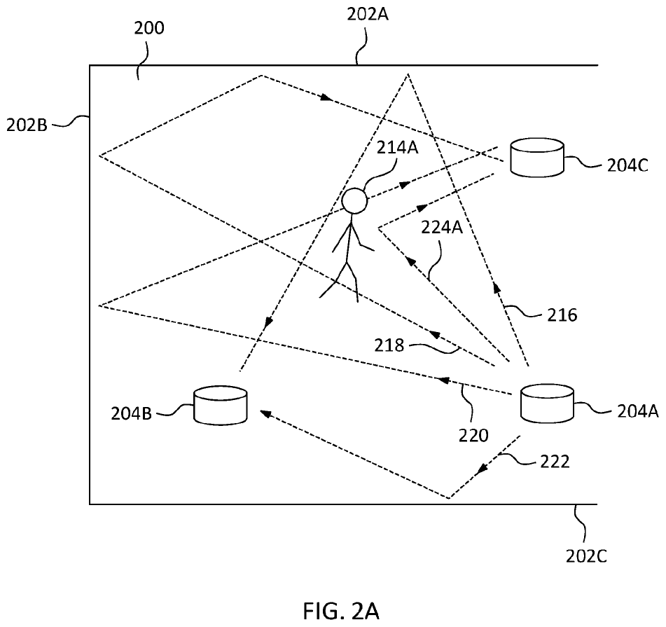

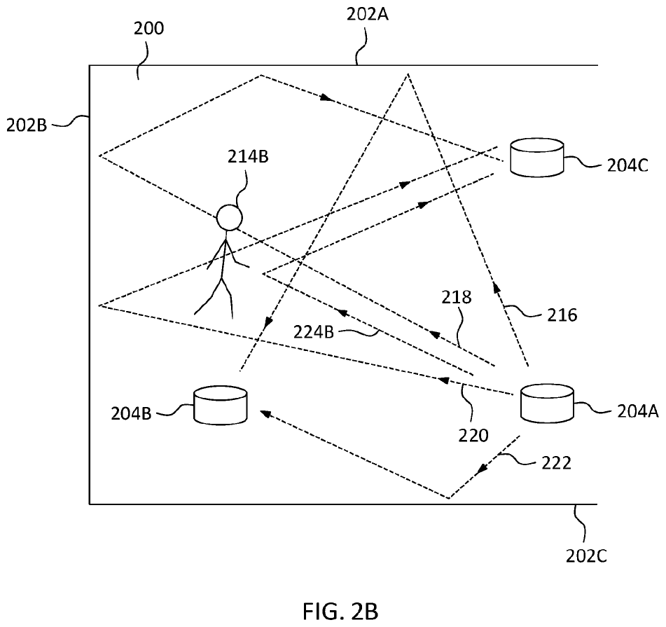

FIG. 2A and FIG. 2B are diagrams showing example wireless signals communicated between wireless communication devices 204A, 204B, 204C. Wireless communication devices 204A, 204B, 204C can be, for example, wireless communication devices 102A, 102B, 102C shown in FIG. 1, or other types of wireless communication devices. Wireless communication devices 204A, 204B, 204C transmit wireless signals through space 200. Space 200 can be completely or partially enclosed or open at one or more boundaries. Space 200 can be or can include an interior of a room, multiple rooms, a building, an indoor area, outdoor area, or the like. First wall 202A, second wall 202B, and third wall 202C at least partially enclose space 200 in the example shown.

In the example shown in FIG. 2A and FIG. 2B, wireless communication device 204A is operable to transmit wireless signals repeatedly (e.g., periodically, intermittently, at scheduled, unscheduled, or random intervals, etc.). Wireless communication devices 204B, 204C are operable to receive signals based on those transmitted by wireless communication device 204A. Wireless communication devices 204B, 204C each have a modem (e.g., modem 112 shown in FIG. 1) that is configured to process received signals to detect motion of an object in space 200.

As shown, an object is in first position 214A in FIG. 2A, and the object has moved to second position 214B in FIG. 2B. In FIG. 2A and FIG. 2B, the moving object in space 200 is represented as a human, but the moving object can be another type of object. For example, the moving object can be an animal, an inorganic object (e.g., a system, device, apparatus, or assembly), an object that defines all or part of the boundary of space 200 (e.g., a wall, door, window, etc.), or another type of object.

As shown in FIG. 2A and FIG. 2B, multiple example paths of the wireless signals transmitted from wireless communication device 204A are illustrated by dashed lines. Along first signal path 216, the wireless signal is transmitted from wireless communication device 204A and reflected off first wall 202A toward the wireless communication device 204B. Along second signal path 218, the wireless signal is transmitted from the wireless communication device 204A and reflected off second wall 202B and first wall 202A toward wireless communication device 204C. Along third signal path 220, the wireless signal is transmitted from the wireless communication device 204A and reflected off second wall 202B toward wireless communication device 204C. Along fourth signal path 222, the wireless signal is transmitted from the wireless communication device 204A and reflected off third wall 202C toward the wireless communication device 204B.

In FIG. 2A, along fifth signal path 224A, the wireless signal is transmitted from wireless communication device 204A and reflected off the object at first position 214A toward wireless communication device 204C. Between FIG. 2A and FIG. 2B, a surface of the object moves from first position 214A to second position 214B in space 200 (e.g., some distance away from first position 214A). In FIG. 2B, along sixth signal path 224B, the wireless signal is transmitted from wireless communication device 204A and reflected off the object at second position 214B toward wireless communication device 204C. Sixth signal path 224B depicted in FIG. 2B is longer than fifth signal path 224A depicted in FIG. 2A due to the movement of the object from first position 214A to second position 214B. In some examples, a signal path can be added, removed, or otherwise modified due to movement of an object in a space.

The example wireless signals shown in FIG. 2A and FIG. 2B may experience attenuation, frequency shifts, phase shifts, or other effects through their respective paths and may have portions that propagate in another direction, for example, through the first, second and third walls 202A, 202B, and 202C. In some examples, the wireless signals are radio frequency (RF) signals. The wireless signals may include other types of signals.

In the example shown in FIG. 2A and FIG. 2B, wireless communication device 204A can repeatedly transmit a wireless signal. In particular, FIG. 2A shows the wireless signal being transmitted from wireless communication device 204A at a first time, and FIG. 2B shows the same wireless signal being transmitted from wireless communication device 204A at a second, later time. The transmitted signal can be transmitted continuously, periodically, at random or intermittent times or the like, or a combination thereof. The transmitted signal can have a number of frequency components in a frequency bandwidth. The transmitted signal can be transmitted from wireless communication device 204A in an omnidirectional manner, in a directional manner or otherwise. In the example shown, the wireless signals traverse multiple respective paths in space 200, and the signal along each path may become attenuated due to path losses, scattering, reflection, or the like and may have a phase or frequency offset.

As shown in FIG. 2A and FIG. 2B, the signals from first to sixth paths 216, 218, 220, 222, 224A, and 224B combine at wireless communication device 204C and wireless communication device 204B to form received signals. Because of the effects of the multiple paths in space 200 on the transmitted signal, space 200 may be represented as a transfer function (e.g., a filter) in which the transmitted signal is input and the received signal is output. When an object moves in space 200, the attenuation or phase offset affected upon a signal in a signal path can change, and hence, the transfer function of space 200 can change. Assuming the same wireless signal is transmitted from wireless communication device 204A, if the transfer function of space 200 changes, the output of that transfer function—the received signal-will also change. A change in the received signal can be used to detect movement of an object.

Mathematically, a transmitted signal f(t) transmitted from the first wireless communication device 204A may be described according to Equation (1):

$$f ( t ) = {\sum }_{n = - ∞}^{∞} {c}_{n} {e}^{j {ω}_{n} t} \qquad ( 1 )$$

Where ωₙ represents the frequency of nth frequency component of the transmitted signal, cₙ represents the complex coefficient of the nth frequency component, and t represents time. With the transmitted signal f(t) being transmitted from the first wireless communication device 204A, an output signal rₖ(t) from a path k may be described according to Equation (2):

$${r}_{k} ( t ) = {\sum }_{n = - ∞}^{∞} {α}_{n , k} {c}_{n} {e}^{j ( {ω}_{n} t + {ϕ}_{n , k} )} \qquad ( 2 )$$

Where α_{n,k} represents an attenuation factor (or channel response; e.g., due to scattering, reflection, and path losses) for the nth frequency component along path k, and ϕ_{n,k} represents the phase of the signal for nth frequency component along path k. Then, the received signal R at a wireless communication device can be described as the summation of all output signals rₖ(t) from all paths to the wireless communication device, which is shown in Equation (3):

$$R = {\sum }_{k} {r}_{k} ( t ) \qquad ( 3 )$$

Substituting Equation (2) into Equation (3) renders the following Equation (4):

$$R = {\sum }_{k} {\sum }_{n = - ∞}^{∞} ( {α}_{n , k} {e}^{j {ϕ}_{n , k}} ) {c}_{n} {e}^{j {ω}_{n} t} \qquad ( 4 )$$

The received signal R at a wireless communication device can then be analyzed. The received signal R at a wireless communication device can be transformed to the frequency domain, for example, using a Fast Fourier Transform (FFT) or another type of algorithm. The transformed signal can represent the received signal R as a series of n complex values, one for each of the respective frequency components (at the n frequencies ωₙ). For a frequency component at frequency ωₙ, a complex value Hₙ may be represented as follows in Equation (5):

$${H}_{n} = {\sum }_{k} {c}_{n} {α}_{n , k} {e}^{j {ϕ}_{n , k}} \qquad ( 5 )$$

The complex value Hₙ for a given frequency component ωₙ indicates a relative magnitude and phase offset of the received signal at that frequency component ωₙ. When an object moves in the space, the complex value Hₙ changes due to the channel response α_{n,k} of the space changing. Accordingly, a change detected in the channel response can be indicative of movement of an object within the communication channel. In some instances, noise, interference, or other phenomena can influence the channel response detected by the receiver, and the motion detection system can reduce or isolate such influences to improve the accuracy and quality of motion detection capabilities. In some implementations, the overall channel response can be represented as follows in Equation (6):

$${h}_{ch} = {\sum }_{k} {\sum }_{n = - ∞}^{∞} {α}_{n , k} \qquad ( 6 )$$

In some instances, the channel response h_{ch} for a space can be determined, for example, based on the mathematical theory of estimation. For instance, a reference signal R_{ef} can be modified with candidate channel responses (h_{ch}), and then a maximum likelihood approach can be used to select the candidate channel which gives best match to the received signal (R_{evd}). In some cases, an estimated received signal (\hat{R}_{cvd}) is obtained from the convolution of the reference signal (R_{ef}) with the candidate channel responses (h_{ch}), and then the channel coefficients of the channel response (h_{ch}) are varied to minimize the squared error of the estimated received signal (\hat{R}_{cvd}). This can be mathematically illustrated as follows in Equation (7):

$${R}_{cvd} = {R}_{ef} ⊗ {h}_{ch} = {\sum }_{k = - m}^{m} {R}_{ef} ( n - k ) {h}_{ch} ( k ) \qquad ( 7 )$$

with the optimization criterion

$${min}_{{h}_{ch}} \sum {( {\hat{R}}_{cvd} - {R}_{cvd} )}^{2}$$

The minimizing, or optimizing, process can utilize an adaptive filtering technique, such as Least Mean Squares (LMS), Recursive Least Squares (RLS), Batch Least Squares (BLS), etc. The channel response can be a Finite Impulse Response (FIR) filter, Infinite Impulse Response (IIR) filter, or the like. As shown in the equation above, the received signal can be considered as a convolution of the reference signal and the channel response. The convolution operation means that the channel coefficients possess a degree of correlation with each of the delayed replicas of the reference signal. The convolution operation as shown in the equation above, therefore shows that the received signal appears at different delay points, each delayed replica being weighted by the channel coefficient.

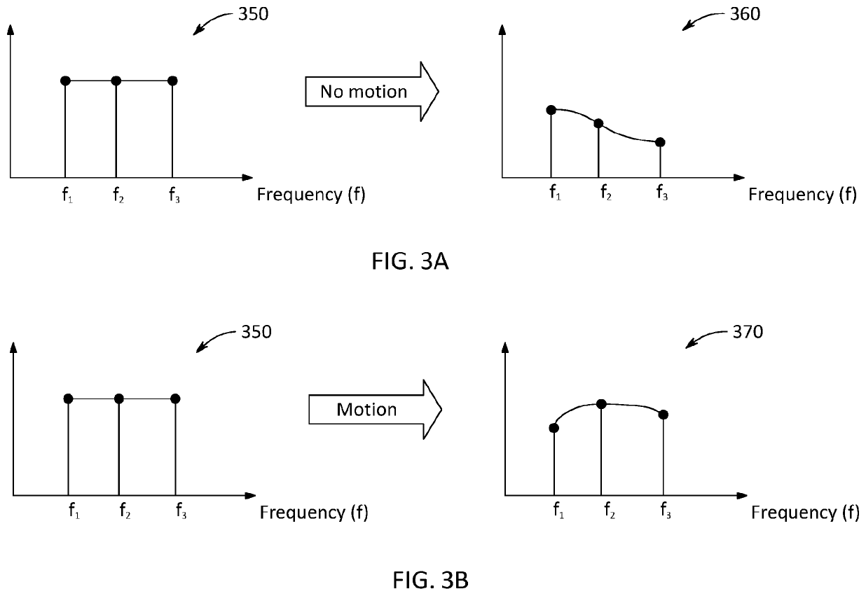

FIG. 3A and FIG. 3B are plots showing examples of channel responses 360, 370 computed from the wireless signals communicated between wireless communication devices 204A, 204B, 204C in FIG. 2A and FIG. 2B. FIG. 3A and FIG. 3B also show frequency domain representation 350 of an initial wireless signal transmitted by wireless communication device 204A. In the examples shown, channel response 360 in FIG. 3A represents the signals received by wireless communication device 204B when there is no motion in space 200, and channel response 370 in FIG. 3B represents the signals received by wireless communication device 204B in FIG. 2B after the object has moved in space 200.

In the example shown in FIG. 3A and FIG. 3B, for illustration purposes, wireless communication device 204A transmits a signal that has a flat frequency profile (the magnitude of each frequency component f₁, f₂, and f₃ is the same), as shown in frequency domain representation 350. Because of the interaction of the signal with space 200 (and the objects therein), the signals received at wireless communication device 204B that are based on the signal sent from wireless communication device 204A are different from the transmitted signal. In this example, where the transmitted signal has a flat frequency profile, the received signal represents the channel response of space 200. As shown in FIG. 3A and FIG. 3B, channel responses 360, 370 are different from frequency domain representation 350 of the transmitted signal. When motion occurs in space 200, a variation in the channel response will also occur. For example, as shown in FIG. 3B, channel response 370 that is associated with motion of object in space 200 varies from channel response 360 that is associated with no motion in space 200.

Furthermore, as an object moves within space 200, the channel response may vary from channel response 370. In some cases, space 200 can be divided into distinct regions and the channel responses associated with each region may share one or more characteristics (e.g., shape), as described below. Thus, motion of an object within different distinct regions can be distinguished, and the location of detected motion can be determined based on an analysis of channel responses.

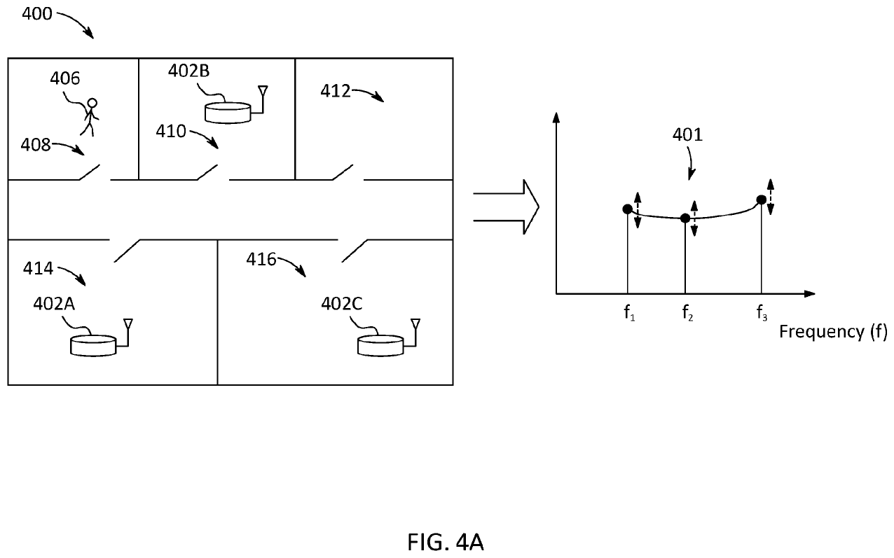

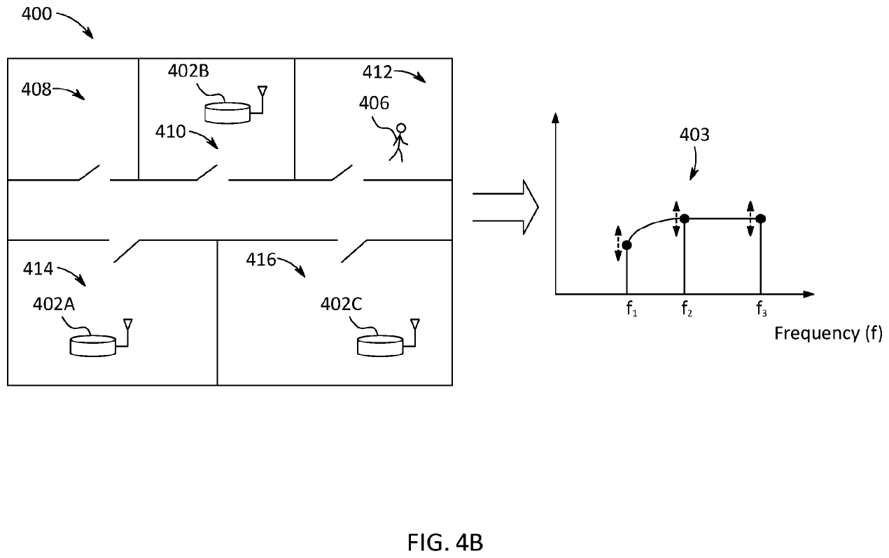

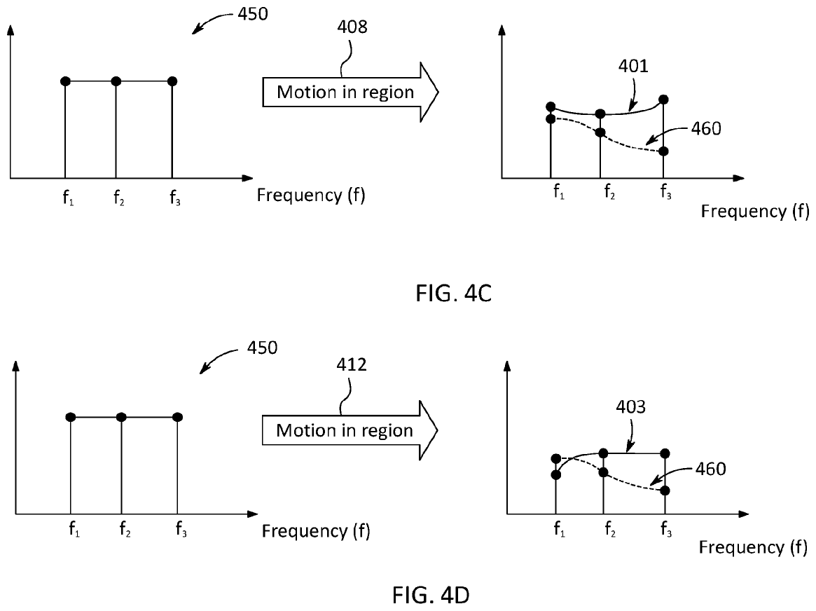

FIG. 4A and FIG. 4B are diagrams showing example channel responses 401, 403 associated with motion of object 406 in distinct regions 408, 412 of space 400 (in an example space 400 may be a sensing space). In the examples shown, space 400 is a building, and space 400 is divided into a plurality of distinct regions-first region 408, second region 410, third region 412, fourth region 414, and fifth region 416. Space 400 may include additional or fewer regions, in some instances. As shown in FIG. 4A and FIG. 4B, the regions within space 400 may be defined by walls between rooms. In addition, the regions may be defined by ceilings between floors of a building. For example, space 400 may include additional floors with additional rooms. In addition, in some instances, the plurality of regions of a space can be or include a number of floors in a multistory building, a number of rooms in the building, or a number of rooms on a particular floor of the building. In the example shown in FIG. 4A, an object located in first region 408 is represented as person 406, but the moving object can be another type of object, such as an animal or an inorganic object.

In the example shown, wireless communication device 402A is located in fourth region 414 of space 400, wireless communication device 402B is located in second region 410 of space 400, and wireless communication device 402C is located in fifth region 416 of space 400. Wireless communication devices 402 can operate in the same or similar manner as wireless communication devices 102 of FIG. 1. For instance, wireless communication devices 402 may be configured to transmit and receive wireless signals and detect whether motion has occurred in space 400 based on the received signals. As an example, wireless communication devices 402 may periodically or repeatedly transmit motion probe signals through space 400, and receive signals based on the motion probe signals. Wireless communication devices 402 can analyze the received signals to detect whether an object has moved in space 400, such as, for example, by analyzing channel responses associated with space 400 based on the received signals. In addition, in some implementations, wireless communication devices 402 can analyze the received signals to identify a location of detected motion within space 400. For example, wireless communication devices 402 can analyze characteristics of the channel response to determine whether the channel responses share the same or similar characteristics to channel responses known to be associated with first to fifth regions 408, 410, 412, 414, 416 of space 400.

In the examples shown, one (or more) of wireless communication devices 402 repeatedly transmits a motion probe signal (e.g., a reference signal) through space 400. The motion probe signals may have a flat frequency profile in some instances, wherein the magnitude of each frequency component f₁, f₂, and f₃. For example, the motion probe signals may have a frequency response similar to frequency domain representation 350 shown in FIG. 3A and FIG. 3B. The motion probe signals may have a different frequency profile in some instances. Because of the interaction of the reference signal with space 400 (and the objects therein), the signals received at another wireless communication device 402 that are based on the motion probe signal transmitted from the other wireless communication device 402 are different from the transmitted reference signal.

Based on the received signals, wireless communication devices 402 can determine a channel response for space 400. When motion occurs in distinct regions within the space, distinct characteristics may be seen in the channel responses. For example, while the channel responses may differ slightly for motion within the same region of space 400, the channel responses associated with motion in distinct regions may generally share the same shape or other characteristics. For instance, channel response 401 of FIG. 4A represents an example channel response associated with motion of object 406 in first region 408 of space 400, while channel response 403 of FIG. 4B represents an example channel response associated with motion of object 406 in third region 412 of space 400. Channel responses 401, 403 are associated with signals received by the same wireless communication device 402 in space 400.

FIG. 4C and FIG. 4D are plots showing channel responses 401, 403 of FIG. 4A and FIG. 4B overlaid on channel response 460 associated with no motion occurring in space 400. FIG. 4C-FIG. 4D also show frequency domain representation 450 of an initial wireless signal transmitted by one or more of wireless communication devices 402A, 402B, 402C. When motion occurs in space 400, a variation in the channel response will occur relative to channel response 460 associated with no motion, and thus, motion of an object in space 400 can be detected by analyzing variations in the channel responses. In addition, a relative location of the detected motion within space 400 can be identified. For example, the shape of channel responses associated with motion can be compared with reference information (e.g., using a trained AI model) to categorize the motion as having occurred within a distinct region of space 400.

When there is no motion in space 400 (e.g., when object 406 is not present), wireless communication device 402 may compute channel response 460 associated with no motion. Slight variations may occur in the channel response due to a number of factors; however, multiple channel responses 460 associated with different periods of time may share one or more characteristics. In the example shown, channel response 460 associated with no motion has a decreasing frequency profile (the magnitude of each frequency component f₁, f₂, and f₃ is less than the previous). The profile of channel response 460 may differ in some instances (e.g., based on different room layouts or placement of wireless communication devices 402).

When motion occurs in space 400, a variation in the channel response will occur. For instance, in the examples shown in FIG. 4C and FIG. 4D, channel response 401 associated with motion of object 406 in first region 408 differs from channel response 460 associated with no motion and channel response 403 associated with motion of object 406 in third region 412 differs from channel response 460 associated with no motion. Channel response 401 has a concave-parabolic frequency profile (the magnitude of the middle frequency component f₂ is less than the outer frequency components f₁ and f₃), while channel response 403 has a convex-asymptotic frequency profile (the magnitude of the middle frequency component f₂ is greater than the outer frequency components f₁ and f₃). The profiles of channel responses 401, 403 may differ in some instances (e.g., based on different room layouts or placement of the wireless communication devices 402).

Analyzing channel responses may be considered similar to analyzing a digital filter. A channel response may be formed through the reflections of objects in a space as well as reflections created by a moving or static human. When a reflector (e.g., a human) moves, it changes the channel response. This may translate to a change in equivalent taps of a digital filter, which can be thought of as having poles and zeros (poles amplify the frequency components of a channel response and appear as peaks or high points in the response, while zeros attenuate the frequency components of a channel response and appear as troughs, low points, or nulls in the response). A changing digital filter can be characterized by the locations of its peaks and troughs, and a channel response may be characterized similarly by its peaks and troughs. For example, in some implementations, analyzing nulls and peaks in the frequency components of a channel response (e.g., by marking their location on the frequency axis and their magnitude), motion can be detected.

In some implementations, a time series aggregation can be used to detect motion. A time series aggregation may be performed by observing the features of a channel response over a moving window and aggregating the windowed result by using statistical measures (e.g., mean, variance, principal components, etc.). During instances of motion, the characteristic digital-filter features would be displaced in location and flip-flop between some values due to the continuous change in the scattering scene. That is, an equivalent digital filter exhibits a range of values for its peaks and nulls (due to the motion). By looking this range of values, unique profiles (in examples profiles may also be referred to as signatures) may be identified for distinct regions within a space.

In some implementations, an artificial intelligence (AI) model may be used to process data. AI models may be of a variety of types, for example linear regression models, logistic regression models, linear discriminant analysis models, decision tree models, naïve bayes models, K-nearest neighbors models, learning vector quantization models, support vector machines, bagging and random forest models, and deep neural networks. In general, all AI models aim to learn a function which provides the most precise correlation between input values and output values and are trained using historic sets of inputs and outputs that are known to be correlated. In examples, artificial intelligence may also be referred to as machine learning.

In some implementations, the profiles of the channel responses associated with motion in distinct regions of space 400 can be learned. For example, machine learning may be used to categorize channel response characteristics with motion of an object within distinct regions of a space. In some cases, a user associated with wireless communication devices 402 (e.g., an owner or other occupier of space 400) can assist with the learning process. For instance, referring to the examples shown in FIG. 4A and FIG. 4B, the user can move in each of first to fifth regions 408, 410, 412, 414, 416 during a learning phase and may indicate (e.g., through a user interface on a mobile computing device) that he/she is moving in one of the particular regions in space 400. For example, while the user is moving through first region 408 (e.g., as shown in FIG. 4A) the user may indicate on a mobile computing device that he/she is in first region 408 (and may name the region as “bedroom”, “living room”, “kitchen”, or another type of room of a building, as appropriate). Channel responses may be obtained as the user moves through the region, and the channel responses may be “tagged” with the user's indicated location (region). The user may repeat the same process for the other regions of space 400. The term “tagged” as used herein may refer to marking and identifying channel responses with the user's indicated location or any other information.

The tagged channel responses can then be processed (e.g., by machine learning software) to identify unique characteristics of the channel responses associated with motion in the distinct regions. Once identified, the identified unique characteristics may be used to determine a location of detected motion for newly computed channel responses. For example, an AI model may be trained using the tagged channel responses, and once trained, newly computed channel responses can be input to the AI model, and the AI model can output a location of the detected motion. For example, in some cases, mean, range, and absolute values are input to an AI model. In some instances, magnitude and phase of the complex channel response itself may be input as well. These values allow the AI model to design arbitrary front-end filters to pick up the features that are most relevant to making accurate predictions with respect to motion in distinct regions of a space. In some implementations, the AI model is trained by performing a stochastic gradient descent. For instance, channel response variations that are most active during a certain zone may be monitored during the training, and the specific channel variations may be weighted heavily (by training and adapting the weights in the first layer to correlate with those shapes, trends, etc.). The weighted channel variations may be used to create a metric that activates when a user is present in a certain region.

For extracted features like channel response nulls and peaks, a time-series (of the nulls/peaks) may be created using an aggregation within a moving window, taking a snapshot of few features in the past and present, and using that aggregated value as input to the network. Thus, the network, while adapting its weights, will be trying to aggregate values in a certain region to cluster them, which can be done by creating a logistic classifier based decision surfaces. The decision surfaces divide different clusters and subsequent layers can form categories based on a single cluster or a combination of clusters.

In some implementations, an AI model includes two or more layers of inference. The first layer acts as a logistic classifier which can divide different concentration of values into separate clusters, while the second layer combines some of these clusters together to create a category for a distinct region. Additional, subsequent layers can help in extending the distinct regions over more than two categories of clusters. For example, a fully-connected AI model may include an input layer corresponding to the number of features tracked, a middle layer corresponding to the number of effective clusters (through iterating between choices), and a final layer corresponding to different regions. Where complete channel response information is input to the AI model, the first layer may act as a shape filter that can correlate certain shapes. Thus, the first layer may lock to a certain shape, the second layer may generate a measure of variation happening in those shapes, and third and subsequent layers may create a combination of those variations and map them to different regions within the space. The output of different layers may then be combined through a fusing layer.

### B. Wi-Fi Sensing System Example Methods and Apparatus

Section B describes systems and methods that are useful for a Wi-Fi sensing system configurated to send sensing transmissions and make sensing measurements.

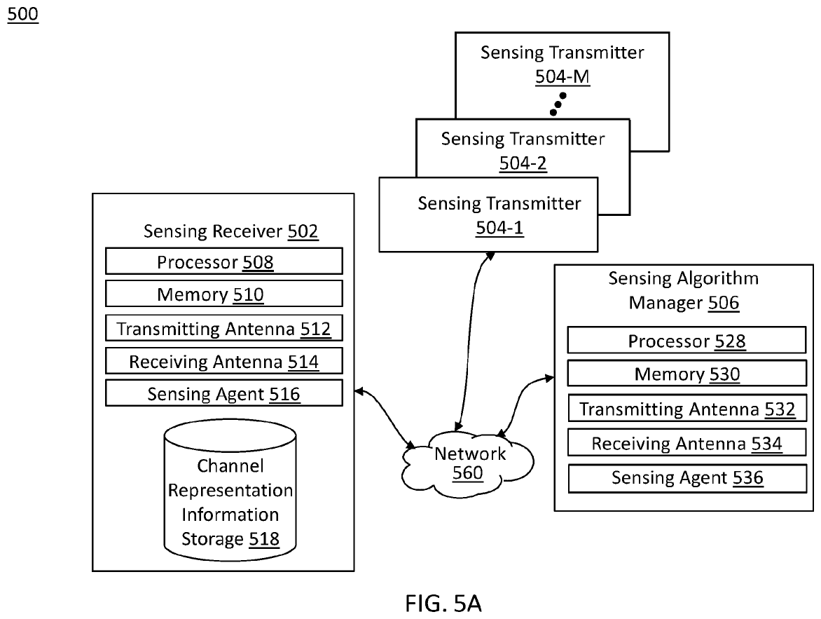

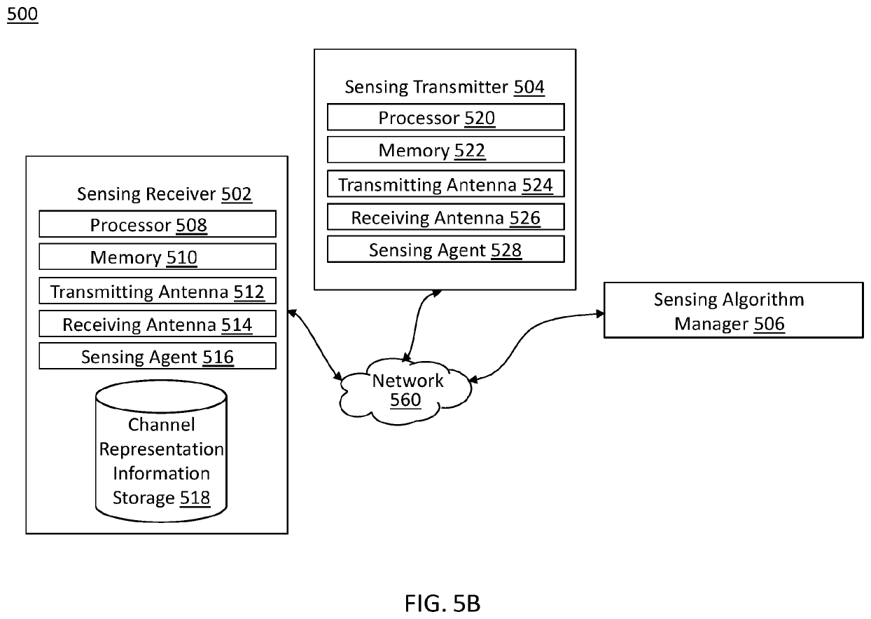

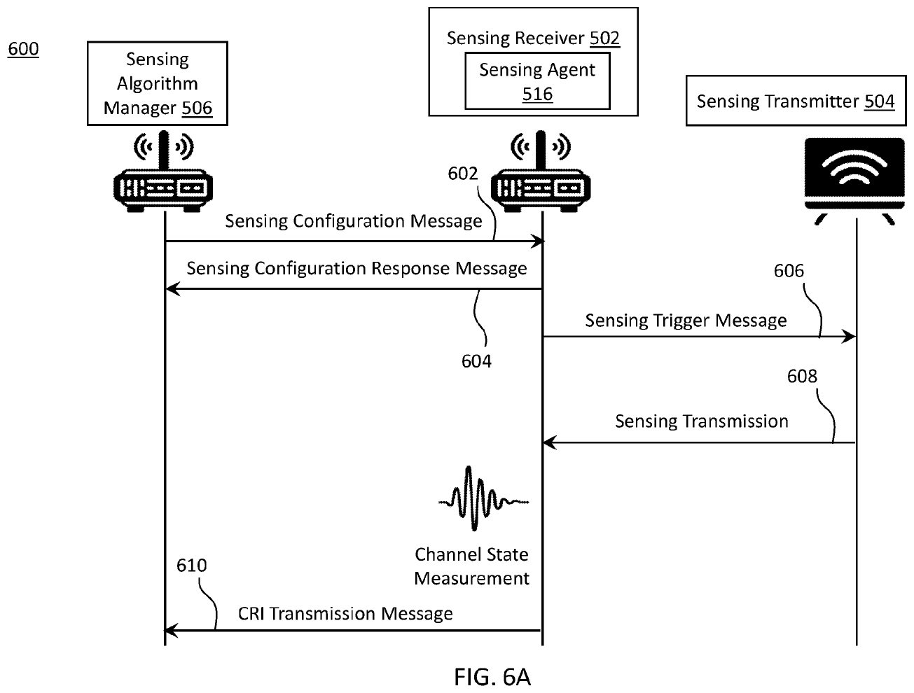

FIG. 5A and FIG. 5B depict an implementation of some of an architecture of an implementation of system 500 for Wi-Fi sensing, according to some embodiments. FIG. 5A and FIG. 5B do not represent separate and exclusive embodiments. FIG. 5A and FIG. 5B illustrate various aspects of embodiments as described herein.

System 500 may include sensing receiver 502, plurality of sensing transmitter 504-(1-M), sensing algorithm manager 506, and network 560 enabling communication between the system components for information exchange. In some examples, sensing algorithm manager 506 may be interchangeably referred to as remote processing device. System 500 may be an example or instance of wireless communication system 100, and network 560 may be an example or instance of wireless network or cellular network, details of which are provided with reference to FIG. 1 and its accompanying description.

According to an embodiment, sensing receiver 502 may be configured to receive a sensing transmission (for example, from each of plurality of sensing transmitters 504-(1-M))) and perform one or more measurements (for example, channel state information (CSI)) useful for Wi-Fi sensing. These measurements may be known as sensing measurements. The sensing measurements may be processed to achieve a sensing result of system 500, such as detecting motions or gestures. In an embodiment, sensing receiver 502 may be an AP. In some embodiments, sensing receiver 502 may take a role of sensing initiator.

According to an implementation, sensing receiver 502 may be implemented by a device, such as wireless communication device 102 shown in FIG. 1. In some implementations, sensing receiver 502 may be implemented by a device, such as wireless communication device 204 shown in FIG. 2A and FIG. 2B. Further, sensing receiver 502 may be implemented by a device, such as wireless communication device 402 shown in FIG. 4A and FIG. 4B. In an implementation, sensing receiver 502 may coordinate and control communication among plurality of sensing transmitters 504-(1-M). According to an implementation, sensing receiver 502 may be enabled to control a measurement campaign to ensure that required sensing transmissions are made at a required time and to ensure an accurate determination of sensing measurement. In some embodiments, sensing receiver 502 may process sensing measurements to achieve the sensing result of system 500. In some embodiments, sensing receiver 502 may be configured to transmit sensing measurements to sensing algorithm manager 506, and sensing algorithm manager 506 may be configured to process the sensing measurements to achieve the sensing result of system 500.

Referring again to FIG. 5A/FIG. 5B, in some embodiments, each of plurality of sensing transmitters 504-(1-M) may form a part of a basic service set (BSS) and may be configured to send a sensing transmission to sensing receiver 502 based on which, one or more sensing measurements (for example, CSI) may be performed for Wi-Fi sensing. In an embodiment, each of plurality of sensing transmitters 504-(1-M) may be a station. According to an implementation, each of plurality of sensing transmitters 504-(1-M) may be implemented by a device, such as wireless communication device 102 shown in FIG. 1. In some implementations, each of plurality of sensing transmitters 504-(1-M) may be implemented by a device, such as wireless communication device 204 shown in FIG. 2A and FIG. 2B. Further, each of plurality of sensing transmitters 504-(1-M) may be implemented by a device, such as wireless communication device 402 shown in FIG. 4A and FIG. 4B. In some implementations, communication between sensing receiver 502 and each of plurality of sensing transmitters 504-(1-M) may happen via station management entity (SME) and MAC layer management entity (MLME) protocols.

In some embodiments, sensing algorithm manager 506 may be configured to receive sensing measurements from sensing receiver 502 and process the sensing measurements. In an example, sensing algorithm manager 506 may process and analyze the sensing measurements to identify one or more features of interest. According to some implementations, sensing algorithm manager 506 may include/execute a sensing algorithm. In an embodiment, sensing algorithm manager 506 may be a station. In some embodiments, sensing algorithm manager 506 may be an AP. According to an implementation, sensing algorithm manager 506 may be implemented by a device, such as wireless communication device 102 shown in FIG. 1. In some implementations, sensing algorithm manager 506 may be implemented by a device, such as wireless communication device 204 shown in FIG. 2A and FIG. 2B. Further, sensing algorithm manager 506 may be implemented by a device, such as wireless communication device 402 shown in FIG. 4A and FIG. 4B. In some embodiments, sensing algorithm manager 506 may be any computing device, such as a desktop computer, a laptop, a tablet computer, a mobile device, a personal digital assistant (PDA) or any other computing device. In embodiments, sensing algorithm manager 506 may take a role of sensing initiator where a sensing algorithm determines a measurement campaign and the sensing measurements required to fulfill the measurement campaign. Sensing algorithm manager 506 may communicate the sensing measurements required to fulfill the measurement campaign to sensing receiver 502 to coordinate and control communication among plurality of sensing transmitters 504-(1-M).

Although sensing algorithm manager 506 is shown in FIG. 5A as a functional block separate from sensing receiver 502 and sensing transmitter 504-(1-M), in an embodiment of system 500, sensing algorithm manager 506 may be implemented by either sensing receiver 502 or one of sensing transmitter 504-(1-M). In embodiments, sensing agent 516 of sensing receiver or sensing agent 528 of sensing transmitter may implement the functionality of sensing algorithm manager 506.

Referring to FIG. 5A/FIG. 5B, in more detail, sensing receiver 502 may include processor 508 and memory 510. For example, processor 508 and memory 510 of sensing receiver 502 may be processor 114 and memory 116, respectively, as shown in FIG. 1. In an embodiment, sensing receiver 502 may further include transmitting antenna(s) 512, receiving antenna(s) 514, and sensing agent 516. In some embodiments, an antenna may be used to both transmit and receive signals in a half-duplex format. When the antenna is transmitting, it may be referred to as transmitting antenna 512, and when the antenna is receiving, it may be referred to as receiving antenna 514. It is understood by a person of normal skill in the art that the same antenna may be transmitting antenna 512 in some instances and receiving antenna 514 in other instances. In the case of an antenna array, one or more antenna elements may be used to transmit or receive a signal, for example, in a beamforming environment. In some examples, a group of antenna elements used to transmit a composite signal may be referred to as transmitting antenna 512, and a group of antenna elements used to receive a composite signal may be referred to as receiving antenna 514. In some examples, each antenna is equipped with its own transmission and receive paths, which may be alternately switched to connect to the antenna depending on whether the antenna is operating as transmitting antenna 512 or receiving antenna 514.

In an implementation, sensing agent 516 may be responsible for receiving sensing transmissions and associated transmission parameters, calculating sensing measurements, and processing sensing measurements to fulfill a sensing result. In some implementations, receiving sensing transmissions and associated transmission parameters, and calculating sensing measurements may be carried out by an algorithm running in the Medium Access Control (MAC) layer of sensing receiver 502 and processing sensing measurements to fulfill a sensing result may be carried out by an algorithm running in the application layer of sensing receiver 502. In examples, the algorithm running in the application layer of sensing receiver 502 is known as Wi-Fi sensing agent, sensing application, or sensing algorithm. In some implementations, the algorithm running in the MAC layer of sensing receiver 502 and the algorithm running in the application layer of sensing receiver 502 may run separately on processor 508. In an implementation, sensing agent 516 may pass physical layer parameters (e.g., such as CSI) from the MAC layer of sensing receiver 502 to the application layer of sensing receiver 502 and may use the physical layer parameters to detect one or more features of interest. In an example, the application layer may operate on the physical layer parameters and form services or features, which may be presented to an end-user. According to an implementation, communication between the MAC layer of sensing receiver 502 and other layers or components may take place based on communication interfaces, such as MLME interface and a data interface. According to some implementations, sensing agent 516 may include/execute a sensing algorithm. In an implementation, sensing agent 516 may process and analyze sensing measurements using the sensing algorithm, and identify one or more features of interest. Further, sensing agent 516 may be configured to determine a number and timing of sensing transmissions and sensing measurements for the purpose of Wi-Fi sensing. In some implementations, sensing agent 516 may be configured to transmit sensing measurements to sensing algorithm manager 506 for further processing.

In an implementation, sensing agent 516 may be configured to cause at least one transmitting antenna of transmitting antenna(s) 512 to transmit messages to plurality of sensing transmitters 504-(1-M). Further, sensing agent 516 may be configured to receive, via at least one receiving antenna of receiving antennas(s) 514, messages from plurality of sensing transmitters 504-(1-M). In an example, sensing agent 516 may be configured to make sensing measurements based on one or more sensing transmissions received from plurality of sensing transmitters 504-(1-M). According to an implementation, sensing agent 516 may be configured to process and analyze the sensing measurements to identify one or more features of interest.

According to some embodiments, sensing receiver 502 may include channel representation information storage 518. In an implementation, channel representation information storage 518 may store information related to sensing measurements that represent a state of the propagation channels between sensing receiver 502 and plurality of sensing transmitters 504-(1-M). In an example, channel representation information storage 518 may store one or more of CSI, full time-domain channel representation information (TD-CRI), filtered TD-CRI, and partial TD-CRI. Information related to the sensing measurements stored in channel representation information storage 518 may be periodically or dynamically updated as required. In some embodiments, results of calculations contributing to partial TD-CRI may be stored on a temporary basis in channel representation information storage 518. In an implementation, channel representation information storage 518 may include any type or form of storage, such as a database or a file system or coupled to memory 510.

Referring again to FIG. 5A, sensing algorithm manager 506 may include processor 528 and memory 530. For example, processor 528 and memory 530 of sensing algorithm manager 506 may be processor 114 and memory 116, respectively, as shown in FIG. 1. In an embodiment, sensing algorithm manager 506 may further include transmitting antenna(s) 532, receiving antenna(s) 534, and sensing agent 536. In an implementation, sensing agent 536 may be a block that passes physical layer parameters from the MAC of sensing algorithm manager 506 to application layer programs. Sensing agent 536 may be configured to cause at least one transmitting antenna of transmitting antenna(s) 532 and at least one receiving antenna of receiving antennas(s) 534 to exchange messages with sensing receiver 502. According to some implementations, sensing agent 536 may be responsible for receiving sensing measurements from sensing receiver 502, and processing the sensing measurements to obtain a sensing result. Sensing agent 536 may include/execute a sensing algorithm. In an implementation, sensing agent 536 may process and analyze sensing measurements using the sensing algorithm, and obtain the sensing result.

Referring now to FIG. 5B, a sensing transmitter 504 of the plurality of sensing transmitters 504-(1-M) may include processor 520 and memory 522. For example, processor 520 and memory 522 of sensing transmitter 504 may be processor 114 and memory 116, respectively, as shown in FIG. 1. In an embodiment, sensing transmitter 504 may further include transmitting antenna(s) 524, receiving antenna(s) 526, and sensing agent 528. In an implementation, sensing agent 528 may be a block that passes physical layer parameters from the MAC of sensing transmitter 504 to application layer programs. Sensing agent 528 may be configured to cause at least one transmitting antenna of transmitting antenna(s) 524 and at least one receiving antenna of receiving antennas(s) 526 to exchange messages with sensing receiver 502.

In some embodiments, an antenna may be used to both transmit and receive in a half-duplex format. When the antenna is transmitting, it may be referred to as transmitting antenna 512, 532, 524, and when the antenna is receiving, it may be referred to as receiving antenna 514, 526, 534. It is understood by a person of normal skill in the art that the same antenna may be transmitting antenna 512, 532, 524 in some instances and receiving antenna 514, 526, 534 in other instances. In the case of an antenna array, one or more antenna elements may be used to transmit or receive a signal, for example, in a beamforming environment. In some examples, a group of antenna elements used to transmit a composite signal may be referred to as transmitting antenna 512, 532, 524, and a group of antenna elements used to receive a composite signal may be referred to as receiving antenna 514, 526, 534. In some examples, each antenna is equipped with its own transmission and receive paths, which may be alternately switched to connect to the antenna depending on whether the antenna is operating as transmitting antenna 512, 532, 524 or receiving antenna 514, 526, 534.

In embodiment where sensing algorithm manager 506 is implemented by sensing receiver 502 then processor 528 may be implemented by processor 508, memory 530 may be implemented by memory 510, transmitting antenna 532 may implemented by transmitting antenna 512, receiving antenna 534 may implemented by receiving antenna 514, and sensing agent 536 may be implemented by sensing agent 516. In examples where sensing algorithm manager 506 receives signals from sensing receiver 502 or where sensing receiver 502 receives signals from sensing algorithm manager 506 then this may be implemented without transmission over the air.

According to one or more implementations, communications in network 560 may be governed by one or more of the 802.11 family of standards developed by IEEE. Some example IEEE standards may include IEEE 802.11-2020, IEEE 802.11ax-2021, IEEE 802.11me, IEEE 802.11az and IEEE 802.11be. IEEE 802.11-2020 and IEEE 802.11ax-2021 are fully-ratified standards whilst IEEE 802.11 me reflects an ongoing maintenance update to the IEEE 802.11-2020 standard and IEEE 802.11be defines the next generation of standard. IEEE 802.11az is an extension of the IEEE 802.11-2020 and IEEE 802.11ax-2021 standards which adds new functionality. In some implementations, communications may be governed by other standards (other or additional IEEE standards or other types of standards). In some embodiments, parts of network 560 which are not required by system 500 to be governed by one or more of the 802.11 family of standards may be implemented by an instance of any type of network, including wireless network or cellular network.

For ease of explanation and understanding, the description hereinafter is provided with reference to an individual sensing transmitter 504, however the description is equally applicable to any of sensing transmitters 504-(1-M).

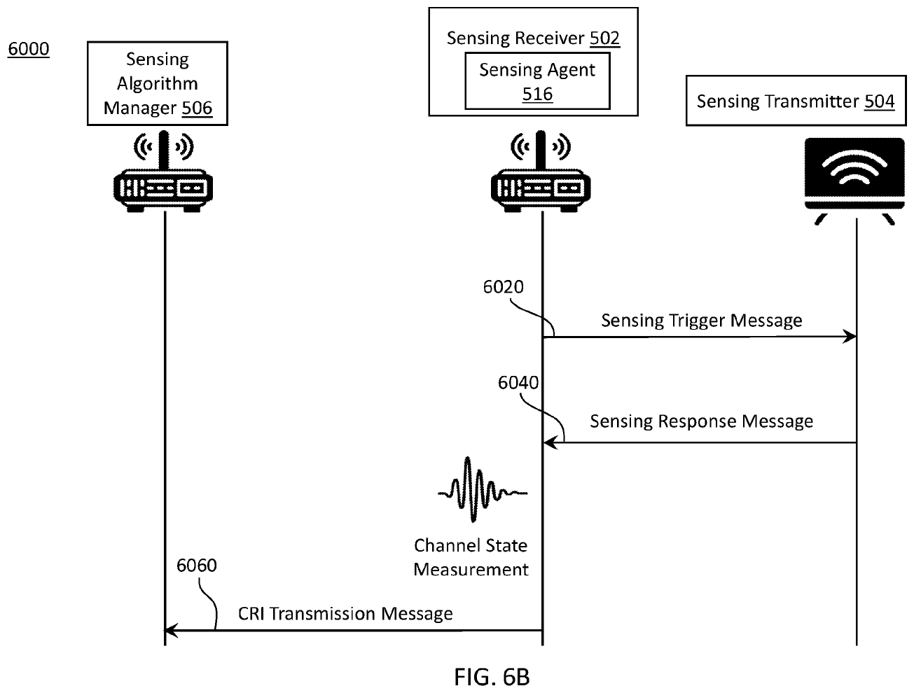

FIG. 6A depicts sequence diagram 600 for communication between sensing receiver 502, sensing transmitter 504, and sensing algorithm manager 506, where sensing receiver 502 is a sensing initiator, according to some embodiments. FIG. 6A shows an example of a network (for example, 802.11 network) where sensing algorithm manager 506 is a separate device.

As shown in FIG. 6A, at step 602, sensing algorithm manager 506 may send a sensing configuration message to sensing receiver 502. In an example, the sensing configuration message may include a channel representation information configuration. At step 604, in response to the sensing configuration message, sensing receiver 502 may send an acknowledgment using a sensing configuration response message and configure sensing agent 516 with the channel representation information configuration for use in generating filtered TD-CRI. At step 606, sensing receiver 502 may initiate a sensing session and send a sensing trigger message to sensing transmitter 504 requesting a sensing transmission. At step 608, sensing transmitter 504 may send a sensing transmission to sensing receiver 502 in response to the sensing trigger message. Upon receiving the sensing transmission, sensing receiver 502 may perform a channel state measurement on the received sensing transmission and generate channel representation information using the channel representation information configuration. In an example, sensing receiver 502 may generate filtered TD-CRI. At step 610, sensing receiver 502 may send a CRI transmission message including the channel state measurement (i.e., the filtered TD-CRI) to sensing algorithm manager 506 over the air for further processing.

FIG. 6B depicts another sequence diagram 6000 for communication between sensing receiver 502, sensing transmitter 504, and sensing algorithm manager 506, where sensing receiver 502 is a sensing initiator, according to some embodiments. FIG. 6B shows an example of a network (for example, 802.11 network) where sensing algorithm manager 506 is a separate device.

As shown in FIG. 6B, at step 6020, sensing receiver 502 may initiate a sensing session and send a sensing trigger message to sensing transmitter 504 requesting a sensing transmission. At step 6040, sensing transmitter 504 may send a sensing response message as a sensing transmission to sensing receiver 502 in response to the sensing trigger message. Upon receiving the sensing response message, sensing receiver 502 may perform a channel state measurement on the received sensing transmission and generate channel representation information (CRI) using the channel representation information configuration. In an example, sensing receiver 502 may generate a reduced CRI. In an example, the reduced CRI may be a filtered TD-CRI. At step 6060, sensing receiver 502 may send a CRI transmission message including the channel state measurement (e.g., the reduced CRI) to sensing algorithm manager 506 over the air for further processing.

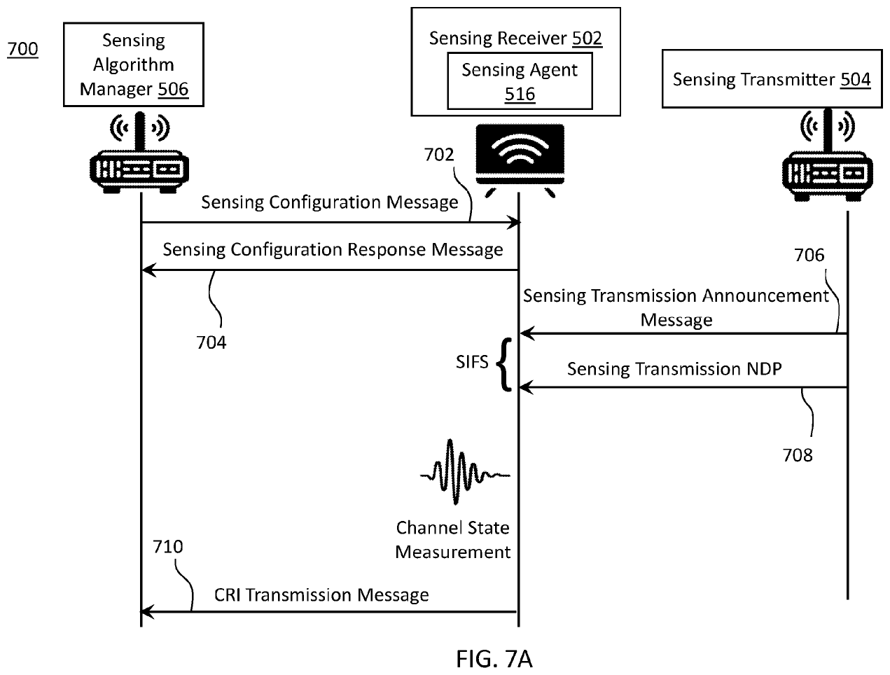

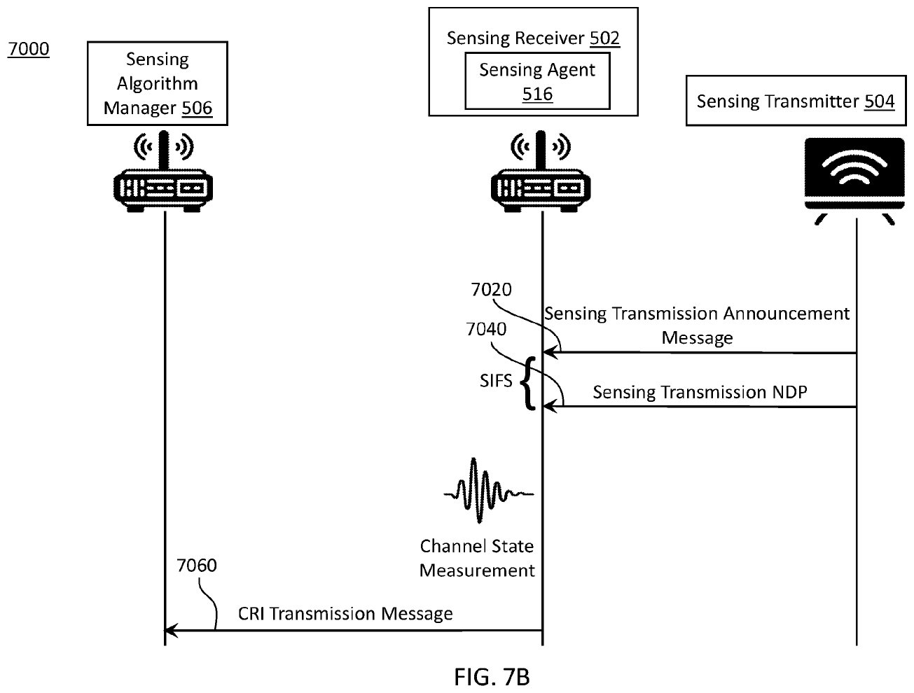

FIG. 7A depicts sequence diagram 700 for communication between sensing receiver 502, sensing transmitter 504, and sensing algorithm manager 506, where sensing transmitter 504 is a sensing initiator, according to some embodiments. FIG. 7A shows an example of a network (for example, 802.11 network) where sensing algorithm manager 506 is a separate device. As shown in FIG. 7A, at step 702, sensing algorithm manager 506 may send a sensing configuration message to sensing receiver 502. In an example, the sensing configuration message may include a channel representation information configuration. At step 704, in response to the sensing configuration message, sensing receiver 502 may send an acknowledgment using a sensing configuration response message and configure sensing agent 516 with the channel representation information configuration for use in generating filtered TD-CRI. At step 706, sensing transmitter 504 may initiate a sensing session and send a sensing transmission announcement message followed by a sensing transmission NDP to sensing receiver 502. As described in step 708, the sensing transmission NDP follows the sensing transmission announcement message after one SIFS. In an example, the duration of SIFS is 10 μs. Sensing receiver 502 may perform a channel state measurement on the sensing transmission NDP and generate channel representation information based on the channel representation information configuration. In an example, the sensing receiver 502 may generate filtered TD-CRI. At step 710, sensing receiver 502 may send a CRI transmission message including the channel state measurement (i.e., the filtered TD-CRI) to sensing algorithm manager 506 over the air for further processing.

FIG. 7B depicts another sequence diagram 7000 for communication between sensing receiver 502, sensing transmitter 504, and sensing algorithm manager 506, where sensing transmitter 504 is a sensing initiator, according to some embodiments. FIG. 7B shows an example of a network (for example, 802.11 network) where sensing algorithm manager 506 is a separate device. As shown in FIG. 7B, at step 7020, sensing transmitter 504 may initiate a sensing session and send a sensing transmission announcement message followed by a sensing transmission NDP to sensing receiver 502. As described in step 7040, the sensing transmission NDP follows the sensing transmission announcement message after one SIFS. In an example, the duration of SIFS is 10 μs. Sensing receiver 502 may perform a channel state measurement on the sensing transmission NDP and generate CRI based on the channel representation information configuration. In an example, sensing receiver 502 may generate reduced CRI. In an example, the reduced CRI may be a filtered TD-CRI. At step 7060, sensing receiver 502 may send a CRI transmission message including the channel state measurement (e.g., the reduced CRI) to sensing algorithm manager 506 over the air for further processing.

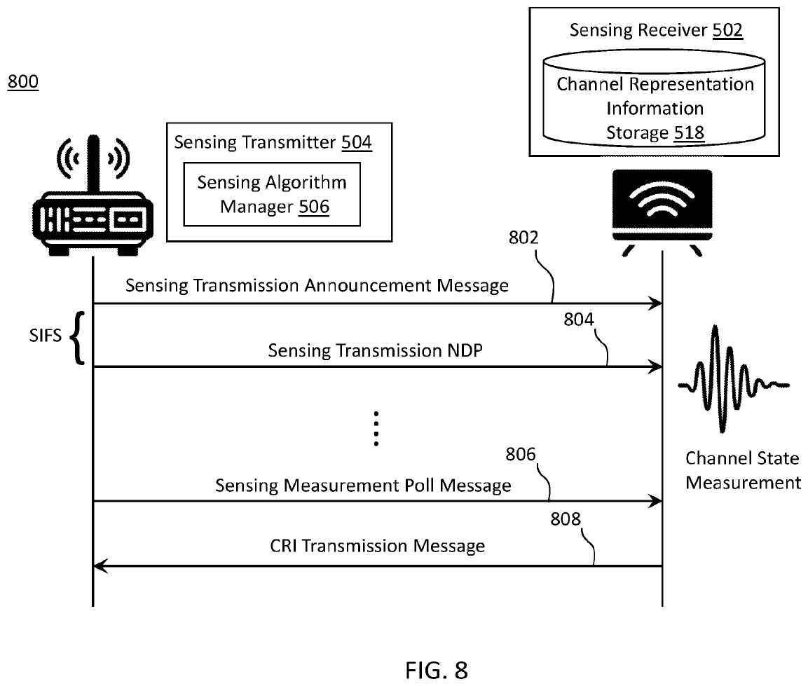

FIG. 8 depicts sequence diagram 800 for communication between sensing receiver 502 and sensing transmitter 504-1 including sensing algorithm manager 506, where sensing transmitter 504-1 is a sensing initiator, according to some embodiments. FIG. 8 shows an example of a network (for example, 802.11 network) where sensing transmitter 504-1 includes sensing algorithm manager 506.

As shown in FIG. 8, at step 802, sensing transmitter 504-1 may initiate a sensing session and send a sensing transmission announcement message followed by a sensing transmission NDP to sensing receiver 502. In an example, the sensing transmission announcement message may include a channel representation information configuration. As described in step 804, the sensing transmission NDP follows the sensing transmission announcement message after one SIFS. In an example, the duration of SIFS is 10 μs. In an implementation, sensing receiver 502 may perform a channel state measurement on the sensing transmission NDP and generate channel representation information based on the channel representation information configuration. In an example, the sensing receiver 502 may generate filtered TD-CRI. In an implementation, sensing receiver 502 may store the channel state measurement in a temporary storage, such as channel representation information storage 518. In another example, sensing receiver 502 may perform a channel state measurement on the sensing transmission NDP and store the resultant CSI measurement in channel representation information storage 518. In an example, sensing receiver 502 may hold the channel state measurement until it receives a sensing measurement poll message. At step 806, sensing transmitter 504-1 may send a sensing measurement poll message to sensing receiver 502, which may trigger sensing receiver 502 to send an already formatted channel state measurement (i.e., filtered TD-CRI) to sensing transmitter 504-1. In another example, sensing transmitter 504-1 may send a sensing measurement poll message to sensing receiver 502 which includes a channel representation information configuration. The sensing measurement poll message may trigger sensing receiver 502 to generate filtered TD-CRI from a CSI measurement stored in channel representation information storage 518 and according to the channel representation information configuration, and to transfer the filtered TD-CRI to sensing transmitter 504-1. At step 808, sensing receiver 502 may send a CRI transmission message including the channel state measurement (i.e., the filtered TD-CRI) to sensing transmitter 504-1 over the air. According to some implementations, sensing transmitter 504-1 may request the channel representation information in multiple formats using multiple sensing measurement poll messages.

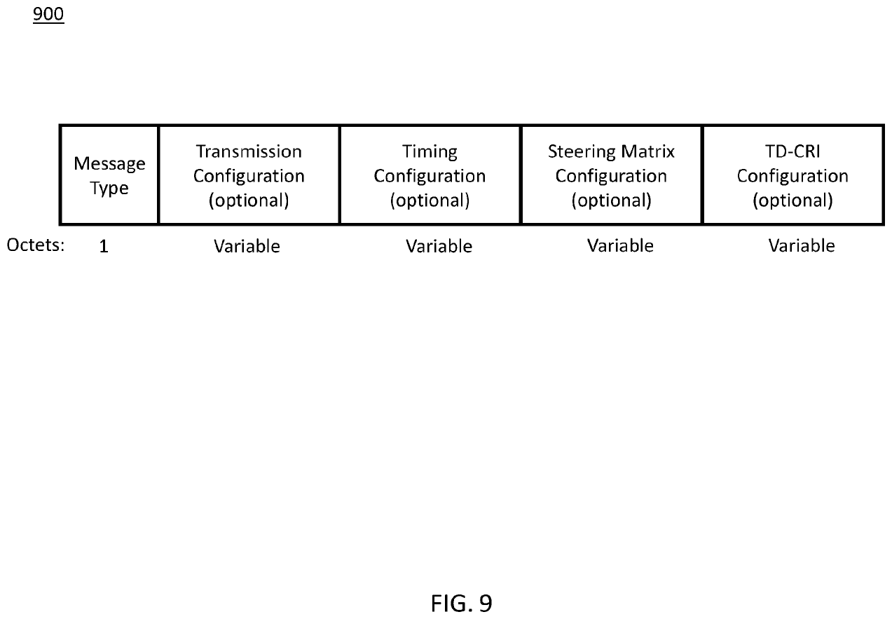

As described above, some embodiments of the present disclosure define two sensing message types for Wi-Fi sensing, namely, sensing configuration message and sensing configuration response message. In an example, the sensing configuration message and the sensing configuration response message are carried in a new extension to a management frame of a type described in IEEE 802.11. FIG. 9 illustrates an example of a component of a management frame 900 carrying a sensing transmission. In an example, system 500 may require acknowledgement frames and the management frame carrying sensing messages may be implemented as an Action frame and in another example, system 500 may not require acknowledgement frames and the management frame carrying sensing messages may be implemented as an Action No Ack frame. In some examples, all message types are carried in a new extension to an IEEE 802.11 control frame. In some examples, a combination of management and control frames may be used to realize these sensing message types.

In an implementation, the information content of all sensing message types may be carried in a format as shown in FIG. 9. In some examples, Transmission Configuration, Timing Configuration, Steering Matrix Configuration, and TD-CRI configuration as described in FIG. 9 are implemented as IEEE 802.11 elements. In some examples, the TD-CRI Configuration element is a part of the Transmission Configuration element.

In one or more embodiments, the sensing message types may be identified by the message type field, and each sensing message type may carry the other identified elements, according to some embodiments. Examples of sensing message types and TD-CRI configuration elements are shown in Table 1.

TABLE 1
Sensing message types and TD-CRI configuration elements

| | Message | Message | |
|---|---|---|---|
| Value | Type | Direction | TD-CRI Configuration |
| 0 | Sensing | Sensing | Optional |
| | configuration | algorithm | Specifies the TD-CRI configuration parameters that the |
| | message | manager to | sensing receiver may use for generating filtered |
| | | sensing | TD-CRI values to send to the sensing algorithm manager. |
| | | receiver | The sensing configuration message may be used when |
| | | | TD-CRI configuration parameters are to be sent to the |
| | | | sensing receiver for use in a future sensing session |
| | | | (i.e., the values are held in memory at the sensing |
| | | | receiver). The sensing configuration message may be |
| | | | sent upon association of the sensing algorithm manager |
| | | | with the sensing receiver. The sensing configuration |
| | | | message may be sent from the sensing algorithm manager |
| | | | which may be present on a separate device (such as |
| | | | the sensing transmitter) on the 802.11 network. |
| | | | If this element is absent, then the sensing receiver |
| | | | may provide CSI values when channel representation |
| | | | information is requested. |
| 1 | Sensing | Sensing | Optional |
| | configuration | receiver to | In response to this element in sensing configuration |
| | response | sensing | message, the sensing receiver receiving the message |
| | message | algorithm | sends an acknowledgement in the TD-CRI configuration |
| | | manager | field and configures sensing agent with the |
| | | | provided values for use in generating filtered |
| | | | TD-CRI (possibly when triggered to do so, or always |
| | | | when sending channel representation information). |
| 2 to 5 | Reserved | N/A | N/A |
| and 7 | | | |
| to 255 | | | |

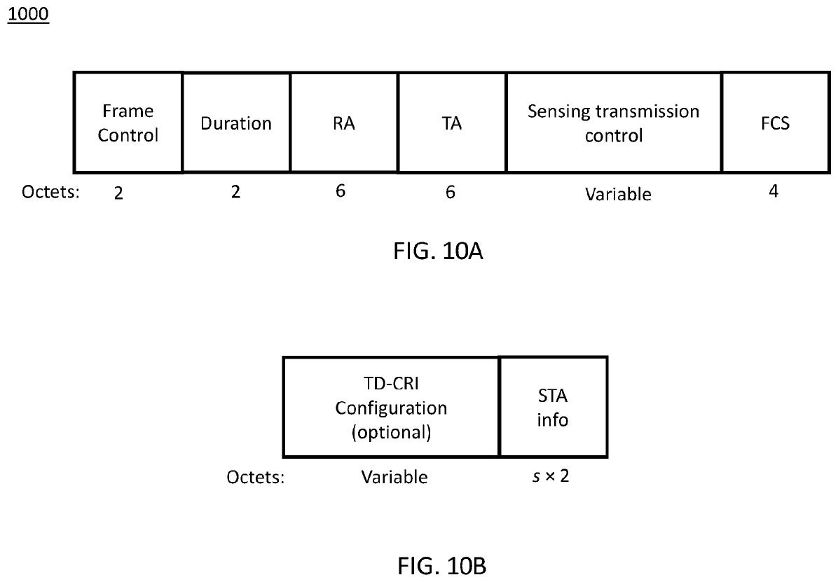

According to some implementations, a sensing transmission announcement message may be carried in a new extension to a control frame of a type described in IEEE 802.11. In some implementations, the sensing transmission announcement message may be carried in a new extension to a control frame extension described in IEEE 802.11. FIG. 10A illustrates an example of a format of control frame 1000 and FIG. 10B illustrates a format of a sensing transmission control field of control frame 1000. In an example, the STA info field of the sensing transmission control field may address up to s sensing receivers via their Association ID. In an example implementation, the sensing transmission announcement message may address s sensing receivers which are required to make a sensing measurement and to relay channel representation information back to the sensing initiator. Examples of sensing transmission control and TD-CRI configuration elements are shown in Table 2, provided below.

TABLE 2
Sensing transmission control and TD-CRI configuration elements

| Message Type | Message Direction | TD-CRI Configuration |
|---|---|---|
| Sensing | Sensing transmitter | Optional |
| transmission | to sensing receiver | This element is included in a sensing transmission |
| announcement | | announcement message (preceding a sensing |
| message | | transmission NDP) to inform the sensing receiver that |
| | | on the transmission of a channel representation |
| | | information made on the sensing transmission NDP, |
| | | the sensing receiver should apply the TD-CRI |
| | | configuration. |
| | | If the TD-CRI configuration was already provided in a |
| | | sensing configuration message, then this TD-CRI |
| | | configuration element may consist of a bit flag which |
| | | indicates whether the sensing receiver should use pre- |
| | | configured TD-CRI configuration information (if only |
| | | one TD-CRI configuration was provided in the sensing |
| | | configuration message). |
| | | If more than one TD-CRI configuration was provided |
| | | in a sensing configuration message, the TD-CRI |
| | | configuration in the sensing trigger message may |
| | | provide an index into the pre-configured TD-CRI |
| | | configurations to indicate to the sensing receiver which |
| | | TD-CRI configuration to apply. In some examples, |
| | | there may be several indices provided, for example, |
| | | one index which selects a time delay filter and one |
| | | index that selects an amplitude mask. |
| | | The sensing receiver may combine the TD-CRI |
| | | configuration information provided with other |
| | | information in the sensing transmission announcement |
| | | to determine which TD-CRI configuration parameters |
| | | to apply. For example, the sensing receiver may |
| | | combine the TD-CRI configuration with the channel |
| | | bandwidth in determining which TD-CRI |
| | | configuration parameters to use. |
| | | In some examples, the TD-CRI configuration provided |
| | | in the sensing transmission announcement is only used |
| | | for the measurement made on the next sensing |
| | | transmission. In other examples, the TD-CRI |
| | | configuration provided in the sensing transmission |
| | | announcement is used until the TD-CRI configuration |
| | | is updated or explicitly canceled. |
| | | If this element is absent, then the sensing receiver |
| | | provides CSI values when channel representation |
| | | information is sent. In another example, if this element |
| | | is absent then the sensing receiver calculates a sensing |
| | | measurement but provides no feedback to the sensing |
| | | transmitter. In this example, a sensing measurement |
| | | poll message may be used to signal to the sensing |
| | | receiver that it should provide the channel |
| | | representation information. |

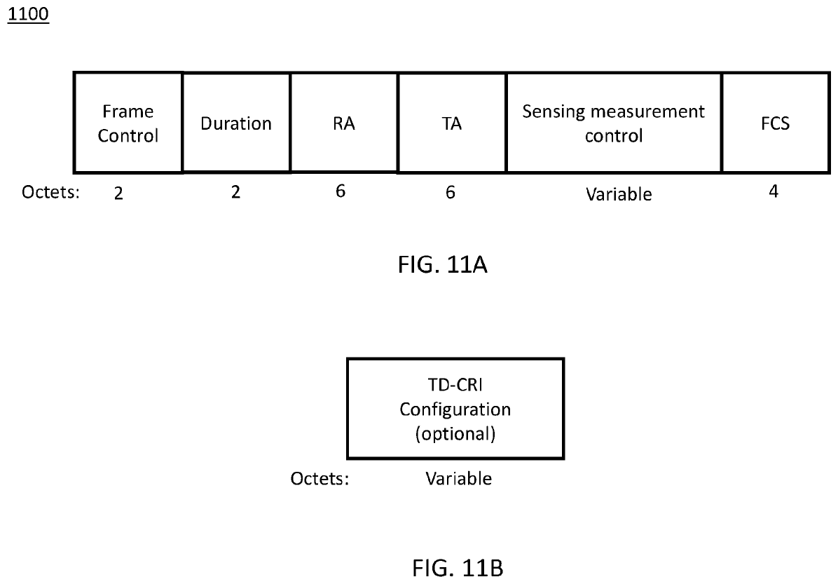

According to some implementations, the sensing measurement poll message may be carried in a new extension to a control frame of a type described in IEEE 802.11. In some implementations, the sensing measurement poll may be carried in a new extension to a control frame extension described in IEEE 802.11. FIG. 11A illustrates an example of a format of control frame 1100 and FIG. 11B illustrates a format of a sensing measurement control field of control frame 1100. Examples of sensing measurement control and TD-CRI configuration elements are shown in Table 3, provided below.

TABLE 3
Sensing measurement control and TD-CRI configuration elements

| Message Type | Message Direction | TD-CRI Configuration |
|---|---|---|
| Sensing | Sensing transmitter | Optional |
| transmission | to sensing receiver | This element is included in a sensing transmission poll |
| poll | | to inform the sensing receiver that on the transmission |
| | | of a channel representation information made on a |
| | | previous sensing measurement, the sensing receiver |
| | | should apply the TD-CRI configuration. |
| | | If the TD-CRI configuration was already provided in a |
| | | sensing configuration message, then this TD-CRI |
| | | configuration element may consist of a bit flag which |
| | | indicates whether the sensing receiver should use pre- |
| | | configured TD-CRI configuration information (if only |
| | | one TD-CRI configuration was provided in the sensing |
| | | configuration message). |
| | | If more than one TD-CRI configuration was provided |
| | | in a sensing configuration message, the TD-CRI |
| | | configuration in the sensing trigger message may |
| | | provide an index into the pre-configured TD-CRI |
| | | configurations to indicate to the sensing receiver which |
| | | TD-CRI configuration to apply. In some examples, |
| | | there may be several indices provided, for example one |
| | | index which selects a time delay filter, one index that |
| | | selects a maximum amplitude mask, and one index that |
| | | selects a minimum amplitude mask. |
| | | The sensing receiver may combine the TD-CRI |
| | | configuration information provided with other |
| | | information in the sensing transmission poll to |
| | | determine which TD-CRI Configuration parameters to |
| | | apply. For example, the sensing receiver may combine |
| | | the TD-CRI configuration with the channel bandwidth |
| | | in determining which TD-CRI Configuration |
| | | parameters to use. |
| | | In some examples, the TD-CRI configuration provided |
| | | in the sensing transmission poll is only used for the |
| | | measurement made on the next sensing transmission. |
| | | In other examples, the TD-CRI configuration provided |
| | | in the sensing transmission poll is used until the TD- |
| | | CRI configuration is updated or explicitly canceled. |
| | | If this element is absent, then the sensing receiver |
| | | provides CSI values when channel representation |
| | | information is sent. |

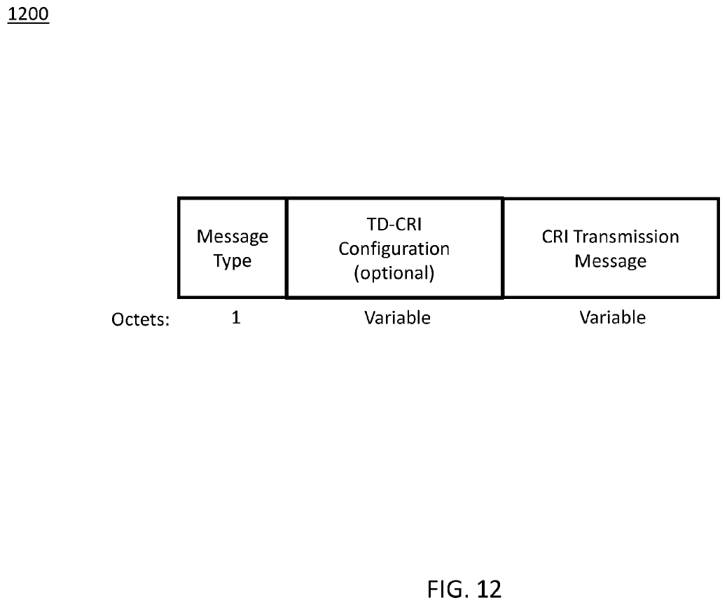

According to some implementations, when sensing receiver 502 has calculated a sensing measurement and created channel representation information (for example, in form of filtered TD-CRI), the sensing receiver 502 may be required to communicate the channel representation information to sensing algorithm manager 506 or sensing transmitter 504-1 including sensing algorithm manager 506. In an example, filtered TD-CRI may be generated in response to a sensing transmission announcement and sensing transmission NDP. In some examples, filtered TD-CRI may be generated in response to a sensing measurement poll. In the examples, the filtered TD-CRI may be transferred by a management frame. In an example, a message type may be defined which represents a CRI Transmission Message. FIG. 12 illustrates an example of a component of a management frame 1200 carrying a CRI transmission message, according to some embodiments. In an example, system 500 may require acknowledgement frames and the management frame carrying the CRI transmission message may be implemented as an Action frame and in another example, system 500 may not require acknowledgement frames and the management frame carrying the CRI transmission message may be implemented as an Action No Ack frame. Examples of CRI transmission message and TD-CRI configuration elements are shown in Table 4. Further, the CRI transmission message element details are shown in Table 5.

TABLE 4
CRI Transmission Message and TD-CRI Configuration Elements

| | Message | Message | TD-CRI | CRI Transmission |
|---|---|---|---|---|
| Value | Type | Direction | Configuration | Message |
| 6 | CRI | Sensing | Optional | CRI Transmission |
| | Transmission | receiver | In the CRI transmission | Message as |
| | Message | to | sent by the sensing | defined in Table 5 |
| | | sensing | receiver, this element | |
| | | algorithm | is present if filtered | |
| | | manager | TD-CRI are being sent | |
| | | | and absent if CSI are | |
| | | | being sent. If this | |
| | | | element is present, | |
| | | | the TD-CRI configuration | |
| | | | that was used to create | |
| | | | the filtered TD-CRI may | |
| | | | be sent along with the | |
| | | | filtered TD-CRI values. | |
| | | | In another example, if | |
| | | | this element is present, | |
| | | | the element may contain | |
| | | | a bit flag to indicate | |
| | | | that the sensing receiver | |
| | | | applied the TD-CRI | |
| | | | configuration that was | |
| | | | in the sensing | |
| | | | transmission announcement | |
| | | | message or sensing | |
| | | | measurement poll message | |
| | | | which triggered the | |
| | | | response. Alternatively, | |
| | | | the element may contain | |
| | | | multiple bit flags, one | |
| | | | for each aspect of the | |
| | | | TD-CRI configuration, | |
| | | | to indicate which of | |
| | | | the aspects of the | |
| | | | TD-CRI configuration | |
| | | | were applied. | |

TABLE 5
CRI Transmission Message Element Details

| Name | Type | Valid Range | Description |
|---|---|---|---|
| IFFT Length | Integer | N_{FFT} | Specifies the length of the |
| | | | IFFT used to calculate the |
| | | | full TD-CRI from the CSI. |
| | | | This value describes the |
| | | | maximum number of active |
| | | | time-domain pulses which |
| | | | may be returned in the |
| | | | filtered TD-CRI and |
| | | | therefore the length of the |
| | | | bit field that represents the |
| | | | active time domain pulses. |
| Active Frequency | Bit field | Length of N_{FFT} with | Specifies the position in the |
| Subcarriers | | 1 representing an | CSI of a subcarrier |
| | | active subcarrier | associated with a sensing |
| | | in the frequency | transmission from the |
| | | domain | sensing transmitter. (A zero |
| | | | in the bit field indicates that |
| | | | the corresponding |
| | | | subcarrier is part of an |
| | | | isolating band.) |
| Active Time | Bit field | Length of N_{FFT} with | Specifies the position in the |
| Domain Pulses | | 1 representing an | full TD-CRI of an active |
| | | active time-domain | time domain pulse. A value |
| | | pulse | of 0 means that a tone is |
| | | | vacant and a value of 1 |
| | | | means that a tone is |
| | | | occupied. There follows in |
| | | | this element exactly one |
| | | | magnitude value and one |
| | | | phase value for each value |
| | | | of 1 in the bit field. |
| CRI Maximum | Unsigned | [0.0, 1.0] | Maximum magnitude value |
| Magnitude 1 | Float | | for the first active time |
| | | | domain pulse. |
| CRI Minimum | Unsigned | [0.0, 1.0] | Minimum magnitude value |
| Magnitude 1 | Float | | for the first active time |
| | | | domain pulse. |
| CRI Phase 1 | Signed | [−π/2, π/2) | Phase value for the first |
| | Float | | active time domain pulse. |
| . | . | . | . |
| . | . | . | . |
| . | . | . | . |
| CRI Maximum Magnitude m | Unsigned | [0.0, 1.0] | Maximum magnitude value |
| | Float | | for the mth active time |
| | | | domain pulse. |
| CRI Minimum Magnitude m | Unsigned | [0.0, 1.0] | Minimum magnitude value |
| | Float | | for the mth active time |
| | | | domain pulse. |
| CRI Phase m | Signed | [−π/2, π/2) | Phase value for the mth |
| | Float | | active time domain pulse. |

Table 5 shows an example of a CRI transmission message element which transfers the TD-CRI using a bit field to represent the active (included/selected) time domain pulses.

In an implementation, when sensing algorithm manager 506 is implemented on a separate device (i.e., is not implemented within sensing transmitter 504-1), a management frame may not be necessary, and the filtered TD CRI may be encapsulated in a standard IEEE 802.11 data frame and transferred to sensing algorithm manager 506. In an example, the data structure described in Table 5 may be used to format the filtered TD CRI data. In an example, a proprietary header or descriptor may be added to the data structure to allow sensing algorithm manager 506 to detect that the data structure is of the form of a CRI transmission message element. In an example, data may be transferred in the format shown in FIG. 12 and sensing algorithm manager 506 may be configured to interpret the Message Type value that represents a CRI Transmission Message.

### C. Systems and Methods for Determining Partial and Filtered TD-CRIs of Time Domain Channel Representation Information

The present disclosure relates to systems and methods for Wi-Fi sensing. In particular, the present disclosure relates to systems and methods for determining partial and filtered TD-CRIs of time domain channel representation information, for example, by using principal impulses and/or a window of time domain pulses.

Referring again to FIG. 5A/FIG. 5B, according to one or more implementations, for the purpose of Wi-Fi sensing, sensing receiver 502 may initiate a measurement campaign (or a Wi-Fi sensing session). In the measurement campaign, exchange of transmissions between sensing receiver 502 and sensing transmitter 504 may occur. In an example, control of these transmissions may be by the MAC layer of the IEEE 802.11 stack.

According to an example implementation, sensing receiver 502 may initiate the measurement campaign via one or more sensing trigger messages. In an implementation, sensing agent 516 may be configured to generate a sensing trigger message configured to trigger a sensing transmission from sensing transmitter 504. In an example, the sensing trigger message may include a requested transmission configuration field. Other examples of information/data included in the sensing trigger message that are not discussed here are contemplated herein.

According to an implementation, sensing agent 516 may transmit the sensing trigger message to sensing transmitter 504. In an implementation, sensing agent 516 may transmit the sensing trigger message to sensing transmitter 504 via transmitting antenna 512 to trigger the sensing transmission from sensing transmitter 504.

In response to receiving the sensing trigger message, sensing transmitter 504 may generate a sensing transmission. In an example, the sensing transmission that the sensing trigger message triggers from sensing transmitter 504 may be a sensing response message. In an implementation, sensing transmitter 504 may generate a sensing transmission using the requested transmission configuration. In an implementation, sensing transmitter 504 may transmit the sensing transmission to sensing receiver 502 in response to the sensing trigger message and in accordance with the requested transmission configuration. In an example, the sensing transmission may include a delivered transmission configuration corresponding to the transmission configuration used to deliver the sensing transmission. In an example, when it may be supported by the sensing transmitter the delivered transmission configuration corresponds to the requested transmission configuration.

In an implementation, sensing receiver 502 may receive the sensing transmission from sensing transmitter 504 transmitted in response to the sensing trigger message. Sensing receiver 502 may be configured to receive the sensing transmission from sensing transmitter 504 via receiving antenna 514. According to an implementation, sensing agent 516 may be configured to generate a sensing measurement representing a channel state information (CSI) in a frequency domain based on the sensing transmission. In an example, generating the sensing measurement based on the sensing transmission may include calculating CSI.

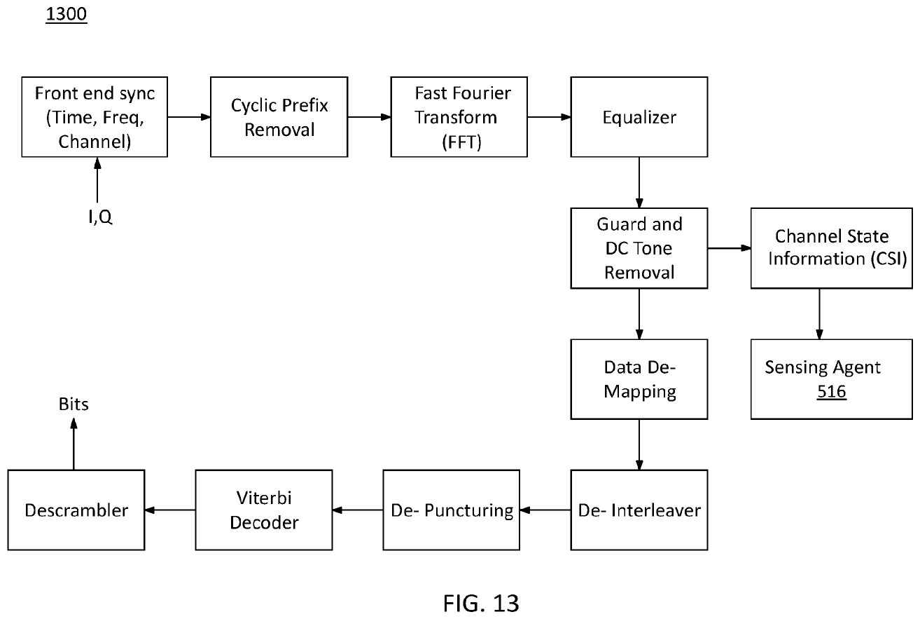

According to an implementation, a baseband receiver of sensing receiver 502 may be configured to calculate the CSI based on the sensing transmission. In some implementations, sensing receiver 502 may calculate a contribution to the CSI by a receiver chain. In an example, the receiver chain of sensing receiver 502 may include analog elements and digital elements. For example, the receiver chain may include the analog and digital components through which a received signal may travel from a reference point to a point at which the received signal may be read, i.e., by sensing agent 516 of sensing receiver 502. A representation 1300 of the receiver chain of sensing receiver 502 is illustrated in FIG. 13. As described in FIG. 13, In-phase (I) and Quadra phase (Q) modulated symbols arrive at a frond end of the receiver where synchronization is performed including frequency and timing recovery. Further, time domain guard period (cyclic prefix) is removed, and the receiver performs a discrete Fourier transform (DFT) on the received signal (for example, the I and Q modulated symbols). Guard tones and DC tones are then removed. CSI is then generated prior to data de-mapping, de-interleaving (using a de-interleaver), de-puncturing, decoding (using a Viterbi decoder) and finally descrambling (using a descrambler). As a result of descrambling, data bits are generated. The generated CSI is provided to sensing agent 516.

In some implementations, an automatic gain control (AGC) may precondition the I and Q samples prior to digitization. The AGC is a dynamic process, and its gain may change over time depending on conditions in the propagation channel. In some examples, a value of gain applied to the signal may be fed from the AGC processing to allow for a compensation operation.

According to an implementation, upon receiving the CSI, sensing agent 516 may generate a full TD-CRI of a propagation channel between sensing receiver 502 and sensing transmitter 504-1. In an implementation, sensing agent 516 may generate the full TD-CRI based on the sensing measurement. In an example implementation, sensing agent 516 may perform an inverse Fourier transform on the CSI to generate the full TD-CRI.

According to an implementation, upon generating the CSI, sensing agent 516 may further generate a full time-domain channel representation information (TD-CRI) of the CSI. In an implementation, sensing agent 516 may generate the full TD-CRI from the CSI by performing an IDFT on the CSI, converting from the frequency domain to the time domain. In an example, for 1024 CSI values, sensing agent 516 may convert the frequency domain CSI into the full TD-CRI by applying a 1024-point IDFT to the 1024 CSI values. In an implementation, to reduce the amount of CRI that needs to be transmitted over the air, the CRI may be represented by a TD-CRI instead of by the CSI. While CSI provides information of the channel's frequency response (i.e., magnitude attenuation and phase rotation on a signal) at each subcarrier, full TD-CRI may provide the channel's impulse response (i.e., magnitude attenuation and phase rotation of each propagation path delay in a multi-path propagation environment).

In the time domain, a propagation channel may be described by a transfer function. In an example, the transfer function may be referred to as h(t). The transfer function may also be described as an impulse response of the propagation channel. The impulse response of the propagation channel may include a plurality of time domain pulses. The plurality of time domain pulses may represent reflections that transmitted signals (for example, those transmitted by a transmitter) underwent before reaching a receiver. A reflected time domain pulse may be represented as:

$$h ( {t}_{k} ) = {α}_{k} δ ( t - {t}_{k} ) \qquad ( 8 )$$

where, tₖ represents a time taken by the reflected time domain pulse to reach the receiver by following a discrete reflective path and αₖ represents an attenuation experienced by the reflected time domain pulse between the transmitter and the receiver.

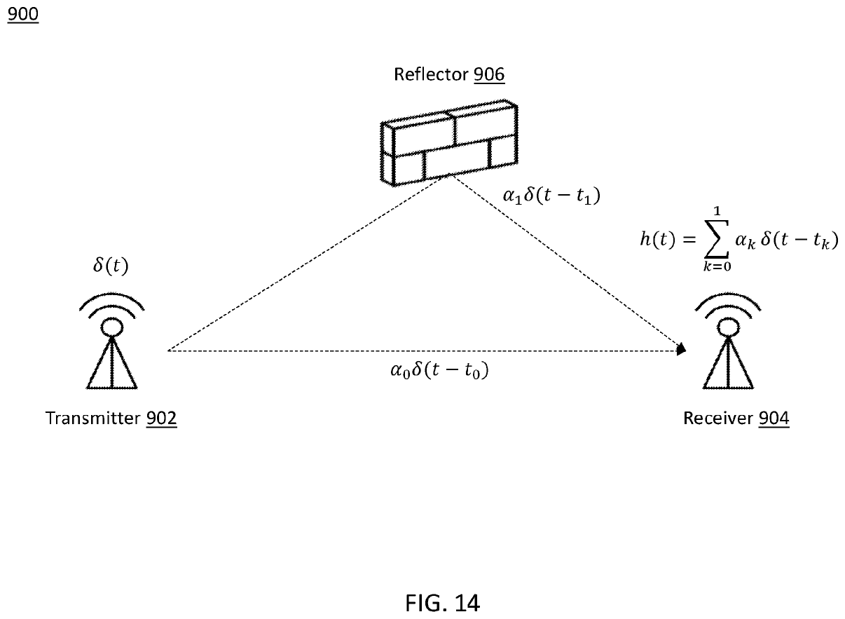

FIG. 14 depicts example representation 1400 of an over-the-air channel, which includes a direct signal path and a single multipath, according to some embodiments. In an implementation, FIG. 14 depicts discrete multipaths of a time domain pulse, δ(t), between transmitter 1402 and receiver 1404 according to some embodiments. In FIG. 14, a direct path signal is represented as:

$$h ( {t}_{0} ) = {α}_{0} δ ( t - {t}_{0} ) \qquad ( 9 )$$

and a first reflected time domain pulse is represented as:

$$h ( {t}_{1} ) = {α}_{1} δ ( t - {t}_{1} ) \qquad ( 10 )$$

In an implementation, if a number of discrete multipaths is given by Lₚ, then the impulse response of the propagation channel may be represented as:

$$h ( t ) = {\sum }_{k = 0}^{{L}_{p}} {α}_{k} δ ( t - {t}_{k} ) \qquad ( 11 )$$

A time domain representation may be converted to a frequency domain representation using a Fourier transform. In an example, the frequency domain representation of the impulse response of the propagation channel may be given by equation (12):

$$H ( f ) = {\sum }_{k = 0}^{{L}_{p}} {α}_{k} {e}^{- j 2 π {ft}_{k}} \qquad ( 12 )$$

Each value of H(f) in equation (12) may be a linear combination of all values of h(t) in equation (11). In an implementation, the equation (12) may be represented using matrix vector multiplication according to equation (13), provided below.

$${A}_{F , N} = [ \begin{matrix}{e}^{- j 2 π {f}_{0} {t}_{0}} & {e}^{- j 2 π {f}_{0} {t}_{1}} & … & {e}^{- j 2 π {f}_{0} {t}_{{L}_{p}}} \\ {e}^{- j 2 π {f}_{1} {t}_{0}} & {e}^{- j 2 π {f}_{1} {t}_{1}} & … & {e}^{- j 2 π {f}_{1} {t}_{{L}_{p}}} \\ ⋮ & & & ⋮ \\ {e}^{- j 2 π {f}_{N - 1} {t}_{0}} & … & … & {e}^{- j 2 π {f}_{N - 1} {t}_{{L}_{p}}}\end{matrix} ] \qquad ( 13 )$$

where, A_{F,N} is a Fourier basis matrix of dimension N×(Lₚ+1) and N is the number of frequencies over which the Fourier transform is calculated.

The CSI (H(f)) representation of equation (12) may be expressed in a Fourier matrix according to equation (13). Further, Fourier matrix equation for determining H(f) is shown in equation (14) and equation (15), provided below.

$$[ \begin{matrix}{e}^{- j 2 π {f}_{0} {t}_{0}} & {e}^{- j 2 π {f}_{0} {t}_{1}} & … & {e}^{- j 2 π {f}_{0} {t}_{{L}_{p}}} \\ {e}^{- j 2 π {f}_{1} {t}_{0}} & {e}^{- j 2 π {f}_{1} {t}_{1}} & … & {e}^{- j 2 π {f}_{1} {t}_{{L}_{p}}} \\ ⋮ & & & ⋮ \\ {e}^{- j 2 π {f}_{N - 1} {t}_{0}} & … & … & {e}^{- j 2 π {f}_{N - 1} {t}_{{L}_{p}}}\end{matrix} ] \times [ \begin{matrix}{α}_{0} \\ {α}_{1} \\ ⋮ \\ {α}_{{L}_{p}}\end{matrix} ] = [ \begin{matrix}H ( {f}_{0} ) \\ H ( {f}_{1} ) \\ ⋮ \\ H ( {f}_{N - 1} )\end{matrix} ] \qquad ( 14 )$$

$${A}_{F , N} \times α = H ( f ) \qquad ( 15 )$$

In an example, each column of A_{F,N} corresponds to a time domain pulse of h(t). Accordingly, the columns of A_{F,N} are set of all possible tₖ from equation (9). The columns of A_{F,N} together with the column vector, α, are the TD-CRI corresponding to the CSI. In an implementation, the CSI (H(f)) may be represented as time domain pulses.

According to an implementation, sensing agent 516 may generate the full TD-CRI of the CSI by performing IDFT on the CSI (H(f)). When TD-CRI is generated by taking the IDFT of the CSI H(f), there is a one-to-one correspondence between a frequency domain tone (a complex value of the CSI) and a time domain tone (a complex value of the TD-CRI), and it is referred to as full TD-CRI. The full TD-CRI and CSI form a pair of DFTs. Accordingly, the CSI and the TD-CRI are represented in a Fourier matrix. In an example, by considering full TD-CRI as a time-domain sequence h and CSI as a frequency-domain sequence H, the full TD-CRI can be derived as the IDFT of a known CSI using equation (16), provided below.

$$H = {B}_{N} h \qquad ( 16 )$$

where B_{N}={b_{n,k}} is the N×N IDFT matrix, whose element at n^{th} row and k^{th} column is:

$${b}_{n , k} = \frac{1}{\sqrt{N}} {e}^{j 2 π kn / N} \qquad ( 17 )$$

The n^{th} row of B_{N} corresponds to hₙ of h, the k^{th} column row of B_{N} corresponds to Hₖ of H, and b_{n,k} represents the contribution of Hₖ on hₙ.

In some embodiments, the CSI may be reconstructed as the DFT of a known full TD-CRI using equation (18), provided below.

$$H = {A}_{N} h , \qquad ( 18 )$$

$$where ,$$

$$h = {[ {h}_{0} , {h}_{1} , {h}_{2} , ... {h}_{N - 1} ]}^{T} \qquad ( 19 )$$

$$H = {[ {H}_{0} , {H}_{1} , {H}_{2} , ... {H}_{N - 1} ]}^{T} \qquad ( 20 )$$

In an example, hᵢ and Hᵢ represent complex numbers, T represents matrix transpose, N represents a number of DFT points (i.e., DFT size), and A_{N}={αₖ,n} is the N×N DFT matrix, whose element at k^{th} row and n^{th} column is:

$${a}_{k , n} = \frac{1}{\sqrt{N}} {e}^{- j 2 π kn / N} \qquad ( 21 )$$

where, k and n are the frequency and time indices, respectively. In DFT, k=0, 1, . . . , N−1 and n=0, 1, . . . , N−1. Further, k^{th} row of A_{N} corresponds to Hₖ of H in equation (20), the n^{th} column of A_{N} corresponds to hₙ of h in equation (19), and αₖ,n represents the contribution of hₙ on Hₖ.

In equation (16) and equation (18), the subscript of A_{N} and B_{N} indicates that the size of the matrices is N×N. In an example, equation (16) may be used to obtain h when H is known, while equation (18) may be used to obtain H when h is known. Alternatively, the equation (16) and the equation (18) may be expressed as equations (22) and (23), respectively, provided below.

$${H}^{T} = {h}^{T} {A}_{N}^{T} \qquad ( 22 )$$

$${h}^{T} = {H}^{T} {B}_{N}^{T} \qquad ( 23 )$$

where the superscript T stands for the matrix transpose.

In an implementation, sensing agent 516 may create a column vector α′ of dimension 1×N comprising amplitudes of each of the TD-CRI values, where N is the number of points in the IDFT. In an example, if N=1024, then the column vector α′ has dimensions of 1×1024. In an example implementation, the column vector α′ is represented using equation (24):

$${α}^{′} = [ \begin{matrix}{α}_{0} \\ {α}_{1} \\ ⋮ \\ {α}_{N - 1}\end{matrix} ] \qquad ( 24 )$$

According to an implementation, sensing agent 516 may remove any an from the column vector α′ whose value is equal to zero or below a predefined threshold. In an example, sensing agent 516 may use other criteria to remove any an from the column vector α′ and to simplify subsequent processing. Sensing agent 516 may retain the information of the position in the column vector α′ for which an was removed. In an example implementation, sensing agent 516 may create a bit field that is N=1024 bits long. Sensing agent 516 may place a zero (0) at each of the locations (starting from the 0th and increasing in order to the N−1th) from where an was removed. Further, sensing agent 516 may place a one (1) at all other locations. The bit field created by sensing agent 516 may be referred to as time domain (TD) bit map. In an example, the number of ones (referred to as the bit weight of the bit map) in the TD bit map is k. The retained, k values may be renumbered from 0 to k−1 and placed consecutively into a new column vector a. In an example implementation, the new column vector a may be represented using equation (25):

$$α = [ \begin{matrix}{α}_{0} \\ {α}_{1} \\ ⋮ \\ {α}_{k - 1}\end{matrix} ] \qquad ( 25 )$$

In an example, a TD bit map may represent active subcarriers in the frequency domain response and guard subcarriers and DC (direct current) subcarriers are not represented. The term active tone TD bit map may describe a TD bit map that represents active subcarriers in the frequency domain response. In another example, the TD bit map may represent all subcarriers in the frequency domain response and guard subcarriers and DC subcarriers are represented by a zero in the TD bit map. The term full tone TD bit map may describe a TD bit map that represents all subcarriers in the frequency domain response.

According to an implementation, sensing agent 516 may create an N×N matrix A_{F,N} represented using equation (26).

$${A}_{F , N} [ \begin{matrix}{e}^{- j 2 π {f}_{0} {t}_{0}} & {e}^{- j 2 π {f}_{0} {t}_{1}} & … & {e}^{- j 2 π {f}_{0} {t}_{N - 1}} \\ {e}^{- j 2 π {f}_{1} {t}_{0}} & {e}^{- j 2 π {f}_{1} {t}_{1}} & … & {e}^{- j 2 π {f}_{1} {t}_{N - 1}} \\ ⋮ & & & ⋮ \\ {e}^{- j 2 π {f}_{N - 1} {t}_{0}} & … & … & {e}^{- j 2 π {f}_{N - 1} {t}_{N - 1}}\end{matrix} ] \qquad ( 26 )$$

where, each TD-CRI is arranged in a column of A_{F,N}. For example, column

$$[ \begin{matrix}{e}^{- j 2 π {f}_{0} {t}_{0}} \\ {e}^{- j 2 π {f}_{1} {t}_{0}} \\ ⋮ \\ {e}^{- j 2 π {f}_{N - 1} {t}_{0}}\end{matrix} ]$$

represents the value of TD-CRI 0, column

$$[ \begin{matrix}{e}^{- j 2 π {f}_{0} {t}_{1}} \\ {e}^{- j 2 π {f}_{1} {t}_{1}} \\ ⋮ \\ … \\ {e}^{- j 2 π {f}_{N - 1} {t}_{1}}\end{matrix} ]$$

represents the value of TD-CRI 1, and column

$$[ \begin{matrix}{e}^{- j 2 π {f}_{0} {t}_{N - 1}} \\ {e}^{- j 2 π {f}_{1} {t}_{N - 1}} \\ ⋮ \\ {e}^{- j 2 π {f}_{N - 1} {t}_{N - 1}}\end{matrix} ]$$

represents the value of TD-CRI N−1.

In an implementation, sensing agent 516 may use the TD bit map to remove columns of A_{F,N} which correspond to zeros in the TD bit map. For a bit weight of k, the matrix is now A_{F,k} (given by equation (27)).

$${A}_{F , k} [ \begin{matrix}{e}^{- j 2 π {f}_{0} {t}_{0}} & {e}^{- j 2 π {f}_{0} {t}_{1}} & … & {e}^{- j 2 π {f}_{0} {t}_{k - 1}} \\ {e}^{- j 2 π {f}_{1} {t}_{0}} & {e}^{- j 2 π {f}_{1} {t}_{1}} & … & {e}^{- j 2 π {f}_{1} {t}_{k - 1}} \\ ⋮ & & & ⋮ \\ {e}^{- j 2 π {f}_{N - 1} {t}_{0}} & … & & {e}^{- j 2 π {f}_{N - 1} {t}_{k - 1}}\end{matrix} ] \qquad ( 27 )$$

In an example, the full TD-CRI includes the same channel representation information as the CSI, however the information may be concentrated in only a few of the time domain pulses. In an example, CRI may be represented with less data by only sending the time domain pulses that are needed. In an implementation, optimum time domain pulses required to represent the CSI at a defined level of accuracy may be determined. The optimum time domain pulses required to represent the CSI at a defined level of accuracy may be referred to as principal impulses. According to an implementation, the level of accuracy may be defined by setting out a maximum error that is allowable between the CSI and the R-CSI. The manner in which the maximum error (i.e., an error signal) is calculated is described herein.

According to an implementation, upon receiving the CSI, sensing agent 516 may send the CSI to sensing algorithm manager 506 for further processing. In an implementation, in response to receiving the CSI, sensing algorithm manager 506 may be configured to perform an IDFT on the CSI, resulting in a time domain representation of the CSI. According to an implementation, sensing algorithm manager 506 may select a number of time domain pulses from the time domain representation of the CSI.

In an implementation, sensing algorithm manager 506 may perform an DFT on the selected time domain pulses. As a result, frequency domain representation of the selected time domain pulses may be generated. The frequency domain representation of the selected time domain pulses may be referred to as reconstructed CSI (R-CSI). In an example, sensing algorithm manager 506 may process the selected time domain pulses values with the same configuration of DFT used for generation of the CSI. According to an implementation, sensing algorithm manager 506 may calculate an error signal between the CSI and the R-CSI. In an example, sensing algorithm manager 506 may compare the R-CSI with the actual CSI to calculate the error signal.

According to an implementation, sensing agent 516 may be configured to identify principal impulses of the full TD-CRI. In an example, the principal impulses may represent a subset of time domain pulses of the full TD-CRI. The subset of time domain pulses may include the optimum time domain pulses required to represent the CSI accurately. In an implementation, sensing agent 516 may identify a filtered TD-CRI according to the principal impulses. The filtered TD-CRI may be an example of channel representation information.

In an implementation, sensing agent 516 may identify the principal impulses of the full TD-CRI based on constraint processing. An example of the constrained processing is described hereinafter.

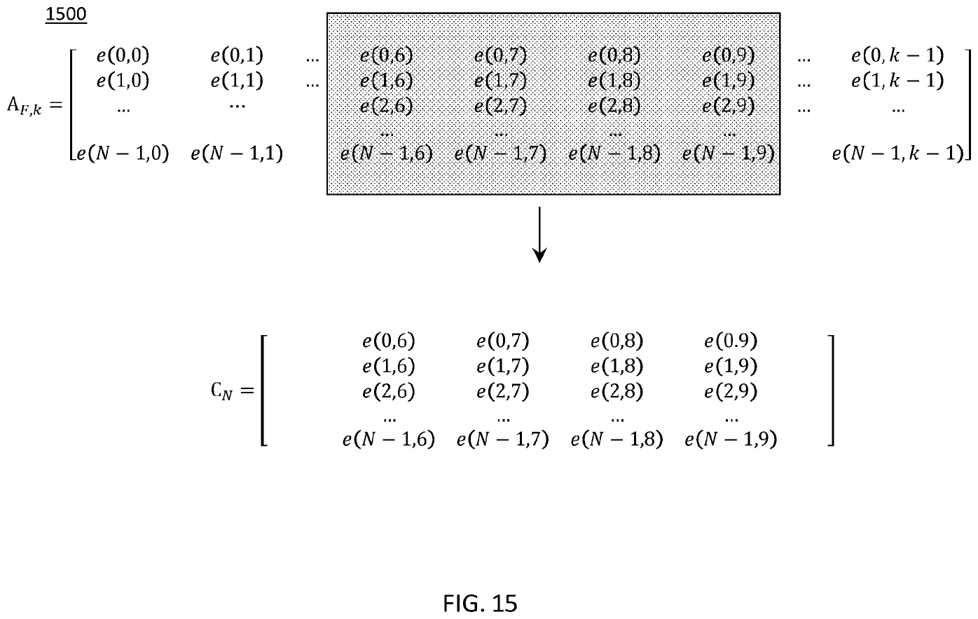

In an implementation, sensing agent 516 may identify a subset of time domain complex pairs of the full TD-CRI. Sensing agent 516 may then use the subset of time domain complex pairs as an initial filtered TD-CRI representation of the propagation channel. According to an implementation, sensing agent 516 may filter the full TD-CRI using Fourier matrix representations. An expansion of the Fourier basis matrix A_{F,k} is shown in equation (28) below. This is also illustrated in FIG. 15.

$$( 28 )$$

$${A}_{F , k} = [ \begin{matrix}e ( 0 , 0 ) & e ( 0 , 1 ) & … & e ( 0 , 6 ) & e ( 0 , 7 ) & e ( 0 , 8 ) & e ( 0.9 ) & … & e ( 0 , k - 2 ) \\ e ( 1 , 0 ) & e ( 1 , 1 ) & … & e ( 1 , 6 ) & e ( 1 , 7 ) & e ( 1 , 8 ) & e ( 1 , 9 ) & … & e ( 1 , k - 2 ) \\ … & … & & e ( 2 , 6 ) & e ( 2 , 7 ) & e ( 2 , 8 ) & e ( 2 , 9 ) & … & … \\ & & & … & … & … & … & & \\ e ( N - 1 , 0 ) & e ( N - 1 , 1 ) & & e ( N - 1 , 6 ) & e ( N - 1 , 7 ) & e ( N - 1 , 8 ) & e ( N - 1 , 9 ) & & e ( N - 1 , k - 1 )\end{matrix} ]$$

For simplicity of notation, in equation (28), e^{-jπf}^{₀}^{t}^{₀} is written as e(0,0), e^{-jπf}^{₁}^{t}^{₀} is written as e(1,0), and so on.

In an implementation, sensing agent 516 may constrain the Fourier basis matrix A_{F,k} by eliminating the columns that do not contribute to the channel representation by some measure keeping the columns that do contribute to the channel representation by some measure (i.e., principal impulses). In an example, it may be assumed that the set of contributing αᵢ occurs for i={6, 7, 8, 9} and is referred to as c_{N} as shown in equation (29) below.

$$c = [ \begin{matrix}{α}_{6} \\ {α}_{7} \\ {α}_{8} \\ {α}_{9}\end{matrix} ] \qquad ( 29 )$$

The constrained version of A_{F,k} (also referred to as constrained basis matrix C_{N}) is created by only keeping the set of column numbers that correspond to the contributing αᵢ, that is columns {6, 7, 8, 9}. The constrained basis matrix Cy is illustrated in FIG. 15.

In an implementation, sensing agent 516 may update the TD bit map with zeros (0s) for additional time domain pulses that are removed. The new bit weight of the TD bit map is calculated to be m. Sensing agent 516 may update the column vector resulting in a new (smaller) column vector c_{N} of length m. In an example implementation, the column vector c_{N} is represented using equation (30), provided below.

$${c}_{N} = [ \begin{matrix}{α}_{0} \\ {α}_{1} \\ … \\ {α}_{m ‐ 1}\end{matrix} ] \qquad ( 30 )$$

In an implementation, using the updated TD bit map, sensing agent 516 may remove the columns of the matrix A_{F,k} which correspond to the new zeros in the TD bit map. For a bit weight (number of 1's in the TD bit map) of m, the matrix A_{F,k} is now referred to as C_{F,m}. The m columns represent the principal impulses. The matrix C_{F,m} may be represented using equation (31), provided below.

$${C}_{F , m} = [ \begin{matrix}{e}^{- j 2 π {f}_{0} {t}_{0}} & {e}^{- j 2 π {f}_{0} {t}_{1}} & … & {e}^{- j 2 π {f}_{0} {t}_{m - 1}} \\ {e}^{- j 2 π {f}_{1} {t}_{0}} & {e}^{- j 2 π {f}_{1} {t}_{1}} & … & {e}^{- j 2 π {f}_{1} {t}_{m - 1}} \\ ⋮ & & & ⋮ \\ {e}^{- j 2 π {f}_{N - 1} {t}_{0}} & … & & {e}^{- j 2 π {f}_{N - 1} {t}_{m - 1}}\end{matrix} ] \qquad ( 31 )$$

In an implementation, sensing agent 516 may calculate the reconstructed CSI (R-CSI) H_{R}(f) using the constrained basis matrix C_{N}. In an example implementation, sensing agent 516 may calculate the reconstructed CSI (R-CSI) H_{R}(f) using equation (32), provided below.

$$[ \begin{matrix}e ( 0 , 6 ) & e ( 0 , 7 ) & e ( 0 , 8 ) & e ( 0.9 ) \\ e ( 1 , 6 ) & e ( 1 , 7 ) & e ( 1 , 8 ) & e ( 1 , 9 ) \\ e ( 2 , 6 ) & e ( 2 , 7 ) & e ( 2 , 8 ) & e ( 2 , 9 ) \\ … & … & … & … \\ e ( N - 1 , 6 ) & e ( N - 1 , 7 ) & e ( N - 1 , 8 ) & e ( N - 1 , 9 )\end{matrix} ] \times [ \begin{matrix}{α}_{6} \\ {α}_{7} \\ {α}_{8} \\ {α}_{9}\end{matrix} ] = \qquad ( 32 )$$

$$[ \begin{matrix}{H}_{R} ( {f}_{0} ) \\ {H}_{R} ( {f}_{1} ) \\ … \\ {H}_{R} ( {f}_{N - 1} )\end{matrix} ]$$

The constrained basis matrix equation for determining H_{R}(f) is shown in equation (33), provided below.

$${C}_{N} \times c = {H}_{R} ( f ) \qquad ( 33 )$$

The channel information is typically concentrated in only a few time domain pulses. Accordingly, α is sparse, i.e., α only has a limited number of non-zero values. In an example, the fewer values of α that are kept, the less information that needs to be transferred over the air. However, if too few values of a are kept, then the R-CSI H_{R}(f) may not be close enough to the original CSI H(f) to be useful. Thus, there is a trade-off between the fidelity of the R-CSI and the amount of information to be transferred over the air.

According to an implementation, sensing agent 516 may identify the principal impulses based on optimizing for a weighted combination of accuracy and size of the filtered TD-CRI. In an implementation, sensing agent 516 may identify the principal impulses based on minimizing an objective function representing a weighted linear combination of an error factor and a size factor. The error factor represents an error between CSI determined from the sensing measurement and R-CSI determined from the filtered TD-CRI and the size factor represents a number of principal impulses carried by the filtered TD-CRI.

In an example, the objective function represents the trade-off between the fidelity of the R-CSI and the amount of information to be transferred over the air. In an example implementation, the objective function is given by equation (34), provided below.

$$J ( h ) = {‖ {H}_{R} ( f ) - H ( f ) ‖}_{2} + λ {‖ c ‖}_{1} \qquad ( 34 )$$

where, λ represents a parameter that is adjustable and is used to modify relative emphasis on each of the terms in the objective function J(h). ∥⋅∥₁ represents a 1-norm operation and ∥⋅∥₂ represents a 2-norm operation.

In an implementation, as a part of an optimization process, sensing agent 516 may minimize the objective function J(h). In an example, by minimizing the objective function J(h), the error between the CSI and the R-CSI is reduced while maintaining the overall magnitude and number of the coefficients in c small. According to an implementation, the selection of the time domain pulses is varied iteratively until the objective function is minimized, thus resulting in the principal impulses of the full TD-CRI.

The 1-norm of a 1×n matrix (i.e., a column vector of length n) is represented by the expression:

$${‖ x ‖}_{1} = {\sum }_{i = 1}^{n} \vert {x}_{i} \vert \qquad ( 35 )$$

The 2-norm of a 1×n matrix (i.e., a column vector of length n) is represented by the expression:

$${‖ x ‖}_{2} = \sqrt{( {\sum }_{i = 1}^{n} {\vert {x}_{i} \vert}^{2} )} \qquad ( 36 )$$

In an example implementation, to minimize the objective function J(h), sensing agent 516 may perform an iterative calculation. Initially, a vector c may be chosen using one of the permutations of choices of αₖ. Subsequently, H_{R}(f) is calculated using the vector c and the objective function J(h) is determined. In an implementation, different permutations may be performed until a minimum value of the objective function J(h) is determined or the objective function J(h) is minimized. In an example, the selection of the time domain pulses to keep in the filtered TD-CRI is varied until the objective function J(h) is minimized, resulting in the optimized set of filtered TD-CRI, i.e., the principal impulses.

According to an implementation, to minimize the objective function J(h), sensing agent 516 may be configured to select a first set of principal impulse candidates (coefficients of vector c) according to a time domain mask including a time delay filter and an amplitude mask. The time delay filter may refer to a maximum time delay boundary. In an example, the amplitude mask includes one of a minimum amplitude mask and a maximum amplitude mask.

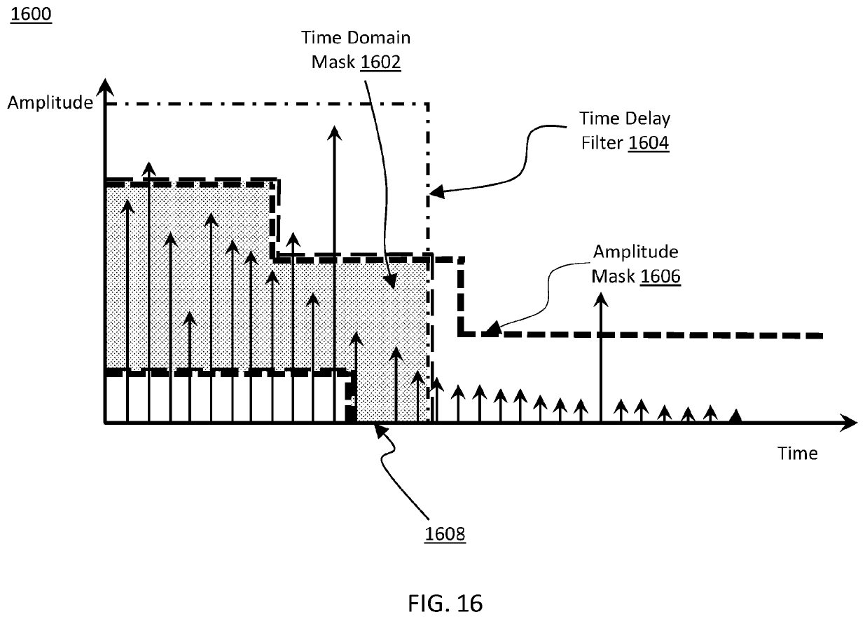

In an example implementation, the first set of principal impulse candidates may be selected by implementing the time domain mask where αₖ of the time domain pulses outside of the time domain mask are nulled or zeroed, and the αₖ of the time domain pulses within the time domain mask make up the vector c. FIG. 16 depicts illustration 1600 of time domain mask 1602, according to some embodiments. As described in FIG. 16, time domain mask 1602 is an aggregation of time delay filter 1604 and amplitude mask 1406. As depicted in FIG. 16, there are twelve time domain pulses within time domain mask 1602 (i.e., twelve time domain pulses meet the time domain mask criteria), including a time domain pulse with zero amplitude 1608. According to an implementation, sensing agent 516 may select the twelve time domain pulses within time domain mask 1602. Further, the remaining time domain pulses are nulled.

In an implementation, sensing agent 516 may vary the first set of principal impulse candidates to generate a second set of principal impulse candidates. In an example, time domain pulses may be selected or nulled in the second set of principal impulse candidates in response to a modification to time domain mask 1602. In an example implementation, the number of iterations performed in the optimization process may be capped to a maximum number. In an implementation, sensing agent 516 may compare the objective function value using the first set of principal impulse candidates and the second set of principal impulse candidates. In some examples, the optimization process may be performed once or periodically for sensing transmitter/sensing receiver pair to determine the principal impulses.

In an example implementation, the result of the optimization process may configure sensing receiver 502 to select a specific number of time domain pulses with the greatest amplitude, regardless of the time delay of those time domain pulses. In some example implementations, the result of the optimization process may configure sensing receiver 502 to locate a time domain pulse with greatest amplitude and to select x time domain pulses that are closest in time to the time domain pulse of greatest amplitude. Other examples of configurations that are not discussed here are contemplated herein.

In an implementation, sensing algorithm manager 506 may communicate time domain mask 1602 (i.e., characteristics of the time delay filter and the amplitude mask) to sensing receiver 502 as a part of an association process between sensing algorithm manager 506 and sensing receiver 502. In some implementations, time domain mask 1602 may be preconfigured into sensing receiver 502 or sent to sensing receiver 502 as a part of a configuration process. In an implementation, upon initial association of sensing receiver 502 with sensing algorithm manager 506, sensing algorithm manager 506 may communicate the time domain mask to sensing receiver 502 via a sensing configuration message. In an implementation, in response to receiving the sensing configuration message including the time domain mask, sensing receiver 502 may send an acknowledgment via a sensing configuration response message. In some implementations, time domain mask 1602 may be communicated to sensing receiver 502 as a part of a sensing transmission announcement message.

According to an implementation, after the principal impulses of the full TD-CRI are identified and the filtered TD-CRI is identified according to the principal impulses, sensing agent 516 may store the filtered TD-CRI in channel representation information storage 518 for future use. In an implementation, sensing agent 516 may send the filtered TD-CRI to sensing algorithm manager 506. Sensing agent 516 may also send location information indicating locations of the principal impulses in the full TD-CRI to sensing algorithm manager 506. In an example, the location information may be included in the filtered TD-CRI. In an implementation, sensing agent 516 may communicate the filtered TD-CRI and corresponding location information to sensing algorithm manager 506 via a CRI transmission message. In an example implementation, sensing agent 516 may communicate the CRI transmission message including the filtered TD-CRI and corresponding location information to sensing algorithm manager 506. In an implementation, sensing agent 516 may encode the filtered TD-CRI and corresponding location information for transmission to sensing algorithm manager 506 over the air via transmitting antenna 512.

In an example, the location information may represent positions of the principal impulses in the Fourier basis matrix. In an implementation, sensing algorithm manager 506 may be required to create a reconstructed TD-CRI from the filtered TD-CRI and the location information of the principal impulses prior to performing an DFT to create a R-CSI. In an implementation, for sensing algorithm manager 506 to correctly create the reconstructed TD-CRI, the sensing algorithm manager 506 may identify where to place each of the filtered TD-CRI complex values that it receives from sensing receiver 502 in the reconstructed TD-CRI prior to performing the DFT.

When the filtered TD-CRI is generated, the selection of the time domain pulses that are kept (i.e., the principal impulses) is captured in the indices of the values of a that are captured in c. Therefore, for sensing algorithm manager 506 to determine how to create the reconstructed TD-CRI from the values that sensing algorithm manager 506 receives over the air from sensing receiver 502, sensing algorithm manager 506 is required to identify in which columns of the Fourier basis matrix the received filtered TD-CRI should be located. (Or equivalently, which values of a were kept in c, where c is a 1× k column vector).

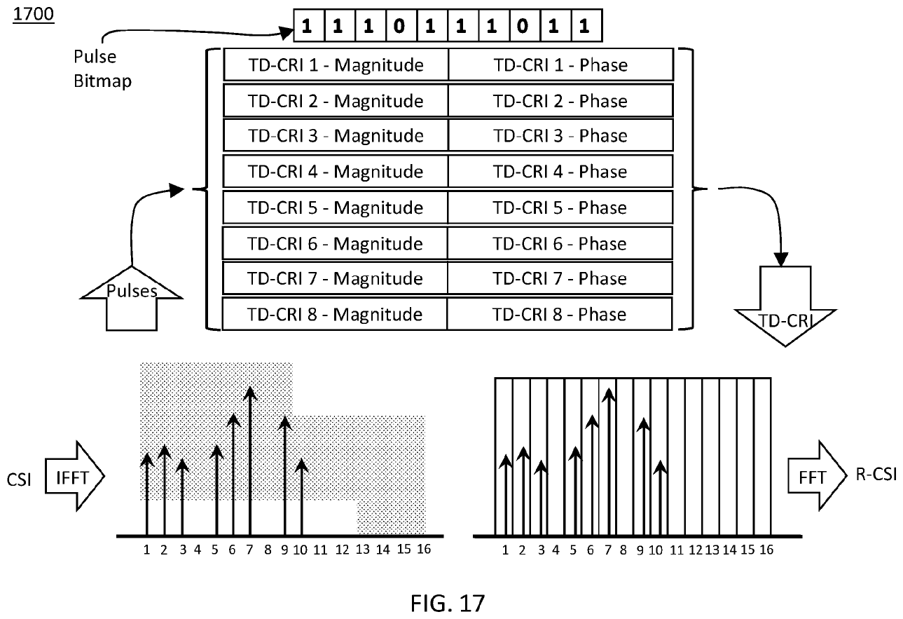

FIG. 17 illustrates representation 1700 of communication of locations of the principal impulses in the full TD-CRI from sensing receiver 502 to sensing algorithm manager 506 using the active tone bit map, according to some embodiments. In an example, information of locations of the principal impulses is included in the filtered TD-CRI. In an example of FIG. 17, the active tone bit map sent from sensing receiver 502 to sensing algorithm manager 506 is 10 bits long, corresponding to 10 pilot and data tones of a 16-point DFT. The value of the active tone bit map, “1110111011” indicates that 8 filtered TD-CRI values will follow (as there are 8 “1”'s in the active tone bitmap) and sensing algorithm manager 506 should arrange the received filtered TD-CRI by applying, in order, each filtered TD-CRI to a reconstructed TD-CRI tone according to the active tone bit map, i.e., TD-CRI 1 in tone 1, TD-CRI 2 in tone 2, TD-CRI 3 in tone 3, null in tone 4, TD-CRI 4 in tone 5, TD-CRI 5 in tone 6, TD-CRI 6 in tone 7, null in tone 8, TD-CRI 7 in tone 9, and TD-CRI 8 in tone 10. In an embodiment, sensing agent 516 of sensing receiver 502 and sensing agent 536 of sensing algorithm manager 506 communicate the locations of the principal impulses in the full TD-CRI.

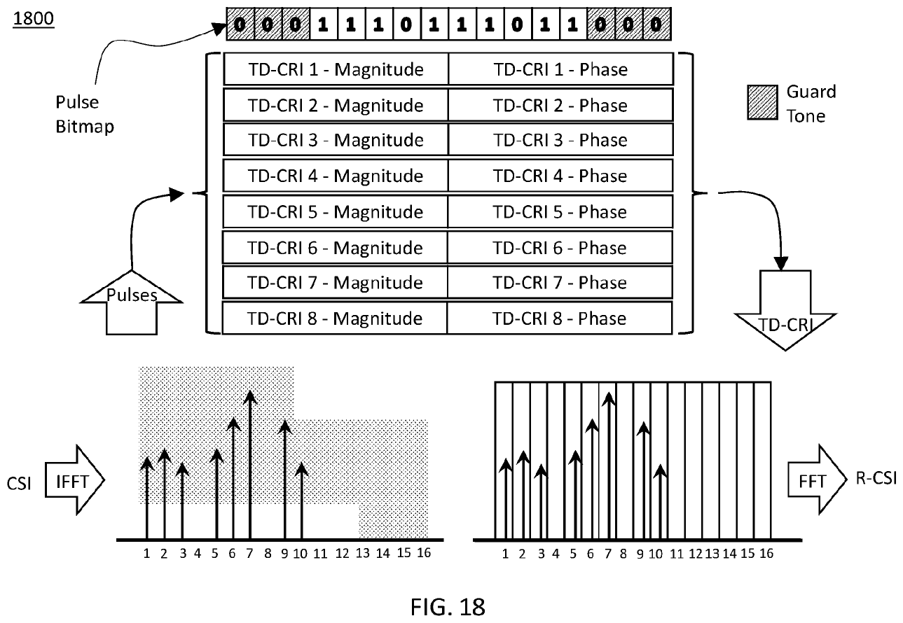

FIG. 18 illustrates representation 1800 of communication of locations of the principal impulses in the full TD-CRI from sensing receiver 502 to sensing algorithm manager 506 using a full bit map, according to some embodiments. In an example, information of locations of the principal impulses is included in the filtered TD-CRI. According to an example, the full bit map may be equal to the total number of tones in the full TD-CRI including the guard tones and DC tones, e.g., 64 bits for an example of a 20 MHz propagation channel bandwidth and 128 bits for an example of 40 MHz propagation channel bandwidth. In the example, some most significant bits (MSB) are “0” to account for the guard tones and some least significant bits (LSB) are “0” to account for the DC tone and the guard tones. In the 16-point DFT example shown in FIG. 18, zeros are placed in the first three locations of the full bit map followed by the location of the eight TD-CRI, followed by three more zeros. In an embodiment, sensing agent 516 of sensing receiver 502 and sensing agent 536 of sensing algorithm manager 506 communicate the locations of the principal impulses in the full TD-CRI.

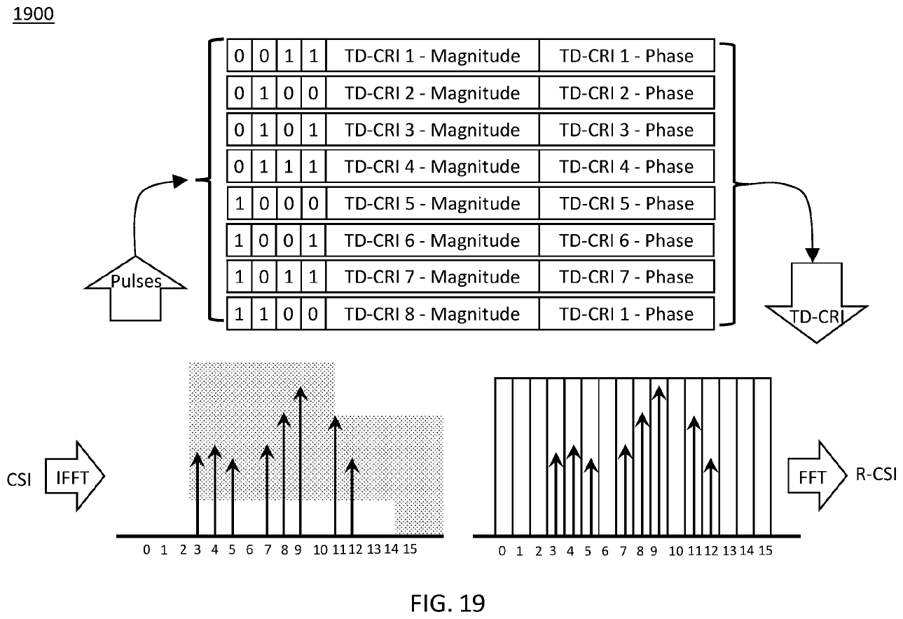

According to some implementations, for each filtered TD-CRI, communicated from sensing receiver 502 to sensing algorithm manager 506, sensing receiver 502 may send three values instead of two values (first value being amplitude of the complex number and second value being phase of the complex number). In an example, the third value may represent the locations of the principal impulses in the full TD-CRI In an example, the number of bits used to represent the third value may vary depending on the channel bandwidth and therefore the number of pulses in the full TD-CRI. For example, if the channel bandwidth is 20 MHz, a 64-point DFT is required and thus the additional value may be 6 bits long. If the channel bandwidth is 40 MHZ, a 128-point DFT is required and thus the additional value may be 7 bits long. In an example, the additional value could precede the values of filtered TD-CRI. In some examples, the additional value could follow the values of filtered TD-CRI. In an example, the number of bits used for the filtered TD-CRI may be determined based on the resolution of the actual CSI output by the baseband receiver. FIG. 19 illustrates representation 1900 of communication of locations of the principal impulses in the full TD-CRI from sensing receiver 502 to sensing algorithm manager 506 using positions of the principal impulses in the full TD-CRI, according to some embodiments. In the example of FIG. 19, the numbering of the symbols has been shifted to start at “0” and end at “15” to facilitate mapping of the symbols to the position of the filtered TD-CRI value in the reconstructed TD-CRI. In an embodiment, sensing agent 516 of sensing receiver 502 and sensing agent 536 of sensing algorithm manager 506 communicate the locations of the principal impulses in the full TD-CRI.

FIG. 17 to FIG. 19 illustrate examples of communication of the principal impulses in the full TD-CRI utilizing 16-point DFT with 3 guard tones on either side (leaving 10 tones for pilot and data symbols), however the description is equally applicable to 32-point DFT, 64-point DFT, 128-point DFT, 256-point DFT, 512-point DFT, 1024-point DFT, and any other number of points in an DFT, and a variable number of guard tones.

According to an implementation, sensing algorithm manager 506 may receive the filtered TD-CRI and corresponding location information from sensing receiver 502. The filtered TD-CRI may include a plurality of principal impulses. In an implementation, sensing algorithm manager 506 may receive the filtered TD-CRI and corresponding location information over the air via receiving antenna 534. In an implementation, sensing algorithm manager 506 may remove (decode) encoding required to transmit the filtered TD-CRI and corresponding location information over the air.

In response to receiving the filtered TD-CRI and corresponding location information, sensing agent 536 may be configured to generate a reconstructed TD-CRI prior to performing a DFT to create an R-CSI. In an implementation, sensing agent 536 may generate the reconstructed TD-CRI from the filtered TD-CRI and the location information. According to an example, sensing agent 536 may use the location information to determine placement of the principal impulses in the reconstructed TD-CRI. Sensing agent 536 may then transform the reconstructed TD-CRI into R-CSI. Further, sensing agent 536 may execute a sensing algorithm on the R-CSI to obtain a sensing result, such as detecting motions or gestures.

In an implementation, when the filtered TD-CRI is received by sensing algorithm manager 506, a reconstruction of the CSI is made from the information of the filtered TD-CRI. In an implementation, since there are significantly fewer filtered TD-CRI than CSI values then there is a significant reduction in the amount of information that needs to be transmitted over the air as CRI to sensing algorithm manager 506 without losing the fidelity of the information which would compromise the performance of sensing algorithm manager 506. For example, for 52 CSI values (which may represent a 20 MHz channel bandwidth), between 10 and 15 time domain pulse in the filtered TD-CRI may be used to accurately represent transmission channel with minimal loss of fidelity. Accordingly, minimizing the amount of information that needs to be sent minimizes the overhead that system 500 puts on network 560.

FIG. 20A and FIG. 20B depict flowchart 2000 for sending a filtered TD-CRI to sensing algorithm manager 506, according to some embodiments.

In a brief overview of an implementation of flowchart 2000, at step 2002, a sensing transmission is received. At step 2004, a sensing measurement is generated based on the sensing transmission. At step 2006, a full TD-CRI of a propagation channel between sensing receiver 502 and sensing transmitter 504-1 is generated based on the sensing measurement. At step 2008, principal impulses of the full TD-CRI are identified. The principal impulses represent a subset of time domain pulses of the full TD-CRI. At step 2010, a filtered TD-CRI is identified according to the principal impulses. At step 2012, the filtered TD-CRI is sent to sensing algorithm manager 506.

Step 2002 includes receiving a sensing transmission. According to an implementation, sensing receiver 502 may receive the sensing transmission from sensing transmitter 504-1. In an example, sensing receiver 502 may receive the sensing transmission from sensing transmitter 504-1 in response to a sensing trigger message.

Step 2004 includes generating a sensing measurement based on the sensing transmission. According to an implementation, sensing receiver 502 may generate the sensing measurement based on the sensing transmission.

Step 2006 includes generating a full TD-CRI of a propagation channel between sensing receiver 502 and sensing transmitter 504-1 based on the sensing measurement. According to an implementation, sensing receiver 502 may generate the full TD-CRI of the propagation channel between sensing receiver 502 and sensing transmitter 504-1 based on the sensing measurement.

Step 2008 includes identifying principal impulses of the full TD-CRI, the principal impulses representing a subset of time domain pulses of the full TD-CRI. According to an implementation, sensing agent 516 may identify the principal impulses of the full TD-CRI. In an implementation, identifying the principal impulses includes optimizing for a weighted combination of accuracy and size of the filtered TD-CRI. In some implementations, identifying the principal impulses includes minimizing an objective function representing a weighted linear combination of an error factor and a size factor. In an example, the error factor represents an error between channel state information determined from the sensing measurement and reconstructed channel state information determined from the filtered TD-CRI. Further, in an example, size factor represents a number of principal impulses in the filtered TD-CRI. In an implementation, minimizing the objective function includes selecting a first set of principal impulse candidates according to a time domain mask including a time delay filter and an amplitude mask, varying the first set of principal impulse candidates to generate a second set of principal impulse candidates, and comparing the objective function value using the first set of principal impulse candidates and the second set of principal impulse candidates.

Step 2010 includes identifying a filtered TD-CRI according to the principal impulses. According to an implementation, sensing agent 516 may identify the filtered TD-CRI according to the principal impulses.

Step 2012 includes sending the filtered TD-CRI to sensing algorithm manager 506. According to an implementation, sensing receiver 502 may send the filtered TD-CRI to sensing algorithm manager 506. In an implementation, sensing receiver 502 may send location information indicating locations in the full TD-CRI of the principal impulses. In an example, the location information includes a bit map. Further, the location information is included in the filtered TD-CRI.

FIG. 21 depicts flowchart 2100 for executing a sensing algorithm according to reconstructed channel state information (R-CSI) to obtain a sensing result, according to some embodiments.

In a brief overview of an implementation of flowchart 2100, at step 2102, a filtered TD-CRI and corresponding location information are received. At step 2104, a reconstructed TD-CRI is generated from the filtered TD-CRI and the location information. At step 2106, a R-CSI is generated according to the reconstructed TD-CRI. At step 2108, a sensing algorithm is executed according to the R-CSI to obtain a sensing result.

Step 2102 includes receiving a filtered TD-CRI and corresponding location information. According to an implementation, sensing algorithm manager 506 may receive the filtered TD-CRI and corresponding location information. In an implementation, sensing algorithm manager 506 may receive the filtered TD-CRI including a plurality of principal impulses.

Step 2104 includes generating a reconstructed TD-CRI from the filtered TD-CRI and the location information. According to an implementation, sensing algorithm manager 506 may generate the reconstructed TD-CRI from the filtered TD-CRI and the location information, in an implementation, sensing algorithm manager 506 may generate the reconstructed TD-CRI using the location information to determine placement of the principal impulses in the reconstructed TD-CRI. In an example, the location information includes a bit map. Further, the location information is included in the filtered TD-CRI.

Step 2106 includes transforming the reconstructed TD-CRI into reconstructed channel state information. According to an implementation, sensing algorithm manager 506 may transform the reconstructed TD-CRI into R-CSI.

Step 2108 includes executing a sensing algorithm on the R-CSI to obtain a sensing result. According to an implementation, sensing algorithm manager 506 may execute the sensing algorithm on the R-CSI to obtain the sensing result.

According to an implementation, sensing agent 516 may use an IDFT to transform CSI to TD-CRI. In an examples an IFFT is used to calculate the IDFT. In an example, Equation (37) may be written as

$$\frac{1}{\sqrt{N}} [ \begin{matrix}1 & 1 & 1 & … & 1 \\ 1 & {e}^{- j \frac{2 π}{N}} & {e}^{- 2 j \frac{2 π}{N}} & … & {e}^{- ( N - 1 ) j \frac{2 π}{N}} \\ 1 & {e}^{- 2 j \frac{2 π}{N}} & {e}^{- 4 j \frac{2 π}{N}} & … & {e}^{- 2 ( N - 1 ) j \frac{2 π}{N}} \\ ⋮ & ⋮ & & & ⋮ \\ 1 & {e}^{- ( N - 1 ) j \frac{2 π}{N}} & {e}^{- 2 ( N - 1 ) j \frac{2 π}{N}} & … & {e}^{- ( N - 1 ) ( N - 1 ) j \frac{2 π}{N}}\end{matrix} ] [ \begin{matrix}{α}_{0} \\ {α}_{1} \\ {α}_{2} \\ ⋮ \\ {α}_{N - 1}\end{matrix} ] = \qquad ( 37 )$$

$$[ \begin{matrix}H ( {f}_{0} ) \\ H ( {f}_{1} ) \\ H ( {f}_{2} ) \\ ⋮ \\ H ( {f}_{N - 1} )\end{matrix} ]$$

where, N is the number of points in the DFT or FFT,

$$\frac{1}{\sqrt{N}}$$

is the normalization factor, and αₙ represents the magnitude of each of the time domain samples at time n. Also, e⁰=1, hence the first row and column is all ones (1s).

In an example, the value of N may be selected so that each subcarrier in an orthogonal frequency division multiplexed (OFDM) channel may be represented by a single complex sample in the DFT or FFT. In an example, a channel bandwidth may be 20 MHz and N may be 64. In the example, each point in the DFT or FFT may represent a signal present in a carrier separated by the subcarrier spacing, B, of 312.5 kHz (equal to 20 MHz/N). Further, since the frequency domain and time domain are equivalent representations of the same information, when converted to the time domain, the carrier separation of each subcarrier may represent the duration of each OFDM symbol, T, and may be given by 1/B. In the example, B may be 312.5 kHz and T may be 3.2 ms.

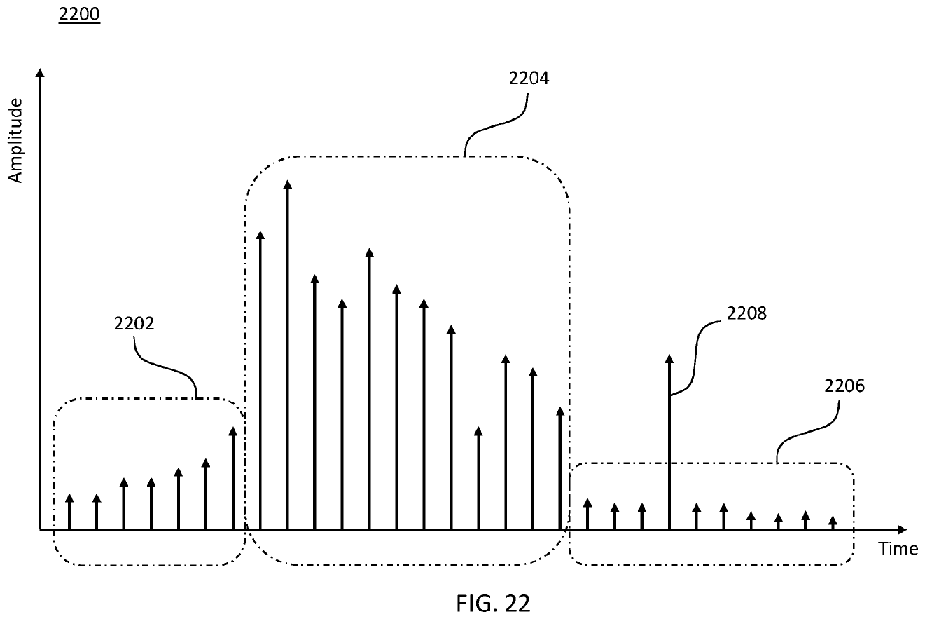

FIG. 22 depicts example 2200 of a full TD-CRI computed by sensing receiver 502 based on a CSI measurement from a sensing transmission, according to some embodiments. In an example, the full TD-CRI computed by sensing receiver 502 forms an impulse response of the channel over which the sensing transmission was carried. FIG. 22 describes received time domain pulses which are grouped according to their generation means. In FIG. 22, the x-axis is a representation of time of the received time domain pulses and the y-axis is a representation of amplitude of the received time domain pulses. The received time domain pulses may be categorized into three sets, namely a first set of received time domain pulses (represented by reference numeral “2202”), a second set of received time domain pulses (represented by reference numeral “2204”), and a third set of received time domain pulses (represented by reference numeral “2206”).

In an implementation, the first set of received time domain pulses may include time domain pulses which may be generated by finite bandwidth signal processing elements present in sensing receiver 502 and sensing transmitter 504. In an example, the finite bandwidth signal processing elements may create time domain pulses across the entire x-axis and may have the effect of producing noise which may be received by sensing receiver 502 prior to receiving the sensing transmission from sensing transmitter 504. In an example, the first set of received time domain pulses may be known as a pre-signal window.

According to an implementation, the second set of received time domain pulses may include time domain pulses which may be generated by direct path element and multipath elements of the sensing transmission as received by sensing receiver 502. In an example, the second set of received time domain pulses may be known as a signal time window.

In an implementation, the third set of received time domain pulses may include time domain pulses which may be generated by background noise in the propagation channel between sensing receiver 502 and sensing transmitter 504, as well as noise produced by the finite bandwidth signal processing elements present in both sensing receiver 502 and sensing transmitter 504. In an example implementation, the amplitude of the time domain pulses of the third set of received time domain pulses may represent a noise level of the propagation channel between sensing receiver 502 and sensing transmitter 504. In an example, the third set of received time domain pulses may be known as a post-signal window.

Example 2200 also shows an example of a spurious time domain pulse (represented by reference numeral “2208”). In an example, the spurious time domain pulse may be a tone which does not fit with its surroundings and may be generated by spurious noise in either sensing receiver 502, sensing transmitter 504, or any other source.

According to an implementation, there may be some time domain pulses within the second set of received time domain pulses which may contribute strongly to the CRI. The time domain pulses which contribute strongly to the CRI may be referred to as principal impulses. In an implementation, the time domain pulses that make up the principal impulses may be determined based on a determination of a signal time window. In other words, the contribution of the over-the-air channel between sensing receiver 502 and sensing transmitter 504 to the impulse response may be finite within the whole impulse response and may be isolated by determining the signal time window of the impulse response.

The relationship between the impulse response in the time domain and the CSI in the frequency domain has been described. Further, it is evident from FIG. 14 that a multipath signal that is received tₖ seconds after the direct path signal will have traveled further through space. The excess distance may be given by Equation (38), provided below.

$${s}_{k} = {ct}_{k} \qquad ( 38 )$$

where, c represents the speed of light.

In an implementation, signals that travel through space may be attenuated by the action and the relationship of received power, Pᵣ, to transmitted power, Pₜ, is given by the Equation (39), provided below.

$$\frac{{P}_{r}}{{P}_{t}} = {D}_{r} {{D}_{t} ( \frac{λ}{4 π d} )}^{2} \qquad ( 39 )$$

where, Dᵣ and Dₜ may represent the directivity of the transmit and receive antenna, λ may represent the wavelength of the transmitted signal, and d may represent the distance traveled through free space. In an example, Equation (39) may be applied to the excess path length of a multipath signal by assuming that D, and D, are equal for all received direct path and multipath signals and by replacing d by sₖ.

In the example, fractional gain for each of k multipath signals may be given by either Equation (40) or Equation (41), provided below.

$$\frac{{P}_{r}}{{P}_{t}} = {D}_{r} {{D}_{t} ( \frac{λ}{4 π {s}_{k}} )}^{2} \qquad ( 40 )$$

$$or$$

$$\frac{{P}_{r}}{{P}_{t}} = {D}_{r} {{D}_{t} ( \frac{λ}{4 π {ct}_{k}} )}^{2} = {D}_{r} {{D}_{t} ( \frac{1}{4 π {ft}_{k}} )}^{2} \qquad ( 41 )$$

where, f is the frequency of the transmitted signal.

In an example, if G_{f} is defined as a cut-off fractional gain at which no signal may be detected, then the cut-off time tₖ may be mathematically represented by Equation (42). The effect of the directivity of both the sensing transmitter and the sensing receiver may be incorporated into the definition of G_{f} hence:

$${t}_{k} = \frac{1}{4 π f \sqrt{{G}_{f}}} \qquad ( 42 )$$

In an implementation, the cut-off time ti may be stated as a number of time domain pulses (or symbols) that are within the cut-off time and may be mathematically represented by Equations (43) and (44), provided below.

$$n = \frac{{t}_{k}}{T} \qquad ( 43 )$$

$$and$$

$$n = \frac{1}{4 π fT \sqrt{{G}_{f}}} \qquad ( 44 )$$

where, n may represent number of time domain pulses that are within the cut-off time and T may represent system period. Accordingly, from the cut-off time, a determination of the number of time domain pulses that the cut-off time represents may be made. According to an implementation, the cut-off fractional gain G_{f} may be determined as a gain below which a multipath signal is known to be too highly attenuated by free space loss and the receiver and transmitter directivity to be detected. In an example, the determination of the cut-off fractional gain G_{f} may allow the calculation of cut-off time and of the number of time domain pulses that the cut-off time represents.

According to an implementation, a determination may be made, prior to processing of any sensing measurement, of a set of time domain pulses in a processed sensing measurement that cannot be affected by features of interest in a sensing space. In an example, a time after which no real signal caused by a feature of interest may be detectable may be determined based on Equations (38) to (44). Furthermore, a margin factor may be added to the determination to ensure that no signal may be present in the determined set of time domain pulses. In an examples, the time after which no real signal caused by a feature of interest may be detectable may be doubled. In an implementation, an average amplitude of the determined set of time domain pulses may allow the computation of the average noise floor of the propagation channel between sensing receiver 502 and sensing transmitter 504. In an example, the averaging operation may reduce or mitigate the effect of spurious noise in the determined set of time domain pulses. In an implementation, sensing agent 516 may determine the average amplitude using a mean operation. In an example implementation, sensing agent 516 may calculate a mean noise power from mean amplitude. Subsequently, sensing agent 516 may compute a measure of standard deviation (σ) of the mean noise power. Sensing agent 516 may then determine the threshold to be greater than a scaled mean noise power. In an examples, the threshold may be three standard deviations (3σ) above the mean noise power.

In an implementation, there may be an unknown number of time domain pulses at the beginning of the impulse response which may be contributed by finite bandwidth signal processing elements in both sensing transmitter 504 and sensing receiver 502. In an example, the unknown time domain pulses may arrive prior to the sensing transmission. Accordingly, the end of the unknown time domain pulses may mark the beginning of the time domain pulses which may be contributed by the sensing transmission. In an implementation, sensing agent 516 may be configured to determine the most likely time domain pulse that marks the final contribution of the finite bandwidth signal processing elements. The next time domain pulse in the sequence may be determined to be the first time domain pulse or the starting impulse. In an implementation, the first time domain pulse or the starting impulse may be referred to as x₀. In an implementation, the signal time window (in which the contribution of the impulse response may most likely be due to the effects of the propagation channel between sensing receiver 502 and sensing transmitter 504 (i.e., sensing measurements)) may start from the first time domain pulse that exceeds the threshold and ends n time domain pulses later. This may be described by the equation x₁=x₀+n, where x₁ may represent an ending impulse. In some examples, a buffer may be added to n to reduce the likelihood that any time domain pulse is lost. In an example, the buffer may be implemented by multiplying n by a scaling factor. In an example, the scaling factor may be between 1.1 and 2.0.

According to an implementation, to reduce the complexity of the transformation between the CSI (frequency domain) and full TD-CRI (time domain), a limited number of time domain pulses n from x₀ to x₁ may be required (where n is the difference between x₀ and x₁ and n is less than the number of tones in the CSI/full TD-CRI, N_{FFT}, and may be significantly less than N_{FFT}.

Referring back to FIG. 5A/FIG. 5B, in an implementation, sensing agent 516 may generate a partial TD-CRI of the CSI by transforming the CSI to identify a plurality of time domain pulses occurring in a window of a time domain. In an example, the window may be any of pre-signal window, signal time window, post-signal window or any other partial set of time domain pulses that may be considered. According to an implementation, sensing agent 516 may transform the CSI based on applying a transform to the CSI to obtain only the plurality of time domain pulses occurring in the window and not obtain time domain pulses occurring outside of the window. In an implementation, sensing agent 516 may apply an optimized IFFT to the CSI to obtain only the plurality of time domain pulses occurring in the window. In an example, sensing agent 516 may apply radix-2 decimation-in-time IFFT to the CSI. In some implementations, sensing agent 516 may apply any signal processing algorithm such as FIR filtering, IIR filtering, z-transform, chirp z-transform, and Goertzel filter to the CSI to obtain only the plurality of time domain pulses occurring in the window.

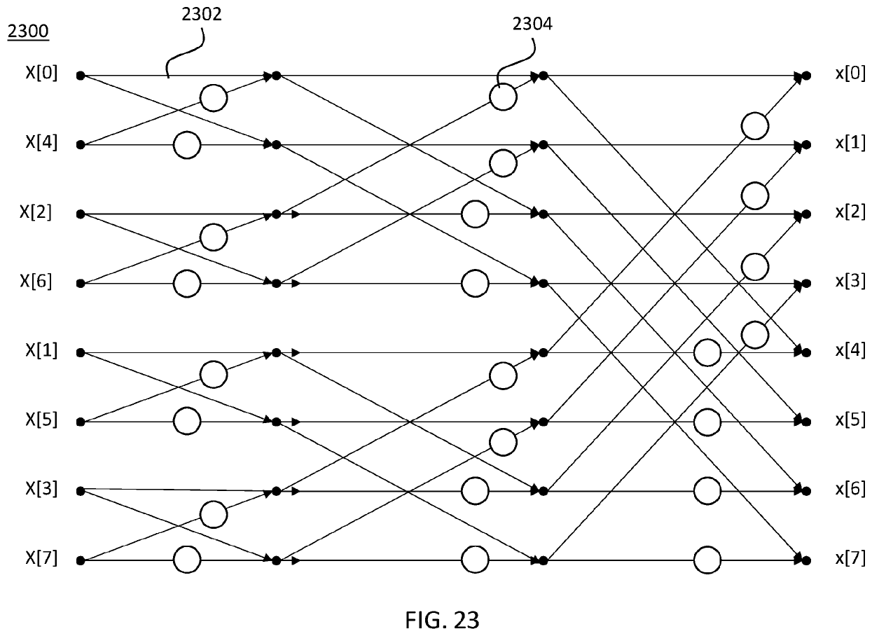

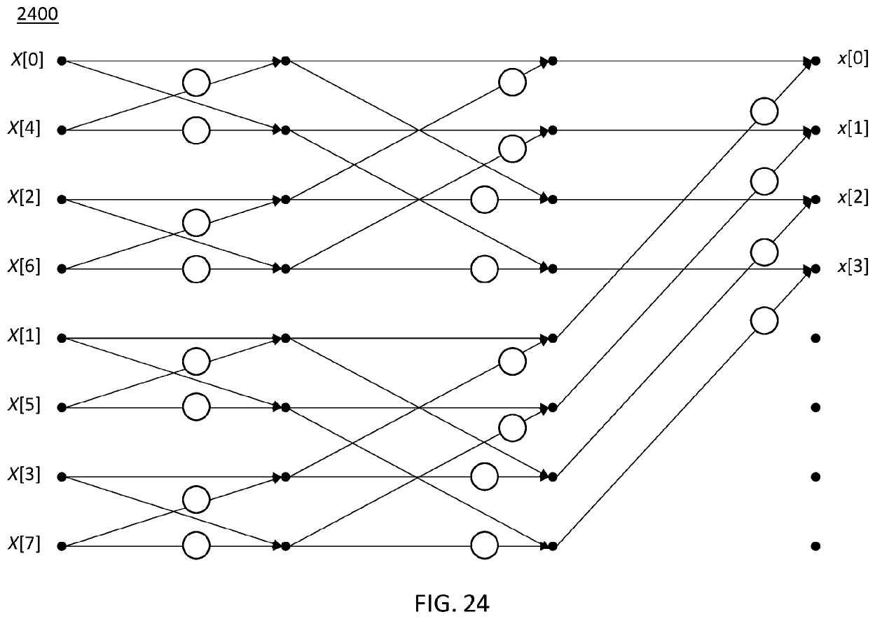

In an implementation, an IFFT may be represented by a signal flow graph which shows the mathematical operations of the transform in a graphical pattern. FIG. 23 depicts signal flow graph 2300 of an 8-point IFFT, according to some embodiments. In FIG. 23, each arrow (an example of which is represented by reference numeral “2302”) shows where a result from a previous calculation is carried to the next stage with the option of a negation operation (i.e., multiplying the result by −1). In an implementation, the signal flow starts with frequency domain samples on the left and ends with time domain samples on the right. Further, each circle (an example of which is represented by reference numeral “2304”) shows a complex multiplication by a branch transmission parameter. In an example, the multiplication by the branch transmission parameter may reflect the order of complexity (represented by the notation, O(⋅)) of an FFT or IFFT algorithm given by O(N log₂N), where N is the number of time domain points (i.e., N_{FFT}). Further, the order of the frequency domain samples at the input of the signal flow graph may be shuffled in relation to the time domain samples. As described previously, the window may limit the number of time domain pulses that are required to be calculated and as a result, calculations as described in FIG. 23 that contribute to time domain pulses that are not required do not need to be carried out. This leads to an optimization of the IFFT calculation. FIG. 24 depicts signal flow graph 2400 of an 8-point IFFT when only half of the time domain pulses are required to be calculated (referred to as resultant time domain pulses) and operations (represented by arrows 2302 and circles 2304) that lead to the time domain pulses that are no longer calculated are removed (i.e., they are not carried out), optimizing the IFFT calculation).

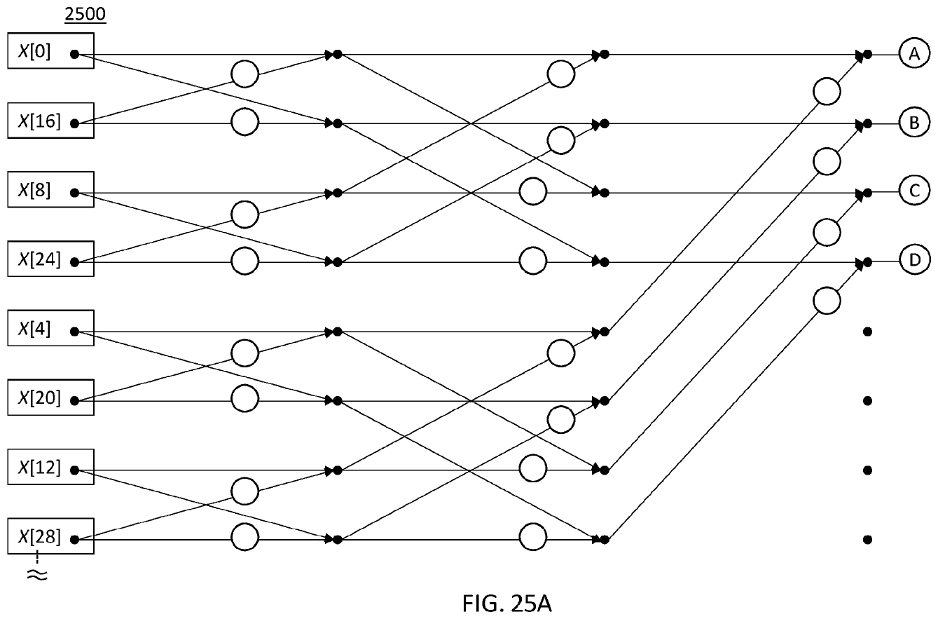

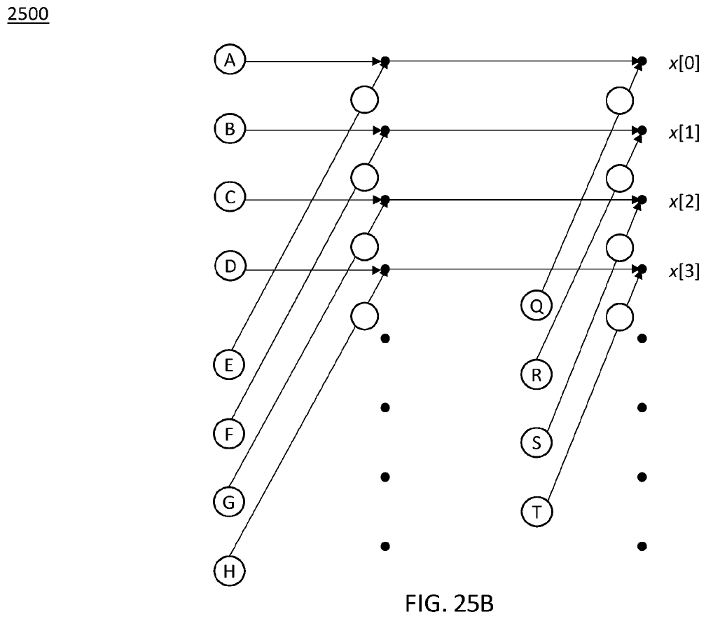

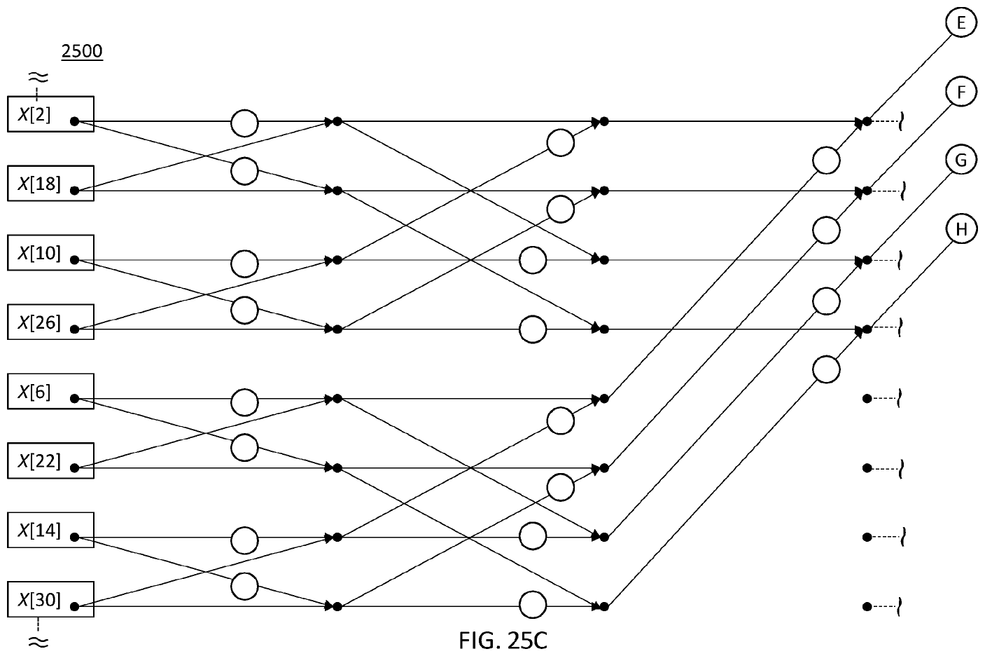

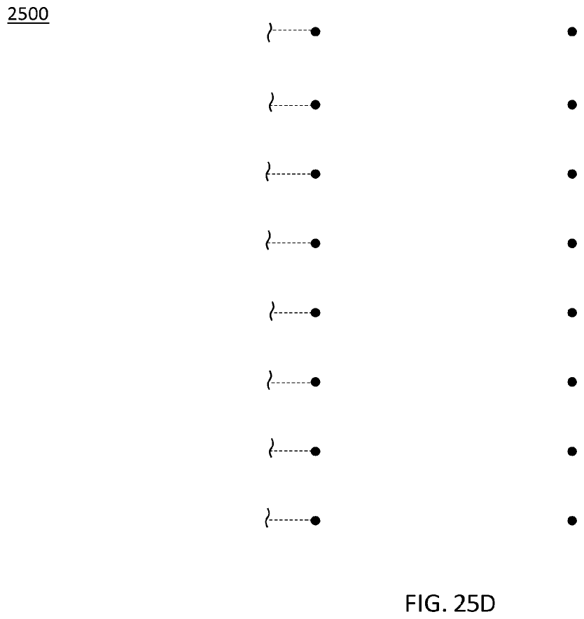

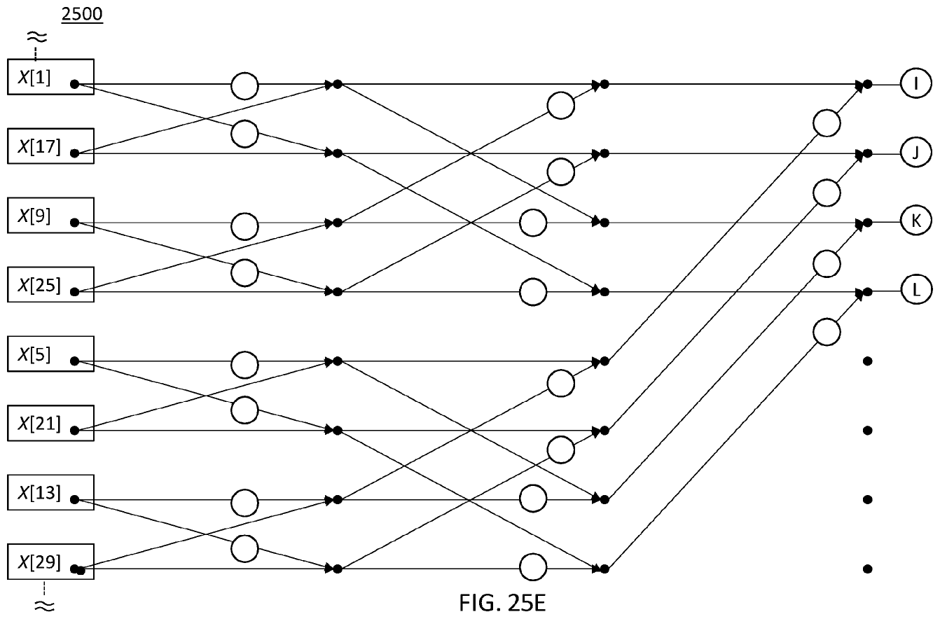

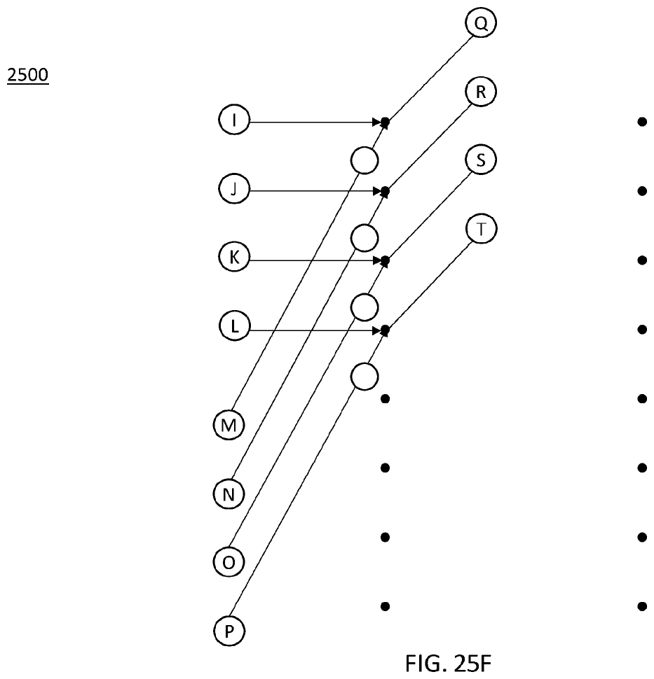

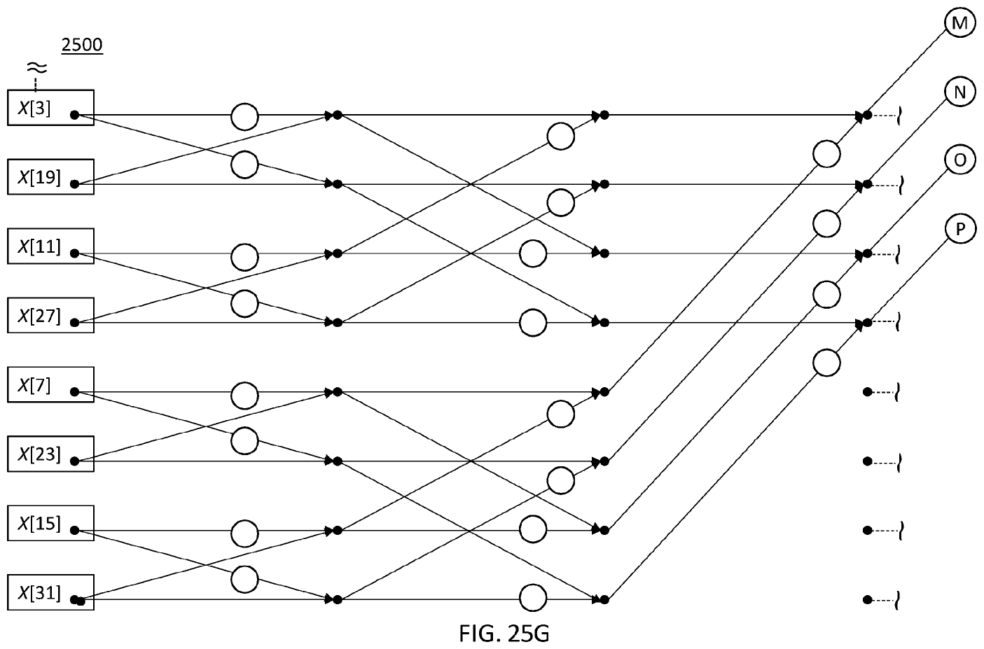

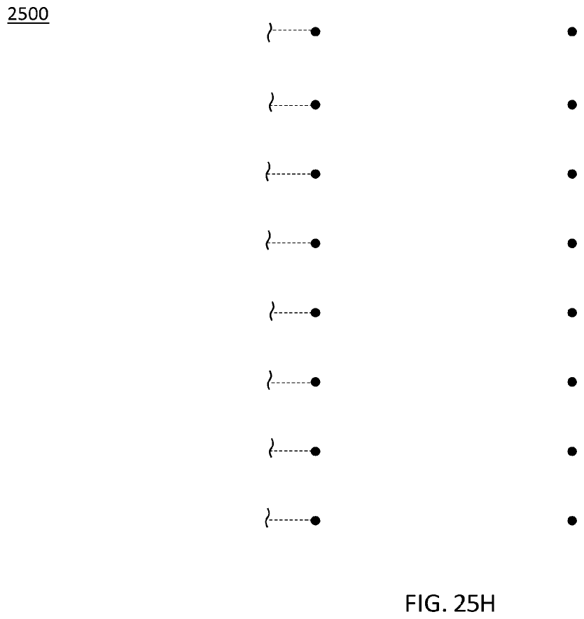

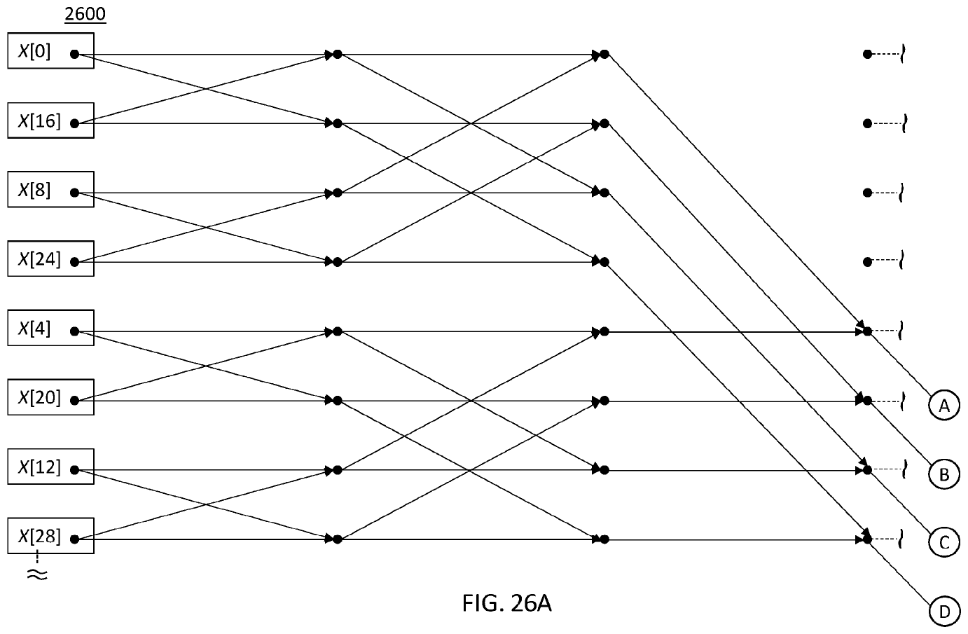

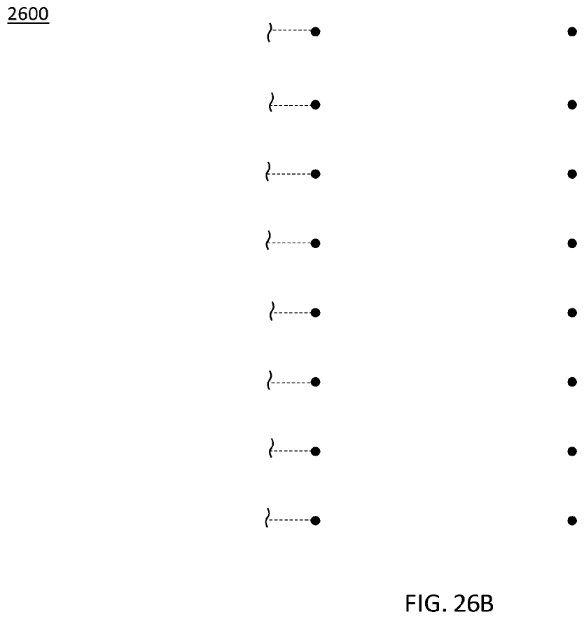

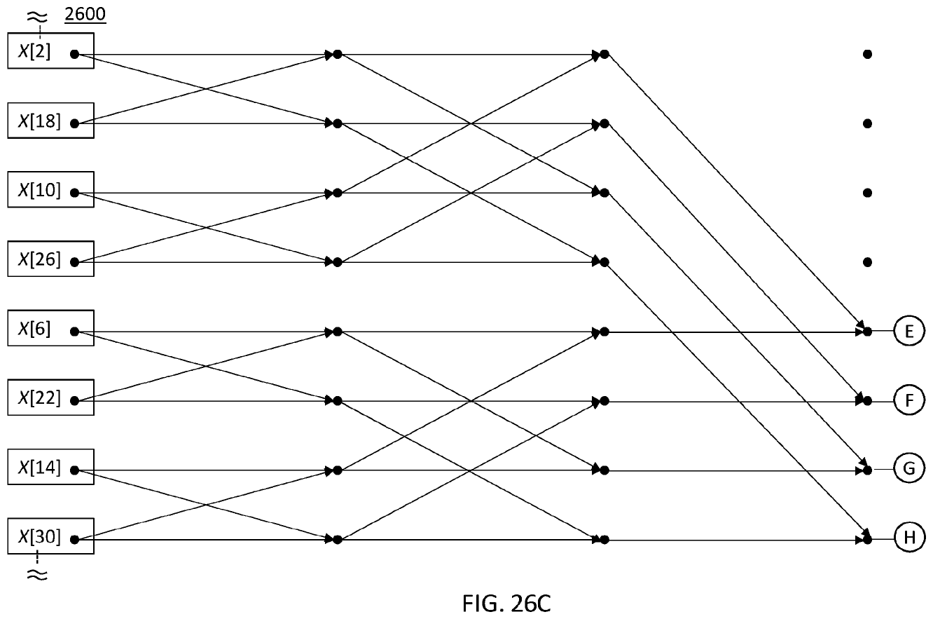

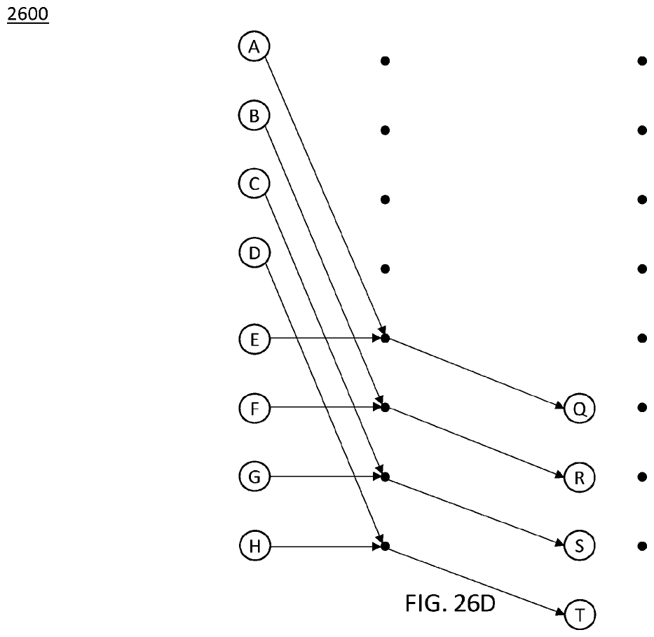

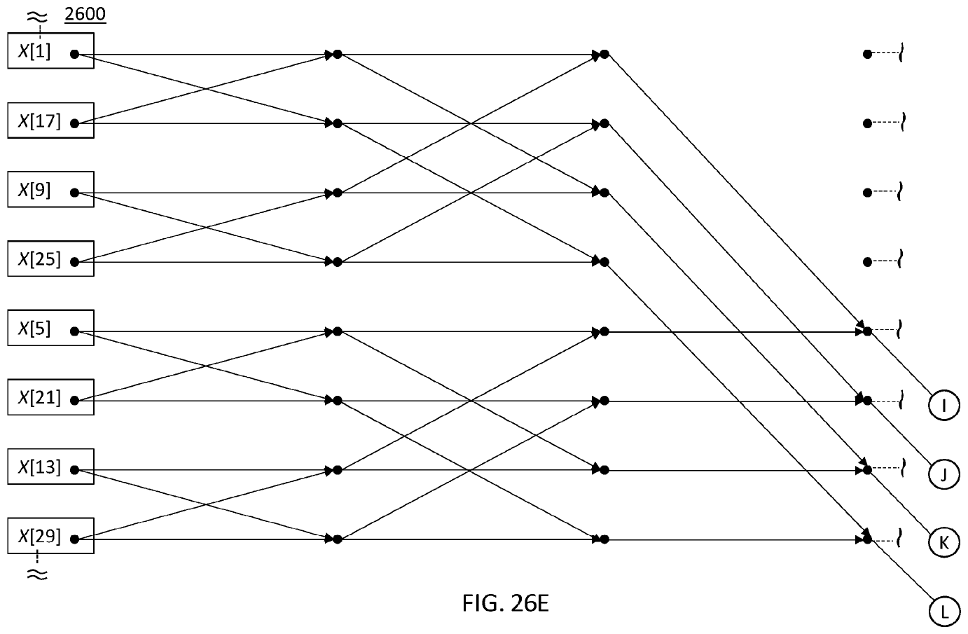

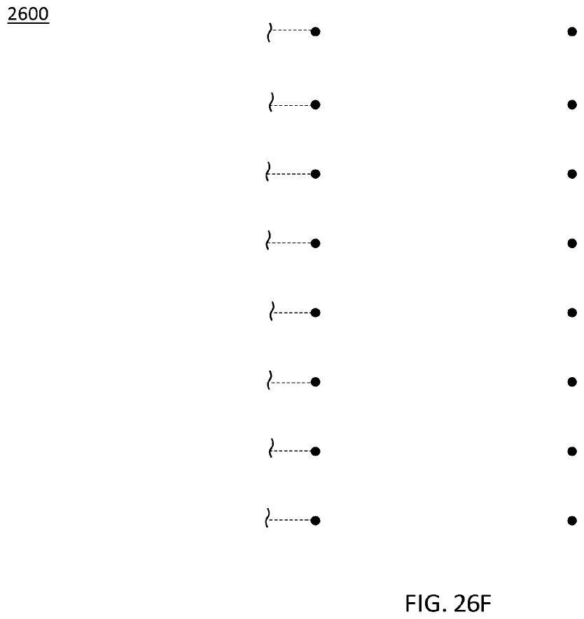

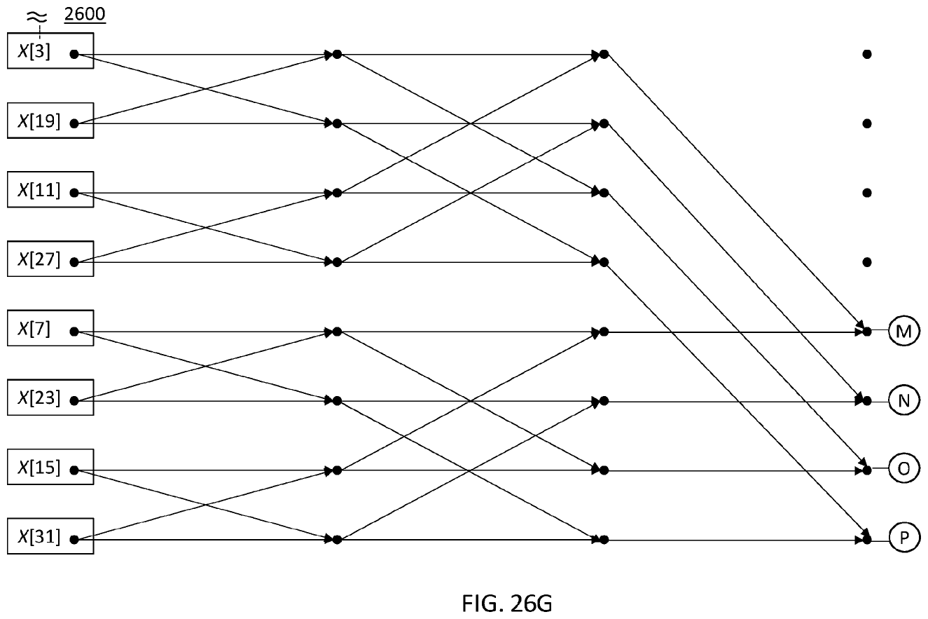

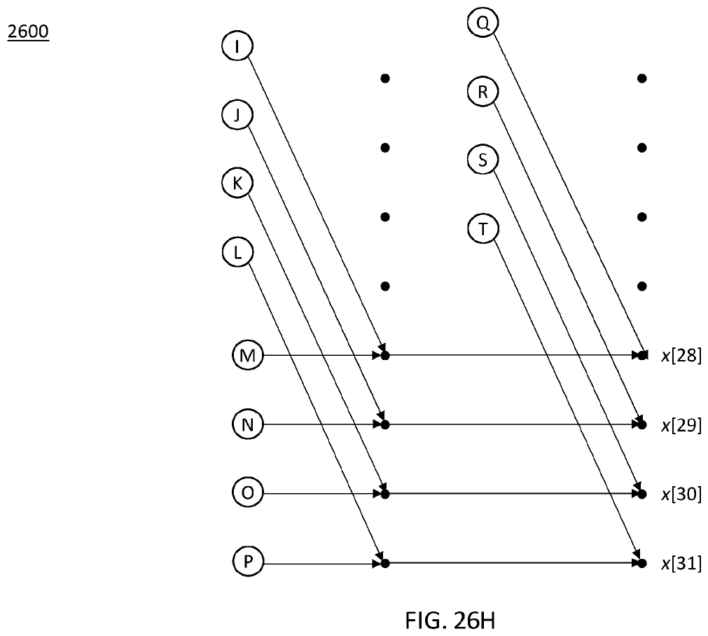

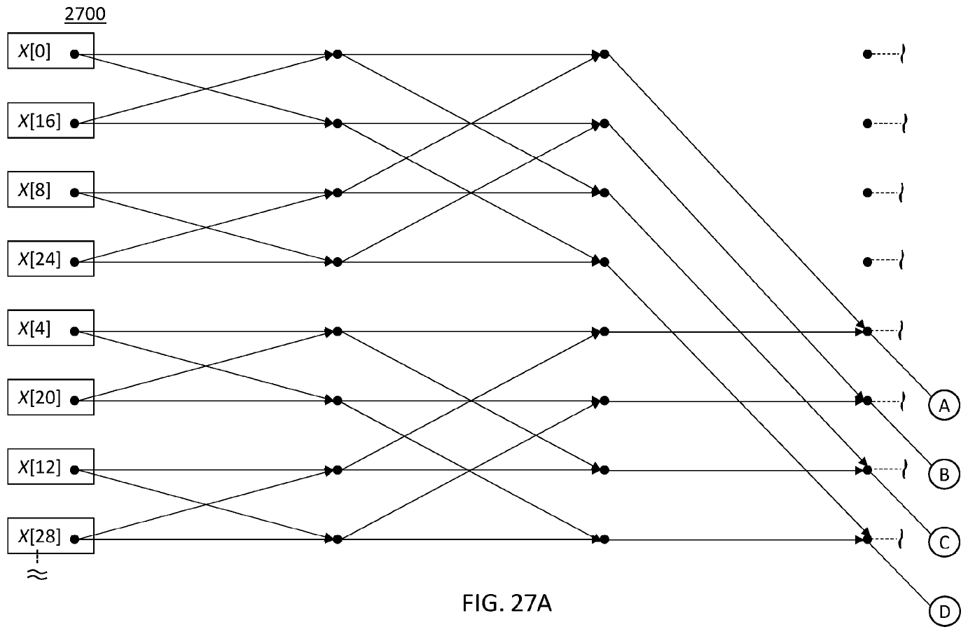

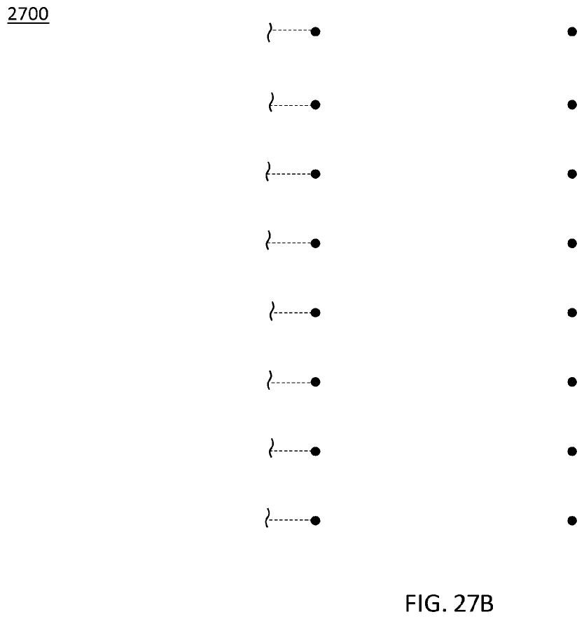

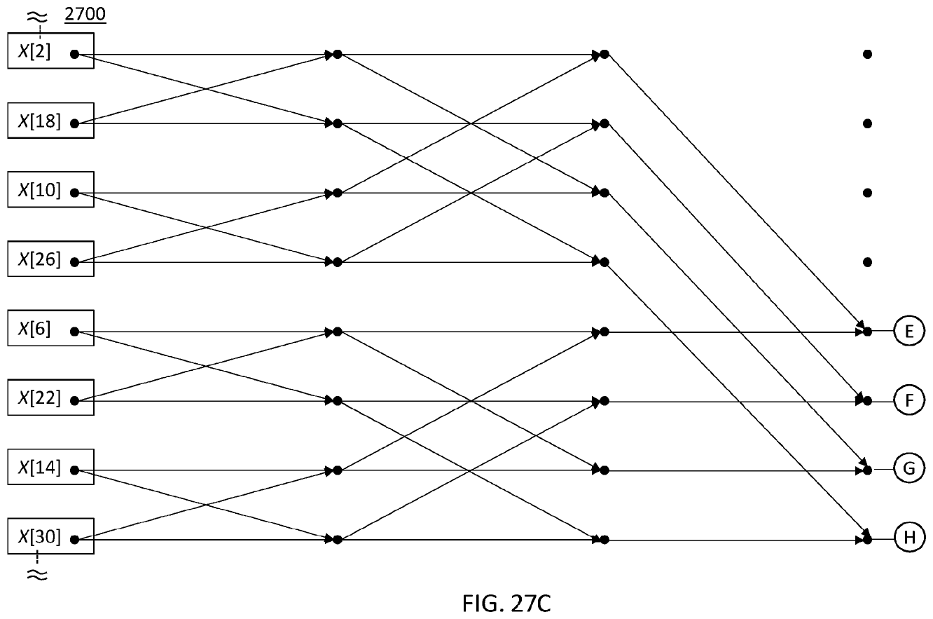

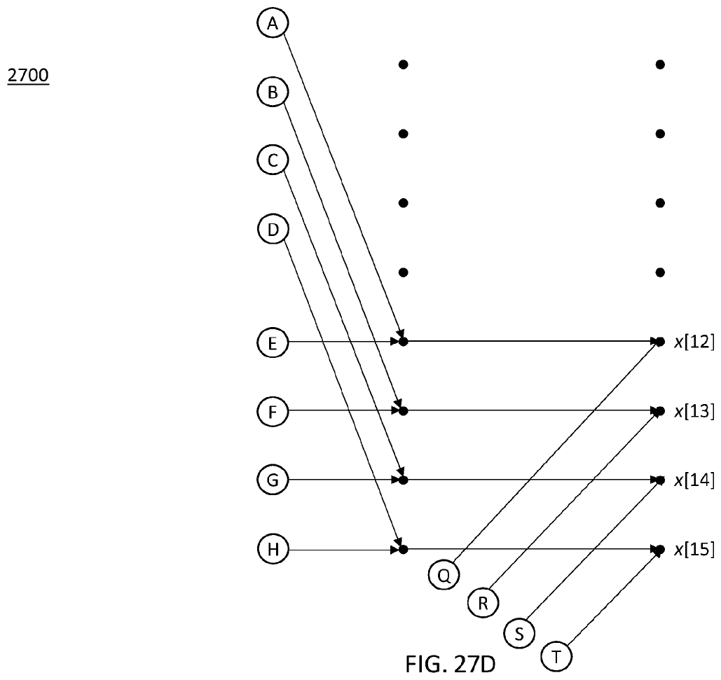

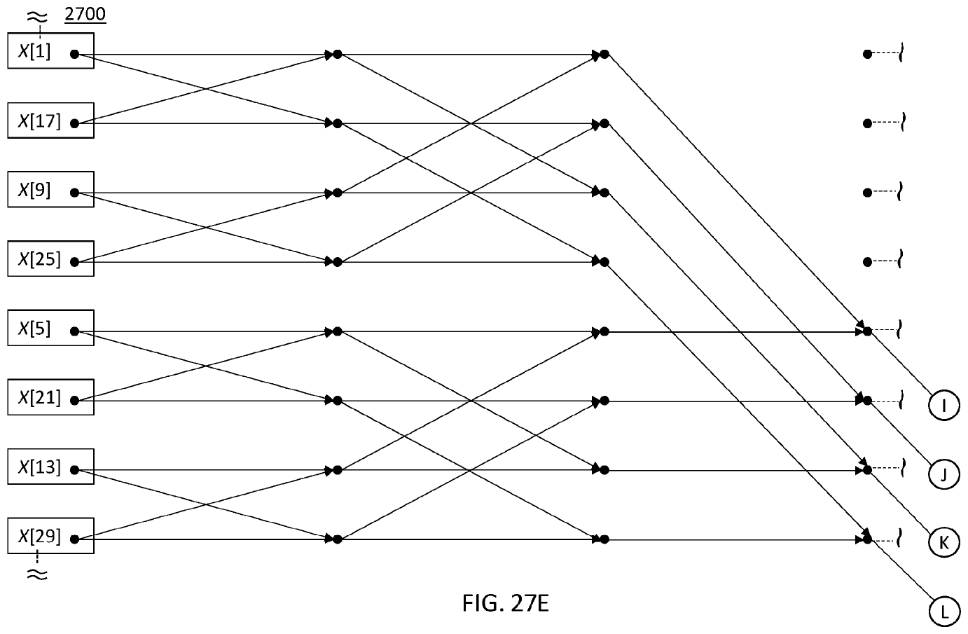

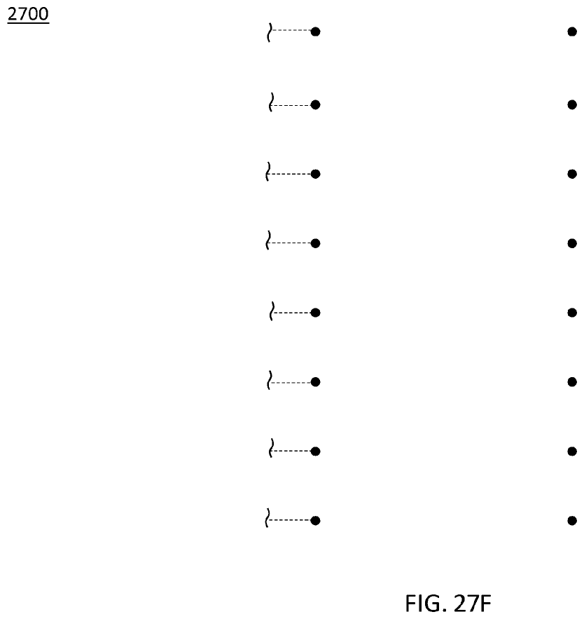

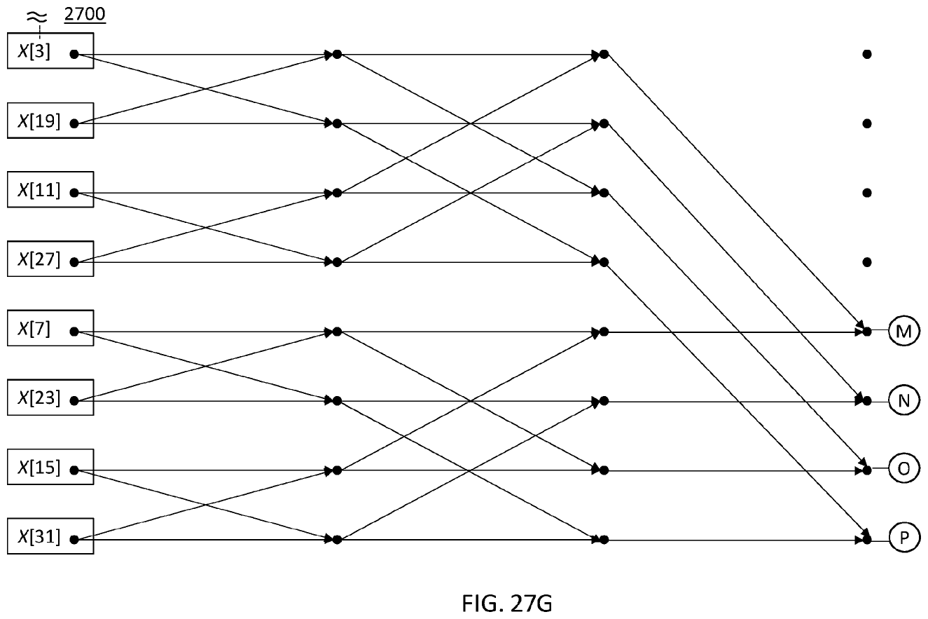

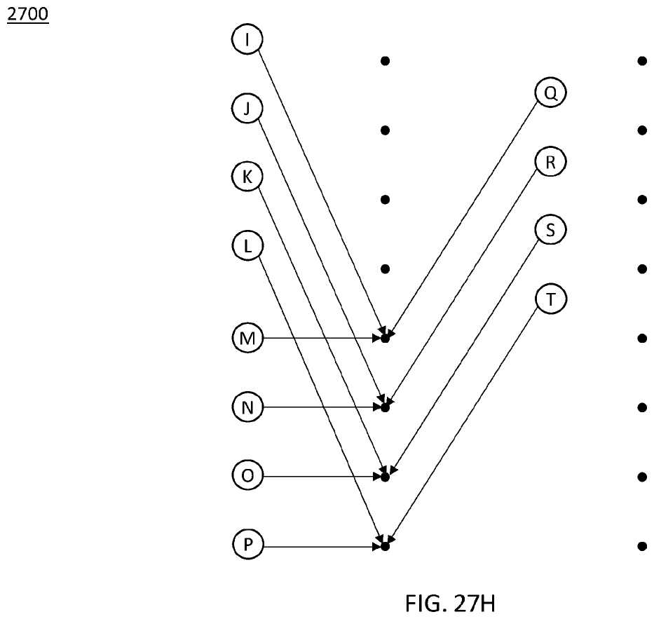

FIG. 25A to FIG. 25H depict signal flow graph 2500 of a 32-point IFFT when only four resultant time domain pulses are required to be calculated at the start of the full IFFT, according to some embodiments. As described in FIG. 25A to FIG. 25H, the 32-point IFFT has a larger relative number of time domain pulses which are rejected. FIG. 26A to FIG. 26H depict signal flow graph 2600 of the 32-point IFFT, according to some embodiments, and FIG. 27A to FIG. 27H depict signal flow graph 2700 of the 32-point IFFT, according to some embodiments. As described in FIG. 26A to FIG. 26H, the location of the resultant time domain pulses is at the end of the full IFFT. Further, As described in FIG. 27A to 27H, the location of the resultant time domain pulses is at a mid-point of the full IFFT. The circles representing the complex multiplications have been omitted from FIG. 26A to FIG. 26H and FIG. 27A to FIG. 27H for clarity. As shown in FIG. 25A to FIG. 25H, FIG. 26A to FIG. 26H, and FIG. 27A to FIG. 27H, there are common operations which must be carried out to calculate different resultant time domain pulses of an optimized IFFT. In an implementation, several optimized IFFTs may be carried out using the same input data set to analyze different portions of the output. In these implementations, results of intermediate operations (e.g., the result of a calculation exemplified by arrow 2302 or by circle 2304) of an optimized IFFT may be stored temporarily (for example, in memory connected to a processor responsible for calculating the optimized IFFT or in channel representation information storage 518) and reused during the calculation of a second or subsequent optimized IFFT.

Referring back to FIG. 5A/FIG. 5B, sensing agent 516 may be configured to identify a filtered TD-CRI based on the partial TD-CRI. In an example, all the time domain pulses of the partial TD-CRI may be considered to be filtered TD-CRI. Accordingly, sensing agent 516 may identify the filtered TD-CRI based on setting the filtered TD-CRI as the partial TD-CRI. In some implementations, sensing agent 516 may identify the filtered TD-CRI based on identifying principal impulses of the partial TD-CRI representing a subset of time domain pulses of the partial TD-CRI.

According to an implementation, sensing agent 516 may identify the principal impulses based on optimizing for a weighted combination of accuracy and size of the partial TD-CRI. In an implementation, sensing agent 516 may identify the principal impulses based on minimizing an objective function representing a weighted linear combination of an error factor and a size factor. The error factor represents an error between CSI determined from the sensing measurement and R-CSI determined from the partial TD-CRI by transforming the partial TD-CRI into the frequency domain. The size factor represents a number of principal impulses carried by the partial TD-CRI.

In an example, the objective function represents the trade-off between the fidelity of the R-CSI and the amount of information to be transferred over the air. In an example implementation, the objective function is given by Equation (45), provided below.

$$J ( h ) = {‖ {H}_{R} ( f ) - H ( f ) ‖}_{2} + λ {‖ {c}_{N} ‖}_{1} \qquad ( 45 )$$

where H(f) and H_{R}(f) represent CSI and R-CSI, respectively, c_{N} represents a constrained set of time domain pulse (i.e., a candidate set of principal impulses) and A represents a parameter that is adjustable and is used to modify relative emphasis on each of the terms in the objective function J(h). ∥⋅∥ represents a 1-norm operation and ∥·∥₂ represents a 2-norm operation.

In an implementation, as a part of an optimization process, sensing agent 516 may minimize the objective function J(h). In an example, by minimizing the objective function J(h), the error between the CSI and the R-CSI is reduced while maintaining the overall magnitude and number of the coefficients in c_{N} small. According to an implementation, the selection of the time domain pulses is varied iteratively until the objective function is minimized, thus resulting in the principal impulses.

The 1-norm of a 1×n matrix (i.e., a column vector of length n) is represented by the expression:

$${‖ x ‖}_{1} = {\sum }_{i = 1}^{n} \vert {x}_{i} \vert \qquad ( 46 )$$

The 2-norm of a 1×n matrix (i.e., a column vector of length n) is represented by the expression:

$${‖ x ‖}_{2} = \sqrt{( {\sum }_{i = 1}^{n} {\vert {x}_{i} \vert}^{2} )} \qquad ( 47 )$$

In an example implementation, to minimize the objective function (h), sensing agent 516 may perform an iterative calculation. Initially, a vector c_{N} may be chosen by use of a algorithm. Subsequently, H_{R}(f) is calculated using the vector c_{N} and the objective function J(h) is determined. In an implementation, different permutations may be performed until a minimum value of the objective function J(h) is determined or the objective function J(h) is minimized. In an example, the selection of the time domain pulses in the partial TD-CRI is varied until the objective function J(h) is minimized, resulting in the optimized set of partial TD-CRI, i.e., the principal impulses.

According to an implementation, sensing agent 516 may store the partial TD-CRI and the filtered TD-CRI in channel representation information storage 518 for future use. Upon identifying the filtered TD-CRI, sensing agent 516 may be configured to send the filtered TD-CRI to sensing algorithm manager 506. In an implementation, the TD-CRI may include the exact same information of the channel representation as the CSI, however this information is typically concentrated in only a few of the time domain pulses. Accordingly, the CRI can be represented with fewer time domain pulses (i.e., the filtered TD-CRI) by only sending the time domain pulses that are needed. In an implementation, sensing agent 516 may communicate the filtered TD-CRI to sensing algorithm manager 506 via a CRI transmission message. In an example implementation, sensing agent 516 may send the CRI transmission message to sensing algorithm manager 506 over the air via transmitting antenna 512. In an implementation, sensing algorithm manager 506 may execute a sensing algorithm on the filtered TD-CRI to obtain a sensing result, such as detecting motions or gestures. Further, the IFFT is optimized for quick and efficient execution outside of the PHY layer of sensing receiver 502.

According to an implementation, sensing agent 516 may determine a partial TD-CRI from the signal time window. In an implementation, for determining a partial TD-CRI from the signal time window, sensing agent 516 may initially determine a cut-off time in the sensing transmission as an end of the signal time window. In an example, the cut-off time may represent the time after which no meaningful signal from the sensing transmission, sent from sensing transmitter 504 and affected by a sensing space and objects within the sensing space, may be expected. In an implementation, sensing agent 516 may determine the cut-off time by selecting a time in the sensing transmission based on a system model of one or more of sensing transmitter 504, sensing receiver 502, and the sensing space. In an example the system model determines the cut-off time by considering free space loss as described in equations (38) to (42). Sensing agent 516 may then form a partial TD-CRI to identify post cut-off pulses occurring in a post-signal window occurring after the cut-off time. In an example, an optimized IFFT may be used to form the partial TD-CRI. In an example, the size of the post-signal window is a fraction of the total size of a full-TD-CRI and in a further example, the fraction of the total size of a full-TD-CRI used is one tenth (10 percent). Thereafter, sensing agent 516 may sample a noise level in the post cut-off pulses. In an implementation, sensing agent 516 may determine a threshold according to the noise level.

Sensing agent 516 may then identify a first time domain pulse exceeding the threshold and set a beginning of the signal time window according to the first time domain pulse. In an example, the first time domain pulse may be a pulse which is not a contribution of noise.

In an implementation, to identify the first time domain pulse, sensing agent 516 may transform the CSI to form a partial TD-CRI where the partial TD-CRI forms a pre-signal window in the time domain. In an implementation, the pre-signal window contains a plurality of time domain pulses which may be dependent on a configuration value. In an example, the size of the pre-signal window may be 10 percent of all pulses in the full TD-CRI. In the example, the pre-signal window contains a number of time domain pulses equal to 10 percent of the number of pulses in the full TD-CRI. Pulses in the pre-signal window may be referred to a pre-signal pulses. Thereafter, sensing agent 516 may detect a presence of a pre-signal pulse from the pre-signal pulses in the pre-signal window that exceeds the threshold. Responsive to detecting the presence of the pre-signal pulse that exceeds the threshold, sensing agent 516 may set the pre-signal pulse as the first time domain pulse. In an example, first time domain pulse is the start of the signal time window.

In an example, there may be no pre-signal pulse that exceeds the threshold in the pre-signal window. In an implementation, sensing agent 516 may make a second transform of the CSI to form a second partial TD-CRI where the second partial TD-CRI forms a second pre-signal window in the time domain. The second pre-signal window may be adjacent to the pre-signal window and may contain a plurality of time domain pulses which represent signals which are later in time to the plurality of time domain pulses in the pre-signal window. In an example, the size of the second pre-signal window may be 10 percent of all pulses in the full TD-CRI and, in the example, the pre-signal window contains a number of time domain pulses equal to 10 percent of the number of pulses in the full TD-CRI but covering the second 10 percent of all pulses in the full TD-CRI.

Thereafter, sensing agent 516 may repeat the detection process to detect a presence of a pre-signal pulse from the pre-signal pulses in the second pre-signal window that exceeds the threshold. Responsive to detecting the presence of the pre-signal pulse that exceeds the threshold, sensing agent 516 may set the pre-signal pulse as the first time domain pulse.

In an implementation, this process may be repeated iteratively until the presence of the pre-signal pulse that exceeds the threshold is detected, or until there are no more time domain pulses in the full TD-CRI to be searched.

According to an implementation, sensing agent 516 may calculate a partial TD-CRI from the CSI and the signal time window defined by first time domain pulse and the cut-off time to obtain only a plurality of time domain pulses occurring in the signal time window and not obtain time domain pulses occurring outside of the signal time window. In an example, an optimized IFFT algorithm is used to calculate the partial TD-CRI from the CSI and the signal time window. In an example, the plurality of time domain pulses may represent the channel between sensing transmitter 504 and sensing receiver 502.

FIG. 28A and FIG. 28B depict flowchart 2800 for sending filtered TD-CRI to sensing algorithm manager 506, according to some embodiments.

In a brief overview of an implementation of flowchart 2800, at step 2802, CSI in a frequency domain is received which is generated based on a sensing transmission received from sensing transmitter 504. At step 2804, a signal time window is determined. At step 2806, a partial TD-CRI of the CSI is generated by transforming the CSI to identify a plurality of time domain pulses occurring in the signal time window of a time domain. At step 2808, a filtered TD-CRI is identified based on the partial TD-CRI. At step 2810, the filtered TD-CRI is sent to sensing algorithm manager 506.

Step 2802 includes receiving CSI in a frequency domain, generated based on a sensing transmission received from sensing transmitter 504. According to an implementation, sensing receiver 502 may be configured to receive CSI in the frequency domain generated based on the sensing transmission received from sensing transmitter 504.

Step 2804 includes determining a signal time window. According to an implementation, sensing receiver 502 may be configured to determine the signal time window.

Step 2806 includes generating a partial TD-CRI of the CSI by transforming the CSI to identify a plurality of time domain pulses occurring in the signal time window of a time domain. According to an implementation, sensing receiver 502 may be configured to generate the partial TD-CRI of the CSI by transforming the CSI to identify the plurality of time domain pulses occurring in the signal time window of the time domain. In an implementation, sensing receiver 502 may transform the CSI by applying a transform to the CSI to obtain only the plurality of time domain pulses occurring in the signal time window and not obtain time domain pulses occurring outside of the signal time window. In an example, the plurality of time domain pulses may represent the channel between sensing transmitter 504 and sensing receiver 502.

Step 2808 includes identifying a filtered TD-CRI based on the partial TD-CRI. According to an implementation, sensing receiver 502 may be configured to identify a filtered TD-CRI based on the partial TD-CRI. In an implementation, identifying the filtered TD-CRI may include setting the filtered TD-CRI as the partial TD-CRI. In some implementations, identifying the filtered TD-CRI may include identifying principal impulses of the partial TD-CRI representing a subset of time domain pulses of the partial TD-CRI.

Step 2810 includes sending the filtered TD-CRI to sensing algorithm manager 506. According to an implementation, sensing receiver 502 may be configured to send the filtered TD-CRI to sensing algorithm manager 506.

FIG. 29 depicts flowchart 2900 for determining a signal time window, according to some embodiments.

In a brief overview of an implementation of flowchart 2900, at step 2902, a cut-off time is determined in a sensing transmission. At step 2904, CSI is transformed to identify post cut-off pulses occurring in a post-signal window occurring after the cut-off time. At step 2906, a noise level in the post cut-off pulses is sampled. At step 2908, a threshold is determined according to the noise level. At step 2910, a first time domain pulse exceeding the threshold is identified. At step 2912, a beginning of a signal time window is set according to the first time domain pulse.

Step 2902 includes determining a cut-off time in the sensing transmission. According to an implementation, sensing receiver 502 may be configured to determine the cut-off time in the sensing transmission. In an example, the cut-off time may represent the time after which no meaningful signal is expected. In an implementation, sensing receiver 502 may determine the cut-off time by select the time in the sensing transmission based on a system model of sensing transmitter 504 and sensing receiver 502.

Step 2904 includes transforming CSI to identify post cut-off pulses occurring in a post-signal window occurring after the cut-off time. According to an implementation, sensing receiver 502 may be configured to transform the CSI to identify post cut-off pulses occurring in the post-signal window occurring after the cut-off time.

Step 2906 includes sampling a noise level in the post cut-off pulses. According to an implementation, sensing receiver 502 may be configured to sample the noise level in the post cut-off pulses.

Step 2908 includes determining a threshold according to the noise level. According to an implementation, sensing receiver 502 may be configured to determine the threshold according to the noise level.

Step 2910 includes identifying a first time domain pulse exceeding the threshold. According to an implementation, sensing receiver 502 may be configured to identify the first time domain pulse exceeding the threshold. In an implementation, sensing receiver 502 may identify the first time domain pulse based on transforming the CSI to identify pre-signal pulses occurring in a pre-signal window in the time domain, detecting a presence of a pre-signal pulse from the pre-signal pulses in the pre-signal window that exceeds the threshold, responsive to detecting the presence of the pre-signal pulse that exceeds the threshold, setting the pre-signal pulse as the first time domain pulse. In an example, the pre-signal window may be a subsequent pre-signal window. According to an implementation, sensing receiver 502 may transform the CSI to identify first pre-signal pulses occurring in a first pre-signal window occurring before the subsequent pre-signal window in the time domain. Subsequently, sensing receiver 502 may detect the non-presence of any pre-signal pulses from the first pre-signal pulses in the first pre-signal window that exceed the threshold. In an implementation, responsive to detecting the non-presence of any first pre-signal pulses from the first pre-signal pulses in the first pre-signal window that exceed the threshold, sensing receiver 502 may apply the transform to the CSI to identify the pre-signal pulses in the subsequent pre-signal window.

Step 2912 includes setting a beginning of a signal time window according to the first time domain pulse. According to an implementation, sensing receiver 502 may be configured to set the beginning of the signal time window according to the first time domain pulse.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

Embodiment 1 is a method for Wi-Fi sensing carried out by a Wi-Fi device including at least one processor configured to execute instructions to implement a sensing agent, the method comprising: receiving, by the at least one processor, a sensing measurement in a frequency domain generated based on a sensing transmission received from a sensing transmitter; generating, by the at least one processor, a time domain representation of the sensing measurement; selecting, by the at least one processor, one or more time domain pulses indicative of the time domain representation; and communicating, by the at least one processor, the one or more time domain pulses to a sensing algorithm manager for use in determining motion or movement.

Embodiment 2 is the method of embodiment 1, wherein the time domain representation is a full time-domain channel representation (TD-CRI) of a propagation channel between a sensing receiver and the sensing transmitter based on the sensing measurement, selecting the one or more time domain pulses includes identifying principal impulses of the full TD-CRI, the principal impulses representing a subset of time domain pulses of the full TD-CRI, and communicating the one or more time domain pulses to the sensing algorithm manager includes identifying a filtered TD-CRI comprising the principal impulses and sending the filtered TD-CRI to a sensing algorithm manager.

Embodiment 3 is the method of embodiment 2, further comprising: sending, to the sensing algorithm manager, location information indicating locations in the full TD-CRI of the principal impulses.

Embodiment 4 is the method of embodiment 3, wherein the location information includes a bit map.

Embodiment 5 is the method of embodiment 3 or 4, wherein the location information is included in the filtered TD-CRI.

Embodiment 6 is the method of any of embodiments 3-5, further comprising: obtaining, by the sensing algorithm manager, the filtered TD-CRI; generating, by the sensing algorithm manager, a reconstructed TD-CRI based on the location information and the principal impulses; generating, by the sensing algorithm manager, reconstructed channel state information according to the reconstructed TD-CRI; and executing, by the sensing algorithm manager, a sensing algorithm according to the reconstructed channel state information to obtain a sensing result.

Embodiment 7 is the method of any of embodiments 2-6, wherein identifying the principal impulses includes optimizing for a weighted combination of accuracy and size of the filtered TD-CRI.

Embodiment 8 is the method of any of embodiments 2-7, wherein identifying the principal impulses includes minimizing an objective function representing a weighted linear combination of an error factor and a size factor.

Embodiment 9 is the method of embodiment 8, wherein the error factor represents an error between channel state information determined from the sensing measurement and reconstructed channel state information determined from the filtered TD-CRI.

Embodiment 10 is the method of embodiment 8 or 9, wherein the size factor represents a number of principal impulses in the filtered TD-CRI.

Embodiment 11 is the method of any of embodiments 8-10, wherein minimizing the objective function includes: selecting a first set of principal impulse candidates according to a time domain mask including a time delay filter and an amplitude mask; varying the first set of principal impulse candidates to generate a second set of principal impulse candidates; and comparing the objective function value using the first set of principal impulse candidates and the second set of principal impulse candidates.

Embodiment 12 is the method of any of embodiments 1-11, wherein receiving the sensing measurement includes receiving channel state information (CSI) in a frequency domain, the method further comprising: determining, by the at least one processor, a signal time window; generating the time domain representation by generating a partial time-domain channel representation (TD-CRI) of the CSI by transforming the CSI to identify a plurality of time domain pulses occurring in the signal time window of a time domain; identifying, by the at least one processor, a filtered TD-CRI based on the partial TD-CRI; and communicating the one or more time domain pulses to the sensing algorithm manager by sending the filtered TD-CRI to the sensing algorithm manager.

Embodiment 13 is the method of embodiment 12, wherein transforming the CSI includes applying a transform to the CSI to obtain only the plurality of time domain pulses occurring in the signal time window and not obtain time domain pulses occurring outside of the signal time window.

Embodiment 14 is the method of embodiment 13, wherein the plurality of time domain pulses represents the channel between the sensing transmitter and the sensing receiver.

Embodiment 15 is the method of any of embodiments 12-14, wherein determining the signal time window includes: determining a cut-off time in the sensing transmission as an end of the signal time window; transforming the CSI to identify post cut-off pulses occurring in a post-signal window occurring after the cut-off time; sampling a noise level in the post cut-off pulses; determining a threshold according to the noise level; identifying a first time domain pulse exceeding the threshold; and setting a beginning of the signal time window according to the first time domain pulse.

Embodiment 16 is the method of embodiment 15, wherein determining the cut-off time includes selecting a time in the sensing transmission based on a system model of the sensing transmitter and the sensing receiver.

Embodiment 17 is the method of embodiment 16, wherein the cut-off time represents the time after which no meaningful signal is expected.

Embodiment 18 is the method of any of embodiments 15-17, wherein identifying the first time domain pulse includes: transforming the CSI to identify pre-signal pulses occurring in a pre-signal window in the time domain; detecting a presence of a pre-signal pulse from the pre-signal pulses in the pre-signal window that exceeds the threshold; and responsive to detecting the presence of the pre-signal pulse that exceeds the threshold, setting the pre-signal pulse as the first time domain pulse.

Embodiment 19 is the method of embodiment 18, wherein the pre-signal window is a subsequent pre-signal window, and identifying the first time domain pulse further includes: transforming the CSI to identify first pre-signal pulses occurring in a first pre-signal window occurring before the subsequent pre-signal window in the time domain; and detecting a non-presence of any pre-signal pulses from the first pre-signal pulses in the first pre-signal window that exceed the threshold; and wherein applying the transform to the CSI to identify the pre-signal pulses in the subsequent pre-signal window is performed responsive to detecting the non-presence of any first pre-signal pulses from the first pre-signal pulses in the first pre-signal window that exceed the threshold.

Embodiment 20 is the method of any of embodiments 12-19, wherein identifying the filtered TD-CRI includes setting the filtered TD-CRI as the partial TD-CRI.

Embodiment 21 is the method of any of embodiments 12-20, wherein identifying the filtered TD-CRI includes identifying principal impulses of the partial TD-CRI representing a subset of time domain pulses of the partial TD-CRI.

Embodiment 22 is a method for Wi-Fi sensing carried out by a Wi-Fi device including at least one processor configured to execute instructions, the method comprising: receiving one or more time domain pulses indicative of a time domain representation; generating a reconstructed time domain representation based on the one or more time domain pulses; generating reconstructed channel state information according to the reconstructed time domain representation; and executing a sensing algorithm according to the reconstructed channel state information to obtain a sensing result.

Embodiment 23 is the method of embodiment 22, wherein the one or more time domain pulses represent a plurality of principal impulses of a filtered TD-CRI, the method further comprising: receiving corresponding location information with the filtered TD-CRI; and generating the reconstructed time domain representation by generating a reconstructed TD-CRI based on the filtered TD-CRI and the location information.

Embodiment 24 is the method of embodiment 23, wherein: generating the reconstructed TD-CRI includes using the location information to determine placement of the principal impulses in the reconstructed TD-CRI.

Embodiment 25 is the method of embodiment 24, wherein the location information includes a bit map.

Embodiment 26 is the method of embodiment 24 or 25, wherein the location information is included in the filtered TD-CRI.

Embodiment 27 is a system of Wi-Fi sensing, comprising: a Wi-Fi device including at least one processor configured to execute instructions for: receiving a sensing measurement in a frequency domain generated based on a sensing transmission received from a sensing transmitter; generating a time domain representation of the sensing measurement; selecting, by the at least one processor, one or more time domain pulses indicative of the time domain representation; and communicating the one or more time domain pulses to a sensing algorithm manager for use in determining motion or movement.

Embodiment 28 is the system of embodiment 27, wherein: the time domain representation is a full time-domain channel representation (TD-CRI) of a propagation channel between a sensing receiver and the sensing transmitter based on the sensing measurement, selecting the one or more time domain pulses includes identifying principal impulses of the full TD-CRI, the principal impulses representing a subset of time domain pulses of the full TD-CRI, and communicating the one or more time domain pulses to the sensing algorithm manager includes identifying a filtered TD-CRI comprising the principal impulses and sending the filtered TD-CRI to a sensing algorithm manager.

Embodiment 29 is the system of embodiment 28, wherein the at least one processor is further configured for: sending, to the sensing algorithm manager, location information indicating locations in the full TD-CRI of the principal impulses.

Embodiment 30 is the system of embodiment 29, wherein the location information includes a bit map.

Embodiment 31 is the system of embodiment 29 or 30, wherein the location information is included in the filtered TD-CRI.

Embodiment 32 is the system of any of embodiments 29-31, further comprising a second Wi-Fi device implementing a sensing algorithm manager configured for: obtaining, by the sensing algorithm manager, the filtered TD-CRI; generating, by the sensing algorithm manager, a reconstructed TD-CRI based on the location information and the principal impulses; generating, by the sensing algorithm manager, reconstructed channel state information according to the reconstructed TD-CRI; and executing, by the sensing algorithm manager, a sensing algorithm according to the reconstructed channel state information to obtain a sensing result.

Embodiment 33 is the system of any of embodiments 28-32, wherein identifying the principal impulses includes optimizing for a weighted combination of accuracy and size of the filtered TD-CRI.

Embodiment 34 is the system of any of embodiments 28-33, wherein identifying the principal impulses includes minimizing an objective function representing a weighted linear combination of an error factor and a size factor.

Embodiment 35 is the system of embodiment 34, wherein the error factor represents an error between channel state information determined from the sensing measurement and reconstructed channel state information determined from the filtered TD-CRI.

Embodiment 36 is the system of embodiment 34 or 25, wherein the size factor represents a number of principal impulses in the filtered TD-CRI.

Embodiment 37 is the system of any of embodiments 34-36, wherein minimizing the objective function includes: selecting a first set of principal impulse candidates according to a time domain mask including a time delay filter and an amplitude mask; varying the first set of principal impulse candidates to generate a second set of principal impulse candidates; and comparing the objective function value using the first set of principal impulse candidates and the second set of principal impulse candidates.

Embodiment 38 is the system of any of embodiments 27-37, wherein receiving the sensing measurement includes receiving channel state information (CSI) in a frequency domain, the at least one processor being further configured for: determining, by the at least one processor, a signal time window; generating the time domain representation by generating a partial time-domain channel representation (TD-CRI) of the CSI by transforming the CSI to identify a plurality of time domain pulses occurring in the signal time window of a time domain; identifying, by the at least one processor, a filtered TD-CRI based on the partial TD-CRI; and communicating the one or more time domain pulses to the sensing algorithm manager by sending the filtered TD-CRI to the sensing algorithm manager.

Embodiment 39 is the system of embodiment 38, wherein transforming the CSI includes applying a transform to the CSI to obtain only the plurality of time domain pulses occurring in the signal time window and not obtain time domain pulses occurring outside of the signal time window.

Embodiment 40 is the system of embodiment 39, wherein the plurality of time domain pulses represents the channel between the sensing transmitter and the sensing receiver.

Embodiment 41 is the system of any of embodiments 38-40, wherein determining the signal time window includes: determining a cut-off time in the sensing transmission as an end of the signal time window; transforming the CSI to identify post cut-off pulses occurring in a post-signal window occurring after the cut-off time; sampling a noise level in the post cut-off pulses; determining a threshold according to the noise level; identifying a first time domain pulse exceeding the threshold; and setting a beginning of the signal time window according to the first time domain pulse.

Embodiment 42 is the system of embodiment 41, wherein determining the cut-off time includes selecting a time in the sensing transmission based on a system model of the sensing transmitter and the sensing receiver.

Embodiment 43 is the system of embodiment 42, wherein the cut-off time represents the time after which no meaningful signal is expected.

Embodiment 44 is the system of any of embodiments 41-43, wherein identifying the first time domain pulse includes: transforming the CSI to identify pre-signal pulses occurring in a pre-signal window in the time domain; detecting a presence of a pre-signal pulse from the pre-signal pulses in the pre-signal window that exceeds the threshold; and responsive to detecting the presence of the pre-signal pulse that exceeds the threshold, setting the pre-signal pulse as the first time domain pulse.

Embodiment 45 is the system of embodiment 44, wherein the pre-signal window is a subsequent pre-signal window, and identifying the first time domain pulse further includes: transforming the CSI to identify first pre-signal pulses occurring in a first pre-signal window occurring before the subsequent pre-signal window in the time domain; and detecting a non-presence of any pre-signal pulses from the first pre-signal pulses in the first pre-signal window that exceed the threshold; and wherein applying the transform to the CSI to identify the pre-signal pulses in the subsequent pre-signal window is performed responsive to detecting the non-presence of any first pre-signal pulses from the first pre-signal pulses in the first pre-signal window that exceed the threshold.

Embodiment 46 is the system of any of embodiments 38-45, wherein identifying the filtered TD-CRI includes setting the filtered TD-CRI as the partial TD-CRI.

Embodiment 47 is the system of any of embodiments 38-46, wherein identifying the filtered TD-CRI includes identifying principal impulses of the partial TD-CRI representing a subset of time domain pulses of the partial TD-CRI.

Embodiment 48 is a system for Wi-Fi sensing, comprising a Wi-Fi device including at least one processor configured to execute instructions for: receiving one or more time domain pulses indicative of a time domain representation; generating a reconstructed time domain representation based on the one or more time domain pulses; generating reconstructed channel state information according to the reconstructed time domain representation; and executing a sensing algorithm according to the reconstructed channel state information to obtain a sensing result.

Embodiment 49 is the system of embodiment 48, wherein the one or more time domain pulses represent a plurality of principal impulses of a filtered TD-CRI, the method further comprising: receiving corresponding location information with the filtered TD-CRI; and generating the reconstructed time domain representation by generating a reconstructed TD-CRI based on the filtered TD-CRI and the location information.

Embodiment 50 is the system of embodiment 49, wherein: generating the reconstructed TD-CRI includes using the location information to determine placement of the principal impulses in the reconstructed TD-CRI.

Embodiment 51 is the system of embodiment 50, wherein the location information includes a bit map.

Embodiment 52 is the system of embodiment 50 or 51, wherein the location information is included in the filtered TD-CRI.

1. A method for Wi-Fi sensing carried out by a Wi-Fi device including at least one processor configured to execute instructions to implement a sensing agent, the method comprising:
receiving, by the at least one processor, a sensing measurement in a frequency domain generated based on a sensing transmission received from a sensing transmitter;
generating, by the at least one processor, a time domain representation of the sensing measurement;
selecting, by the at least one processor, one or more time domain pulses indicative of the time domain representation; and
communicating, by the at least one processor, the one or more time domain pulses to a sensing algorithm manager for use in determining motion or movement.

2. The method of claim 1, wherein:
the time domain representation is a full time-domain channel representation (TD-CRI) of a propagation channel between a sensing receiver and the sensing transmitter based on the sensing measurement,
selecting the one or more time domain pulses includes identifying principal impulses of the full TD-CRI, the principal impulses representing a subset of time domain pulses of the full TD-CRI, and
communicating the one or more time domain pulses to the sensing algorithm manager includes identifying a filtered TD-CRI comprising the principal impulses and sending the filtered TD-CRI to a sensing algorithm manager.

3. The method of claim 2, further comprising:
sending, to the sensing algorithm manager, location information indicating locations in the full TD-CRI of the principal impulses.

4-5. (canceled)

6. The method of claim 3, further comprising:
obtaining, by the sensing algorithm manager, the filtered TD-CRI;
generating, by the sensing algorithm manager, a reconstructed TD-CRI based on the location information and the principal impulses;
generating, by the sensing algorithm manager, reconstructed channel state information according to the reconstructed TD-CRI; and
executing, by the sensing algorithm manager, a sensing algorithm according to the reconstructed channel state information to obtain a sensing result.

7. (canceled)

8. The method of claim 2, wherein identifying the principal impulses includes minimizing an objective function representing a weighted linear combination of an error factor and a size factor, wherein the error factor represents an error between channel state information determined from the sensing measurement and reconstructed channel state information determined from the filtered TD-CRI and the size factor represents a number of principal impulses in the filtered TD-CRI.

9-10. (canceled)

11. The method of claim 8, wherein minimizing the objective function includes:
selecting a first set of principal impulse candidates according to a time domain mask including a time delay filter and an amplitude mask;
varying the first set of principal impulse candidates to generate a second set of principal impulse candidates; and
comparing the objective function value using the first set of principal impulse candidates and the second set of principal impulse candidates.

12. The method of claim 1, wherein receiving the sensing measurement includes receiving channel state information (CSI) in a frequency domain, the method further comprising:
determining, by the at least one processor, a signal time window;
generating the time domain representation by generating a partial time-domain channel representation (TD-CRI) of the CSI by transforming the CSI to identify a plurality of time domain pulses occurring in the signal time window of a time domain;
identifying, by the at least one processor, a filtered TD-CRI based on the partial TD-CRI; and
communicating the one or more time domain pulses to the sensing algorithm manager by sending the filtered TD-CRI to the sensing algorithm manager.

13. The method of claim 12, wherein transforming the CSI includes applying a transform to the CSI to obtain only the plurality of time domain pulses occurring in the signal time window and not obtain time domain pulses occurring outside of the signal time window.

14-21. (canceled)

22. A method for Wi-Fi sensing carried out by a Wi-Fi device including at least one processor configured to execute instructions, the method comprising:
receiving one or more time domain pulses indicative of a time domain representation;
generating a reconstructed time domain representation based on the one or more time domain pulses;
generating reconstructed channel state information according to the reconstructed time domain representation; and
executing a sensing algorithm according to the reconstructed channel state information to obtain a sensing result.

23-26. (canceled)

27. A system for Wi-Fi sensing, comprising:
a Wi-Fi device including at least one processor configured to execute instructions for:
receiving a sensing measurement in a frequency domain generated based on a sensing transmission received from a sensing transmitter;
generating a time domain representation of the sensing measurement;
selecting, by the at least one processor, one or more time domain pulses indicative of the time domain representation; and
communicating the one or more time domain pulses to a sensing algorithm manager for use in determining motion or movement.

28. The system of claim 27, wherein:
the time domain representation is a full time-domain channel representation (TD-CRI) of a propagation channel between a sensing receiver and the sensing transmitter based on the sensing measurement,
selecting the one or more time domain pulses includes identifying principal impulses of the full TD-CRI, the principal impulses representing a subset of time domain pulses of the full TD-CRI, and
communicating the one or more time domain pulses to the sensing algorithm manager includes identifying a filtered TD-CRI comprising the principal impulses and sending the filtered TD-CRI to a sensing algorithm manager.

29. The system of claim 28, wherein the at least one processor is further configured for:
sending, to the sensing algorithm manager, location information indicating locations in the full TD-CRI of the principal impulses.

30-31. (canceled)

32. The system of claim 29, further comprising a second Wi-Fi device implementing a sensing algorithm manager configured for:
obtaining, by the sensing algorithm manager, the filtered TD-CRI;
generating, by the sensing algorithm manager, a reconstructed TD-CRI based on the location information and the principal impulses;
generating, by the sensing algorithm manager, reconstructed channel state information according to the reconstructed TD-CRI; and
executing, by the sensing algorithm manager, a sensing algorithm according to the reconstructed channel state information to obtain a sensing result.

33. (canceled)

34. The system of claim 28, wherein identifying the principal impulses includes minimizing an objective function representing a weighted linear combination of an error factor and a size factor,
wherein the error factor represents an error between channel state information determined from the sensing measurement and reconstructed channel state information determined from the filtered TD-CRI and the size factor represents a number of principal impulses in the filtered TD-CRI.

35-36. (canceled)

37. The system of claim 34, wherein minimizing the objective function includes:
selecting a first set of principal impulse candidates according to a time domain mask including a time delay filter and an amplitude mask;
varying the first set of principal impulse candidates to generate a second set of principal impulse candidates; and
comparing the objective function value using the first set of principal impulse candidates and the second set of principal impulse candidates.

38. The system of claim 27, wherein receiving the sensing measurement includes receiving channel state information (CSI) in a frequency domain, the at least one processor being further configured for:
determining, by the at least one processor, a signal time window;
generating the time domain representation by generating a partial time-domain channel representation (TD-CRI) of the CSI by transforming the CSI to identify a plurality of time domain pulses occurring in the signal time window of a time domain;
identifying, by the at least one processor, a filtered TD-CRI based on the partial TD-CRI; and
communicating the one or more time domain pulses to the sensing algorithm manager by sending the filtered TD-CRI to the sensing algorithm manager.

39. The system of claim 38, wherein transforming the CSI includes applying a transform to the CSI to obtain only the plurality of time domain pulses occurring in the signal time window and not obtain time domain pulses occurring outside of the signal time window.

40-52. (canceled)
